(19) United States
(12) Patent Application Publication
(10) Pub. No.: US 2024/0408501 A1
(43) Pub. Date: Dec. 12, 2024

(54) NON-TRANSITORY COMPUTER READABLE MEDIUM, INFORMATION PROCESSING METHOD, AND INFORMATION PROCESSING SYSTEM

(71) Applicant: CYGAMES, INC., Tokyo (JP)

(72) Inventors: Tetsuta Yamada, Tokyo (JP); Yusuke Takeda, Tokyo (JP); Shingo Ikeda, Tokyo (JP)

(73) Assignee: CYGAMES, INC., Tokyo (JP)

(21) Appl. No.: 18/797,126

(22) Filed: Aug. 7, 2024

Related U.S. Application Data
(63) Continuation of application No. PCT/JP2023/005480, filed on Feb. 16, 2023.

(30) Foreign Application Priority Data
Feb. 17, 2022 (JP) 2022-023315

(51) Int. Cl. A63F 13/825; A63F 13/42

(52) U.S. Cl. CPC A63F 13/825; A63F 13/42

(57) ABSTRACT

A non-transitory computer readable medium stores a program causing a computer to execute: processing for enabling a player to select one command from among a plurality of commands including a specific command, in a game for changing a parameter of a nurture-target character; processing for executing a predetermined game among at least one game on the basis of the fact that the specific command is selected; processing for giving a first reward on the basis of a game result of the predetermined game; processing for displaying a specific image linked to the specific command on the basis of a predetermined condition; and processing for giving a second reward on the basis of the game result of the predetermined game, in the case where the predetermined game is executed after the specific command for which the predetermined condition is established is selected.

### CROSS REFERENCE TO RELATED APPLICATIONS

This application is a continuation application of International Application No. PCT/JP2023/005480, filed on Feb. 16, 2023, which claims priority to Japanese Patent Application No. 2022-023315, filed on Feb. 17, 2022, the entire contents of which are incorporated by reference herein.

### BACKGROUND ART

### Technical Field

The present invention relates to an information processing program, an information processing method, and an information processing system.

In the related art, there is a known game of a genre called a nurture game, as shown in Patent Literature 1, for example. In a nurture game, a plurality of kinds of nurture events are provided, and a player can select any of the nurture events to nurture a nurture-target character. In Patent Literature 1, a rival character appears at a particular timing during the nurture game, and it is possible to compete with the rival character for victory or defeat.

### CITATION LIST

### Patent Literature

Patent Literature 1: JP 3990058 B

### SUMMARY OF INVENTION

### Technical Problem

However, in the nurture game of Patent Literature 1, a game for competing with a rival character for victory or defeat is always performed at a particular timing. Thus, there is a problem in that player's choices are narrowed, whereby the strategic characteristic required for the player is reduced, and an interest in the nurture game is reduced.

An object of the present invention is to provide an information processing program, an information processing method, and an information processing system capable of improving an interest in a nurture game.

### Solution to Problem

In order to solve the above-described problem, the present invention provides an information processing program causing a computer to execute: processing for enabling a player to select one command from among a plurality of commands including a specific command, in a game for changing a parameter of a nurture-target character; processing for executing a predetermined game on the basis of the fact that the specific command is selected; processing for giving a first reward on the basis of the game result of the predetermined game; processing for displaying a specific image linked to the specific command on the basis of a predetermined condition; and processing for giving a second reward on the basis of the game result of the predetermined game, in the case where the predetermined game is executed after the specific command for which the predetermined condition is established is selected.

In the processing for executing the predetermined game, the predetermined game executed after the specific command for which the predetermined condition is not established is selected may be executed by using a predetermined parameter; and, in the predetermined game executed after the specific command for which the predetermined condition is established is selected, the predetermined parameter may be changed.

In the processing for giving the second reward, an event serving as the second reward may be displayed.

The game for changing the parameter of the nurture-target character may include a plurality of turns; and in the processing for displaying the specific image, whether the specific image is displayed or not may be determined on the basis of a lottery executed in each of the turns.

A plurality of subcommands linked to the specific command may be set for the specific command in a selectable manner; predetermined games different from each other may be set for the plurality of subcommands; and in the processing for displaying the specific image, whether the specific image is displayed or not may be determined on the basis of the type of each of the subcommands.

A plurality of subcommands linked to the specific command may be set for the specific command in a selectable manner; predetermined games different from each other may be set for the plurality of subcommands; and in the processing for displaying the specific image, the specific image may be displayed while being linked to the subcommand(s) corresponding to one or a plurality of the predetermined games.

In the processing for displaying the specific image, whether the specific image for each of the subcommand(s) is displayed or not may be determined on the basis of the parameter of the nurture-target character.

In order to solve the above-described problem, the present invention provides an information processing method executed by a computer, the computer executing: processing for enabling a player to select one command from among a plurality of commands including a specific command, in a game for changing a parameter of a nurture-target character; processing for executing a predetermined game on the basis of the fact that the specific command is selected; processing for giving a first reward on the basis of the game result of the predetermined game; processing for displaying a specific image linked to the specific command on the basis of a predetermined condition; and processing for giving a second reward on the basis of the game result of the predetermined game, in the case where the predetermined game is executed after the specific command for which the predetermined condition is established is selected.

In order to solve the above-described problem, the present invention provides an information processing system comprising one or a plurality of computers, the computer(s) executing: processing for enabling a player to select one command from among a plurality of commands including a specific command, in a game for changing a parameter of a nurture-target character; processing for executing a predetermined game on the basis of the fact that the specific command is selected; processing for giving a first reward on the basis of the game result of the predetermined game; processing for displaying a specific image linked to the specific command on the basis of a predetermined condition; and processing for giving a second reward on the basis of the game result of the predetermined game, in the case where the predetermined game is executed after the specific command for which the predetermined condition is established is selected.

### Effects of Disclosure

According to the present invention, it is possible to improve an interest in a nurture game.

### BRIEF DESCRIPTION OF DRAWINGS

FIG. 1 is an explanatory view showing, in outline, the configuration of an information processing system.

FIG. 2A is a diagram for explaining the hardware configuration of a player terminal. FIG. 2B is a diagram for explaining the hardware configuration of a server.

FIG. 3A is a view for explaining an example of a home screen. FIG. 3B is a view for explaining an example of an option setting screen. FIG. 3C is a view for explaining an example of a profile setting screen. FIG. 3D is a view for explaining an example of a home setting screen.

FIG. 4 is a view for explaining a rough flow of progress of a nurture game.

FIG. 5A is a view for explaining a main-character selection screen. FIG. 5B is a first view for explaining a character detail screen. FIG. 5C is a second view for explaining the character detail screen.

FIG. 6A is a view for explaining an ability parameter (initial value) table. FIG. 6B is a view for explaining an aptitude parameter (initial value) table. FIG. 6C is a view for explaining a skill table. FIG. 6D is a view for explaining a dedicated-event table.

FIG. 7A is a first view for explaining an inheritance character selection screen. FIG. 7B is a first view for explaining a nurtured-character list screen. FIG. 7C is a second view for explaining the inheritance character selection screen. FIG. 7D is a third view for explaining the inheritance character selection screen.

FIG. 8 is a view for explaining lineage of inheritance.

FIG. 9 is a view for explaining factor information.

FIG. 10A is a view for explaining compatibility judgment targets. FIG. 10B is a view for explaining compatibility judgment items.

FIG. 11A is a view for explaining a sort condition. FIG. 11B is a view for explaining a filtering condition.

FIG. 12 is a first view for explaining a character detail dialog.

FIG. 13 is a second view for explaining the character detail dialog.

FIG. 14 is a third view for explaining the character detail dialog.

FIG. 15 is a view for explaining a skill display dialog.

FIG. 16A is a first view for explaining a support-card organization screen. FIG. 16B is a view for explaining a support-card selection screen. FIG. 16C is a second view for explaining the support-card organization screen.

FIG. 17A is a view for explaining a support card table.

FIG. 17B is a view for explaining a support effect table.

FIG. 17C is a view for explaining a possessed-skill table.

FIG. 17D is a view for explaining a support event table.

FIG. 18A is a view for explaining a final confirmation screen. FIG. 18B is a view for explaining a preset selection screen.

FIG. 19 is a view for explaining a selection item table.

FIG. 20A is a view for explaining a game screen. FIG. 20B is a view for explaining a special race screen.

FIG. 21A is a first view for explaining a training screen. FIG. 21B is a second view for explaining the training screen. FIG. 21C is a view for explaining a training-result notification screen. FIG. 21D is a view for explaining an event screen.

FIG. 22A is a first view for explaining an inheritance event. FIG. 22B is a second view for explaining the inheritance event. FIG. 22C is a third view for explaining the inheritance event. FIG. 22D is a fourth view for explaining the inheritance event.

FIG. 23A is a first view for explaining a skill screen.

FIG. 23B is a second view for explaining the skill screen.

FIG. 24A is a first view for explaining an individual-race selection screen. FIG. 24B is a view for explaining an individual-race start screen. FIG. 24C is a first view for explaining an individual-race result screen. FIG. 24D is a second view for explaining the individual-race result screen.

FIG. 25 is a view for explaining an example of an item exchange screen.

FIG. 26 is a view for explaining a rough flow of turn start-time processing.

FIG. 27 is a view for explaining an arrangement-or-not table.

FIG. 28A is a view for explaining a training-level table.

FIG. 28B is a view for explaining an increase fixed value (speed) table. Furthermore, FIG. 28C is a view for explaining an increase fixed value table (power). FIG. 28D is a view for explaining a bonus addition rate table.

FIG. 29 is a view for explaining a second-event table.

FIG. 30 is a view for explaining a post-re-arrangement training screen.

FIG. 31 is a view for explaining a rough flow of turn start-time processing.

FIG. 32 is a view for explaining an arrangement-or-not table.

FIG. 33 is a view for explaining a bonus-acquisition-count table.

FIG. 34A is a view for explaining notification of arrangement of a rival character in a game screen. FIG. 34B is a view for explaining notification of arrangement of a rival character in an individual-race selection screen.

FIG. 35A is a view for explaining a nurture complete screen. FIG. 35B is a second view for explaining the nurture complete screen. FIG. 35C is a third view for explaining the nurture complete screen.

FIG. 36 is a view for explaining the configuration of a memory at the player terminal and the function of the player terminal serving as a computer.

FIG. 37 is a view for explaining the configuration of a memory at the server and the function of the server serving as a computer.

FIG. 38 is a sequence diagram for explaining processing procedures related to the nurture game and performed at the player terminal and the server.

FIG. 39 is a flowchart for explaining nurture-stage processing at the server.

FIG. 40 is a flowchart for explaining turn start-time processing at the server.

FIG. 41 is a flowchart for explaining nurture-stage processing at the player terminal.

FIG. 42 is a flowchart for explaining turn start-time processing at the player terminal.

FIG. 43 is a flowchart for explaining display control processing.

FIG. 44 is a flowchart for explaining middle-of-turn processing at the server.

FIG. 45 is a flowchart for explaining individual-race execution processing.

FIG. 46 is a flowchart for explaining reward giving processing.

FIG. 47 is a flowchart for explaining middle-of-turn processing at the player terminal.

FIG. 48 is a flowchart for explaining display control processing.

### DESCRIPTION OF EMBODIMENTS

One aspect of an embodiment of the present invention will be described in detail below with reference to the accompanying drawings. Numerical values and the like shown in the embodiment are merely examples for facilitating understanding and do not limit the present invention unless otherwise specified. In the present specification and drawings, elements having substantially the same function and configuration are given the same reference numerals to omit redundant description, and elements that are not directly related to the present invention are omitted from the drawings.

### (Overall Configuration of Information Processing System S)

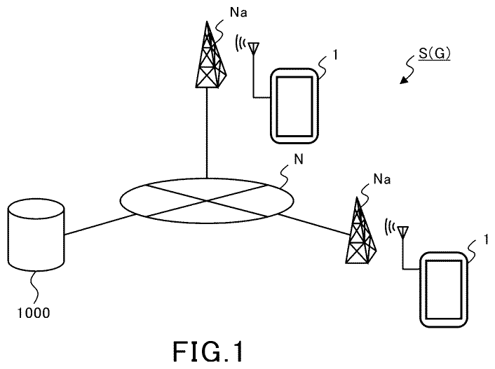

FIG. 1 is an explanatory view showing, in outline, the configuration of an information processing system S. The information processing system S is a so-called client-server system that includes: player terminals 1 functioning as clients, i.e., game terminals; a server 1000; and a communication network N having communication base stations Na.

In the information processing system S according to this embodiment, each of the player terminals 1 and the server 1000 function as a game device G. The player terminal 1 and the server 1000 respectively play roles for controlling the proceeding of a game, whereby it is possible to proceed with the game through cooperation between the player terminal 1 and the server 1000.

Each of the player terminals 1 can establish communication with the server 1000 via the communication network N. The player terminals 1 widely include electronic appliances that can be communicatively connected to the server 1000 by wire or wirelessly. Examples of the player terminals 1 include, for example, smartphones, mobile phones, tablet devices, personal computers, game machines, or the like. In this embodiment, a description will be given of a case in which smartphones are used as the player terminals 1.

The server 1000 is communicatively connected to the plurality of player terminals 1. The server 1000 accumulates various kinds of information, for each player who plays a game. Furthermore, the server 1000 mainly updates the accumulated information and performs processing for allowing the player terminal 1 to download images and various kinds of information, on the basis of operations input from the player terminal 1.

The communication base stations Na are connected to the communication network N and send information to and receive information from the player terminals 1 wirelessly. The communication network N is configured of a mobile-phone network, an Internet network, a local area network (LAN), a dedicated line, or the like, to realize wireless or wired communication connection between the player terminals 1 and the server 1000.

(Hardware Configurations of Player Terminal 1 and server 1000)

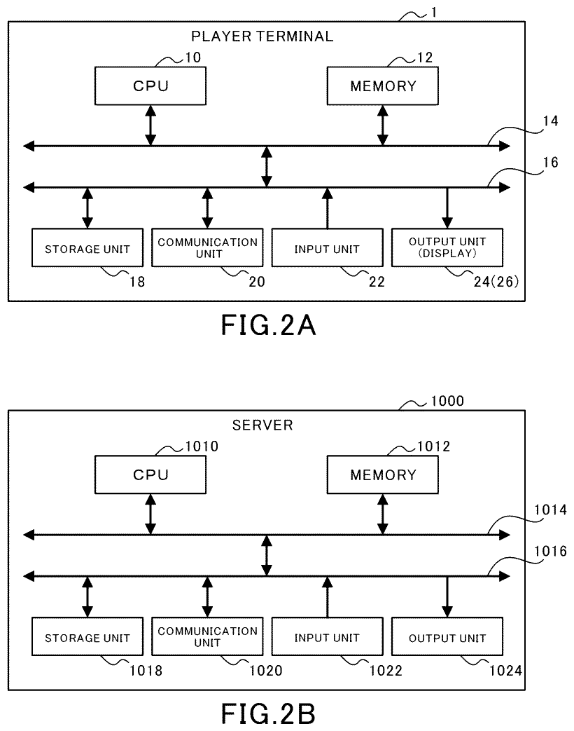

FIG. 2A is a diagram for explaining the hardware configuration of the player terminal 1. Furthermore, FIG. 2B is a diagram for explaining the hardware configuration of the server 1000. As shown in FIG. 2A, the player terminal 1 is configured to include a central processing unit (CPU) 10, a memory 12, a bus 14, an input/output interface 16, a storage unit 18, a communication unit 20, an input unit 22, and an output unit 24.

Furthermore, as shown in FIG. 2B, the server 1000 is configured to include a CPU 1010, a memory 1012, a bus 1014, an input/output interface 1016, a storage unit 1018, a communication unit 1020, an input unit 1022, and an output unit 1024.

Note that the configurations and the functions of the CPU 1010, the memory 1012, the bus 1014, the input/output interface 1016, the storage unit 1018, the communication unit 1020, the input unit 1022, and the output unit 1024 of the server 1000 are substantially the same as those of the CPU 10, the memory 12, the bus 14, the input/output interface 16, the storage unit 18, the communication unit 20, the input unit 22, and the output unit 24 of the player terminal 1, respectively. Therefore, the hardware configuration of the player terminal 1 will be described below, and a description of the server 1000 is omitted.

The CPU 10 runs a program stored in the memory 12 to control the proceeding of the game. The memory 12 is configured of a read only memory (ROM) or a random access memory (RAM) and stores programs and various kinds of data needed for controlling the proceeding of the game. The memory 12 is connected to the CPU 10 via the bus 14.

The input/output interface 16 is connected to the bus 14. The storage unit 18, the communication unit 20, the input unit 22, and the output unit 24 are connected to the input/output interface 16.

The storage unit 18 is configured of a semiconductor memory, such as a dynamic random access memory (DRAM), and stores various kinds of programs and data. At the player terminal 1, the programs and data stored in the storage unit 18 are loaded into the memory 12 (RAM) by the CPU 10.

The communication unit 20 is communicatively connected to the communication base station Na wirelessly, and sends information to and receives information from the server 1000 via the communication network N, such as various kinds of data and programs. At the player terminal 1, the programs etc. received from the server 1000 are stored in the memory 12 or the storage unit 18.

The input unit 22 is configured of, for example, a touchscreen, buttons, a keyboard, a mouse, a cross key, or an analog controller with which player operations are input (operations are accepted). Alternatively, the input unit 22 may be a dedicated controller provided in the player terminal 1 or connected (externally attached) to the player terminal 1. Alternatively, the input unit 22 may be configured of an acceleration sensor that detects tilting or movement of the player terminal 1 or a microphone that detects speech of the player. That is, the input unit 22 may widely include devices that enable the player to input his or her intents in distinguishable manners.

The output unit 24 is configured to include a display device and a speaker. Note that the output unit 24 may be a device connected (externally attached) to the player terminal 1. In this embodiment, the player terminal 1 includes a display 26 as the output unit 24 and includes, as the input unit 22, a touchscreen provided in the display 26 so as to be overlaid thereon.

### (Game Content)

Next, a game provided by the information processing system S, the game device G, of this embodiment will be described. A player can possess a character obtained by a lottery called gacha and a character distributed by a management side. Furthermore, the player can possess a support card obtained by the lottery and a support card distributed by the management side.

Although a detailed description will be given later, in the game according to this embodiment, a nurture game is provided. The player can nurture a character possessed by the player in the nurture game. Furthermore, the nurture game in this embodiment has a game property in which a character is nurtured while being made to participate in a race simulating a horse race.

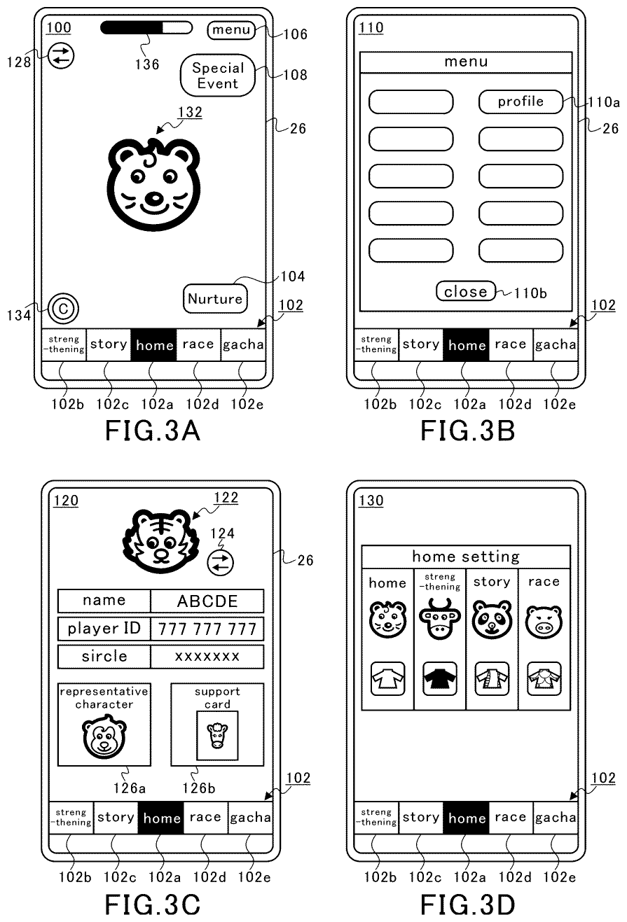

FIG. 3A is a view for explaining an example of a home screen 100. When a game application is activated at the player terminal 1, the home screen 100 is displayed on the display 26. A menu bar 102 is displayed at a lower section of the home screen 100. In the menu bar 102, a plurality of operation sections that can be operated (tapped) by the player are provided.

Here, in the menu bar 102, a home-screen selection operation section 102a, a strengthening-screen selection operation section 102b, a story-screen selection operation section 102c, a race-game selection operation section 102d, and a gacha-screen selection operation section 102e are provided. Note that, in order to be able to identify the screen currently displayed on the display 26, the operation section corresponding to the currently displayed screen is highlighted in the menu bar 102.

When the home-screen selection operation section 102a is tapped, the home screen 100, which is shown in FIG. 3A, is displayed on the display 26.

When the strengthening-screen selection operation section 102b is tapped, a strengthening screen (not shown) is displayed. In the strengthening screen, it is possible to strengthen characters or support cards possessed by the player. The player strengthens the characters or the support cards, thereby making it possible to raise the levels set for the characters or the support cards. Various parameters are set for the characters and the support cards and are increased when the levels thereof are raised. When the parameters of the characters and the support cards are increased, the player can nurture a character having a more powerful status in the nurture game.

When the story-screen selection operation section 102c is tapped, a story screen (not shown) is displayed. Here, a story image is provided for each character that appears in the game. The player can select and view a character and the story image thereof in the story screen.

When the race-game selection operation section 102d is tapped, a race-game selection screen (not shown) is displayed. In this embodiment, various race games are provided, in which a nurtured character nurtured in a nurture game, to be described later, can be made to participate. In the race-game selection screen, the player can select a race game in which the nurtured character is made to participate. Examples of the race games include a team competition game in which a team organized by a plurality of nurtured characters and a team of another player selected by a computer are made to compete with each other. The team competition game has a game property to compete with the other player for ranking.

When the gacha-screen selection operation section 102e is tapped, a gacha screen (not shown) is displayed. In the gacha screen, the player can perform a so-called gacha lottery in which a character or a support card can be obtained by a lottery, by consuming in-game currency.

Furthermore, in the home screen 100, a nurture-game operation section 104 is provided above the menu bar 102. When the nurture-game operation section 104 is tapped, a nurture-game screen is displayed, and the nurture game, to be described later, is started. The nurture game is roughly divided into a preparatory stage and a nurture stage. First, in the preparatory stage, the player selects one character from among characters possessed by the player and sets the character as a main character serving as a nurture-target character.

Furthermore, in the preparatory stage, the player sets a deck to be used when the main character is nurtured. The deck is organized by a plurality of inheritance characters, to be described in detail later, and a plurality of support cards. Therefore, the inheritance characters and the support cards organized in the deck are used in the nurture game.

When the settings of the main character and the deck (the inheritance characters and the support cards) are completed, the stage is transitioned from the preparatory stage to the nurture stage, and the game for nurturing the main character is started. In the nurture game, the parameters of the nurture-target character can be changed. The player can possess characters that have been nurtured in the nurture game, as nurtured characters. As described above, the player can organize possessed nurtured characters in a team and use the team in the team competition game or the like.

In this way, a main purpose of the game of this embodiment is to nurture a nurture character in the nurture game and to increase the ranking in the team competition game by using nurtured characters.

Furthermore, in this embodiment, a function of sharing a nurtured character or a support card between players and a function of sharing information between a plurality of players are provided. The player can set a nurtured character and a support card that can be used by another player in the nurture game. Specifically, as shown in FIG. 3A, a setting operation section 106 is provided at an upper right section of the home screen 100. When the setting operation section 106 is tapped, an option setting screen 110 is displayed.

FIG. 3B is a view for explaining an example of the option setting screen 110. The option setting screen 110 is a screen in which various kinds of information can be confirmed and set. In the option setting screen 110, a plurality of operation sections are provided, and, when any of the operation sections is tapped, information corresponding to the operation section can be confirmed and set.

The operation sections in the option setting screen 110 include a profile-setting operation section 110a and a close operation section 110b. When the close operation section 110b is tapped, the option setting screen 110 is closed, and the home screen 100 is displayed. When the profile-setting operation section 110a is tapped, a profile setting screen 120 is displayed.

FIG. 3C is a view for explaining an example of the profile setting screen 120. In the profile setting screen 120, the player can confirm and set his or her own profile information. The profile information includes a profile character, a player name, a player ID, an affiliated circle, a representative character, and a rental card.

The profile character functions as a character to be displayed when the information of the player is viewed by another player(s). For example, the profile character is displayed when a circle function that serves as a place to share information with the other player(s) is used. In the profile setting screen 120, a profile character image 122 that is currently set is displayed. A change button 124 is provided near the profile character image 122. When the change button 124 is tapped, a profile-character change screen (not shown) is displayed. The player can change the profile character in the profile-character change screen.

Furthermore, in the profile setting screen 120, the player name set by the player, the player ID assigned to the player, and the name of the circle to which the player belongs are displayed. Furthermore, a representative-character setting operation section 126a and a rental-card setting operation section 126b are provided in the profile setting screen 120.

When the representative-character setting operation section 126a is tapped, a representative-character setting screen (not shown) is displayed. In the representative-character setting screen, the player can set, as a representative character, any one of the nurtured characters that have been nurtured by the player himself/herself. In the representative-character setting operation section 126a, an icon image showing the currently set representative character is displayed. Note that, although a detailed description will be given later, the representative character can be organized, as an inheritance character, into a deck in a nurture game played by another player.

When the rental-card setting operation section 126b is tapped, a rental-card setting screen (not shown) is displayed. In the rental-card setting screen, the player can set, as a rental card, any one of the support cards possessed by the player himself/herself. In the rental-card setting operation section 126b, an icon image showing the currently set rental card is displayed. Note that, as described above, the support card that is set as a rental card can be organized into a deck by another player and is used in a nurture game played by the other player.

Note that, although a detailed description is omitted, when the setting of the profile information is changed in the profile setting screen 120, setting change information is sent to the server 1000. At the server 1000, the profile information is stored for each player.

Furthermore, as shown in FIG. 3A, a setting icon 128 is displayed in the home screen 100. When the setting icon 128 is tapped, a home setting screen 130 is displayed.

FIG. 3D is a view for explaining an example of the home setting screen 130. In the home setting screen 130, the player can set a home-screen setting character(s) 132 to be displayed in the home screen 100. The player can set four home-screen setting characters 132 to be displayed in the home screen 100.

Although not shown in the figures, when a flick operation in the horizontal direction is input in the home screen 100, the screen displayed on the display 26, i.e., the display in the home screen 100, is switched. In the home screen 100, the currently set four home-screen setting characters 132 are displayed. Functions serving as the individual operation sections displayed in the menu bar 102 are assigned to the home-screen setting characters 132. Therefore, when any of the home-screen setting characters 132 displayed in the home screen 100 is tapped, the screen is switched in the same way as when any of the operation sections in the menu bar 102 is tapped.

In the home setting screen 130, character images corresponding to the currently set four home-screen setting characters 132 and operation sections corresponding thereto are displayed in an identifiable manner. When any of the character images displayed in the home setting screen 130 is tapped, a character selection screen (not shown) is displayed. The player can select the home-screen setting character 132 in the character selection screen. Furthermore, the player can set a costume for the home-screen setting character 132 in the home setting screen 130.

Furthermore, as shown in FIG. 3A, a circle icon 134 is displayed in the home screen 100. When the circle icon 134 is tapped, a circle screen is displayed. In the circle screen, the player can exchange information with another player who belongs to the same circle.

Furthermore, in this embodiment, various limited-time events are held irregularly. During the period of a specific event that is one of the limited-time events, a specific-event icon 108 is displayed in the home screen 100. When the specific-event icon 108 is tapped, a specific-event screen is displayed. In the specific-event screen, the player can exchange specific-event points provided only by the specific event, for various rewards, for example. Furthermore, during a limited-time event, when the player wins a specific race (hereinafter, referred to as specific race), an additional reward that is different from a basic reward is given to the player in some cases. The additional reward is, for example, a special item that enables to increase the initial values of ability parameters of a specific character and that enables to strengthen a unique skill provided for the specific character. Here, the specific character is, for example, any character that participates in a specific race during a limited-time event. However, the specific character is not limited thereto, and the specific character may be any character that can be obtained by the player and may be a character that does not participate in a specific race.

Here, a specific race is at least one race that is set in advance in accordance with the type of the race, among races that can be played during the period of the specific event. Furthermore, the additional reward may be given when the main character participates in a specific race, irrespective of whether the main character wins the specific race or not. The number of times of acquisition of the additional reward (that is, the special item) in one specific race (one kind of specific race) is limited to a predetermined number of times during a predetermined period of time. For example, the number of times of acquisition of a special item in one specific race during one day is three. However, the number of times of acquisition of a special item may be changed depending on the type of the specific race (race event). Furthermore, the number of special items obtained at one time is the total of a basic acquisition count (for example, three) and a bonus acquisition count (for example, one or two). The bonus acquisition count can be given in the case where a specific race is won. An additional reward obtained from a specific race is linked to the player ID and is stored in the server 1000.

In the home screen 100, when the nurture-game operation section 104 is tapped, the nurture-game screen is displayed, and the nurture game is started. Note that the player can play the nurture game by consuming game points. The game points are given to the player by a predetermined value (for example, +1) at intervals of a predetermined period of time (for example, ten minutes). The game points that can be possessed by the player have an upper limit (for example, 100) set therefor, and the player can possess the game points within the range defined by the upper limit. A game-point display bar 136 is provided at an upper section of the home screen 100, and the percentage of the currently possessed game points with respect to the upper limit is visually displayed.

Note that a predetermined value (for example, −30) is subtracted from the game points when the nurture game is started. Therefore, if the player does not possess the required game points, the player cannot start the nurture game. However, the player can possess an item for restoring the game points and can restore the game points by using the item. This item can be given, for example, as a reward for the nurture game or the team competition game or can be obtained by consuming the in-game currency. The nurture game will be described in detail below.

### (Nurture Game)

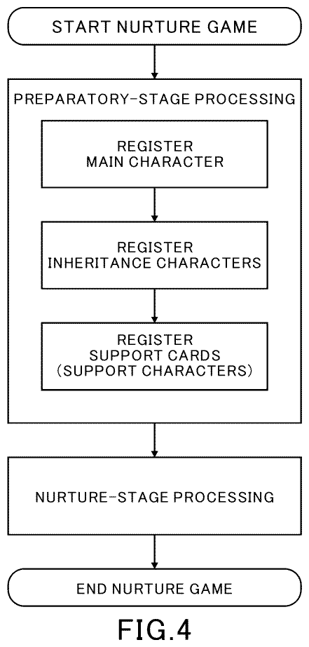

FIG. 4 is a view for explaining a rough flow of the nurture game. The nurture game is roughly divided into a setting game and a nurture main game. Although a detailed description will be given later, the nurture main game is a game in which one main character selected from among the characters possessed by the player is nurtured as a nurture-target character.

Furthermore, the setting game is a game in which the player registers a main character and a deck (inheritance characters and support cards), and corresponds to the preparatory stage of the nurture game. Hereinafter, processing to be carried out in the setting game is referred to as preparatory-stage processing, and processing to be carried out in the nurture main game is referred to as nurture-stage processing. Here, in order to facilitate understanding, rough flows of the preparatory-stage processing and the nurture-stage processing will be described first.

### <Preparatory-Stage Processing>

In the preparatory-stage processing, registration of a main character and registration of a deck (inheritance characters and support cards) are mainly performed. Note that support cards are used to support the nurture of a main character. Each of the support cards is surely linked to one character, and the characters linked to the support cards registered in the preparatory-stage processing support the nurture of the main character. Hereinafter, the characters linked to the support cards are referred to as support characters.

### <Registration of Main Character>

In the home screen 100, when the nurture-game operation section 104 is tapped by the player, a scenario selection screen (not shown) is displayed. In this embodiment, a plurality of scenarios for the nurture main game are provided. In the respective scenarios for the nurture main game, the final goal, a goal in the middle of the game, etc., have been set, and the player needs to sequentially clear the set goals. The respective goals and periods of time during which the goals are achieved are different for each scenario. The player can select one from among the plurality of scenarios in the scenario selection screen. Here, a description will be given of a case in which a predetermined scenario is selected.

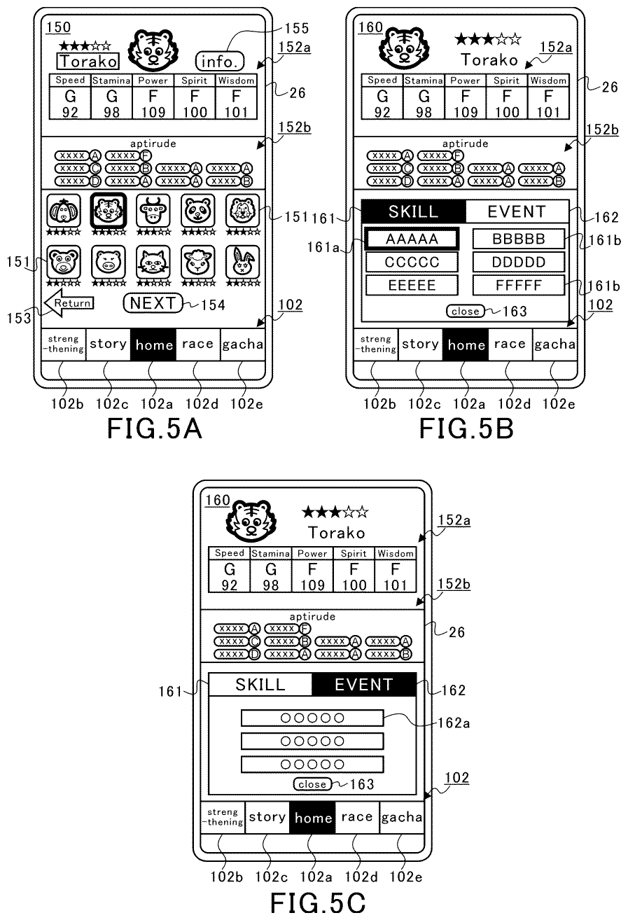

FIG. 5A is a view for explaining a main-character selection screen 150. At a central section of the main-character selection screen 150, a plurality of character icons 151 are displayed, and the characters possessed by the player are displayed in a list. Furthermore, an ability-parameter display section 152a and an aptitude-parameter display section 152b are displayed at an upper section of the main-character selection screen 150. Furthermore, a return operation section 153, in which “Return” is written, and a next operation section 154, in which “NEXT” is written, are displayed at a lower section of the main-character selection screen 150.

In this embodiment, the initial values of the ability parameters are set for each character, and the initial values of the ability parameters of the character corresponding to a character icon 151 selected by the player are numerically displayed in the ability-parameter display section 152a. In this embodiment, it is indicated that the abilities are higher as the values of the ability parameters are increased.

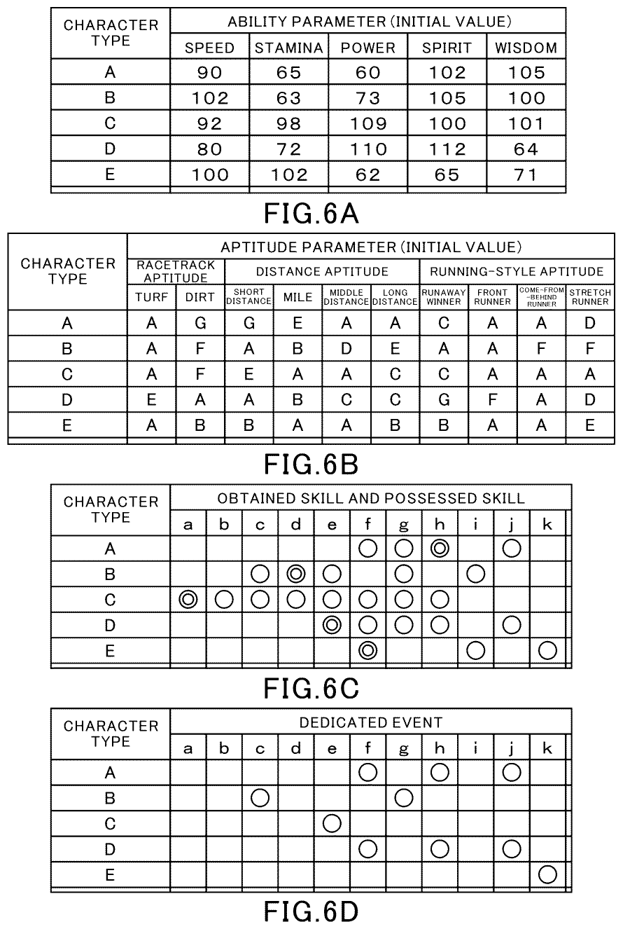

FIG. 6A is a view for explaining an ability parameter (initial value) table. In this embodiment, as shown in FIG. 6A, the initial values of the ability parameters of each character are stored in the ability parameter (initial value) table. Then, the initial values of the ability parameters are displayed in the ability-parameter display section 152a on the basis of the initial values of the ability parameters stored in the ability parameter (initial value) table.

In this embodiment, the initial values of the ability parameters are set for a plurality of kinds of abilities for each character. Specifically, a speed ability parameter, in which “Speed” is written in the ability-parameter display section 152a, a stamina ability parameter, in which “Stamina” is written in the ability-parameter display section 152a, a power ability parameter, in which “Power” is written in the ability-parameter display section 152a, a spirit ability parameter, in which “Spirit” is written in the ability-parameter display section 152a, and a wisdom ability parameter, in which “Wisdom” is written in the ability-parameter display section 152a, are provided as the ability parameters.

Note that the initial values of the ability parameters of each character are increased by a player's operation etc. For example, five levels are provided for a character, and the player can raise the level of the character by consuming the in-game currency or a predetermined item. In this case, when the level of the character is raised, the initial values of the ability parameters thereof are increased. FIG. 6A shows the initial values when characters are at a predetermined level. Note that the player can increase the values of the ability parameters in the nurture main game. That is, the purpose of the nurture main game is to nurture a character having higher values of the ability parameters.

Furthermore, in this embodiment, aptitude parameters (initial values) are set for each character, and, as shown in FIG. 5A, the initial values of the aptitude parameters of the character corresponding to the character icon 151 selected by the player are displayed with alphabets in the aptitude-parameter display section 152b.

FIG. 6B is a view for explaining an aptitude parameter (initial value) table. In this embodiment, as shown in FIG. 6B, the initial values of the aptitude parameters of each character are stored in the aptitude parameter (initial value) table. The initial values of the aptitude parameters are each set to any of seven stages with alphabets A to G. Note that, in the initial values of the aptitude parameters, A indicates the highest aptitude, and G indicates the lowest aptitude. The initial values of the aptitude parameters are displayed in the aptitude-parameter display section 152b on the basis of the initial values of the aptitude parameters stored in the aptitude parameter (initial value) table.

In this embodiment, the initial values of the aptitude parameters are set for a plurality of kinds of aptitudes for each character. Specifically, provided as the aptitude parameters are: aptitude parameters related to racetrack aptitudes of turf and dirt; aptitude parameters related to distance aptitudes of short distance, mile, middle distance, and long distance; and aptitude parameters related to running-style aptitudes of runaway winner, front runner, come-from-behind runner, and stretch runner.

In the nurture game, the player can make the main character participate in various races. At this time, the race development becomes advantageous as the aptitudes of the main character that are suitable for the race content are higher.

Note that it is also possible that the initial values of the aptitude parameters of each character are increased by consuming the in-game currency. Furthermore, the values of the aptitude parameters may be changed in the nurture main game. Furthermore, in the nurture main game, the aptitude parameter(s) may also be set to S that indicates a higher aptitude than A.

FIG. 5B is a first view for explaining a character detail screen 160. Furthermore, FIG. 5C is a second view for explaining the character detail screen 160. When any of the character icons 151 in the main-character selection screen 150 is pressed and held, the character detail screen 160 is displayed on the display 26. In the character detail screen 160, the details of the abilities of the character corresponding to the character icon 151 pressed and held in the main-character selection screen 150 are displayed.

A skill operation section 161 and an event operation section 162 are displayed at a central section of the character detail screen 160. As shown in FIG. 5B, the skill operation section 161 is highlighted when the character detail screen 160 is first displayed, and skills provided for each character are displayed. The skills are each an ability that can be activated when a predetermined condition is established during an individual race, to be described later. The race development of each character becomes advantageous through activation of a skill thereof.

FIG. 6C is a view for explaining a skill table. As shown in FIG. 6C, skills of each of the characters possessed by the player are stored in the skill table. Then, as shown in FIG. 5B, skills are displayed in the character detail screen 160 on the basis of the skills stored in the skill table. Note that the skills are not activated just by being possessed but can be activated only after being obtained. Hereinafter, a skill that can be activated by the character is referred to as an obtained skill.

One obtained skill is set for each character at the beginning of start of the nurture main game. Furthermore, a plurality of possessed skills are set for each character, separately from the obtained skill. The possessed skills are skills that can be obtained by consuming skill points, to be described later, after the start of the nurture main game. Thus, the possessed skills can be obtained skills in exchange for the skill points.

In this embodiment, a skill corresponding to double circle in the skill table, which is shown in FIG. 6C, is displayed as an obtained skill in the character detail screen 160, which is shown in FIG. 5B. Furthermore, skills corresponding to single circle in the skill table, which is shown in FIG. 6C, are displayed as possessed skills in the character detail screen 160, which is shown in FIG. 5B. In this embodiment, in order to make it easier to distinguish between the obtained skill and the possessed skills, the obtained skill is highlighted, as shown in the character detail screen 160 of FIG. 5B.

Note that, although FIG. 5B shows a case in which, as the skills set for each character, one obtained skill is displayed in an obtained-skill display field 161a, and seven possessed skills are displayed in possessed-skill display fields 161b, the present invention is not limited thereto. For example, a different number of obtained skills and a different number of possessed skills may be set for each character. Furthermore, the number of obtained skills or the number of possessed skills for each character may be increased due to a raise in the level of the character or consumption of the in-game currency or an item, for example.

Furthermore, when the player taps the event operation section 162 in the character detail screen 160, the content in the character detail screen 160 is switched, and a dedicated-event display field(s) 162a that shows a dedicated event(s) provided for each character is displayed, as shown in FIG. 5C. In this case, the event operation section 162 is highlighted, as shown in FIG. 5C. A dedicated event is an event that occurs when a predetermined condition is established during the nurture main game, for displaying a story related to a character appearing in the nurture game or for changing the values of the ability parameters.

FIG. 6D is a view for explaining a dedicated-event table. As shown in FIG. 6D, in the dedicated-event table, a dedicated event(s) is stored for each of the characters possessed by the player. Then, dedicated events are displayed in the character detail screen 160, as shown in FIG. 5C, on the basis of the dedicated events stored in the dedicated-event table. Note that examples of the dedicated events may include a tip event for allowing a skill to be possessed or obtained, an ability event for increasing or decreasing the values of the ability parameters of the character, etc.

Note that the dedicated events displayed in the character detail screen 160 shown in FIG. 5C may be all executed during the execution of the nurture main game, at least some of them may be executed during the execution of the nurture main game, or none of them may be executed during the execution of the nurture main game if the predetermined condition is not established. Furthermore, for example, the number of dedicated events provided for each character may be increased due to a raise in the level of the character or consumption of the in-game currency or an item. Furthermore, in the case where the predetermined condition is established, a dedicated event that is not displayed as a dedicated event may be executed during the nurture main game.

Furthermore, as shown in FIGS. 5B and 5C, a close operation section 163, in which “close” is written, is displayed at a lower section of the character detail screen 160. When the close operation section 163 in the character detail screen 160 is tapped, the display of the character detail screen 160 is ended, and the main-character selection screen 150 is displayed on the display 26.

Furthermore, when the return operation section 153 is tapped in the main-character selection screen 150, which is shown in FIG. 5A, the home screen 100, which is shown in FIG. 3A, is displayed on the display 26. Furthermore, a nurture information display button 155 is provided in the main-character selection screen 150. When the nurture information display button 155 is tapped, a nurture information display screen (not shown) is displayed. The player can confirm information related to the character selected in the main-character selection screen 150, in the nurture information display screen.

In the nurture information display screen, a clear goal tab is provided. Here, the purpose of the nurture game is to nurture a character selected, from among the characters possessed by the player, as a main character serving as a nurture target, thereby generating a stronger nurtured character. Although a detailed description will be given later, the nurture main game is composed of a plurality of turns, and the player is required to give training to the main character or to make the main character participate in a race, in each turn.

Then, a plurality of clear goals are set for each character. When the clear goal tab is tapped, clear goals that are set for the selected character are displayed in a list in the nurture information display screen. In each turn, a race(s) in which the main character can be made to participate is set in advance.

Furthermore, when the nurture-target main character is made to participate in a race, the main character can obtain fans, victory points, and special currency. In each race, the base acquisition counts of fans, victory points, and special currency are set for individual orders of arrival, and the values of fans, victory points, and special currency to be obtained are increased as the order of arrival is higher. Furthermore, the difficulty level is set for a race, and more fans, more victory points, and more special currency can be obtained as a higher difficulty level is set for the race. For example, among races, races of grades of GI, GII, and GIII, called major prize, are provided. The grade becomes higher in the order of GIII, GII, and GI. As a higher grade is set for a race, the difficulty level becomes higher, and more fans, more victory points, and more special currency can be obtained.

Here, the number of fans that can be obtained due to participation in a race is calculated by adding the bonus acquisition count to the base acquisition count, which is set for individual orders of arrival. Specifically, a correction value is determined on the basis of a race result, and the base acquisition count is multiplied by the correction value, thereby calculating the bonus acquisition count. The total of the bonus acquisition count and the base acquisition count is the number of fans to be obtained by the main character. For example, in the case where the race result is the 1st place, the correction value becomes larger as the difference between the main character and the 2nd-place character is increased. Furthermore, in the case where the race result falls within the range from the 2nd place to the 5th place, the correction value becomes larger as the difference between the main character and the 1st-place character is reduced.

Furthermore, the main character activates a skill at a predetermined rate during a race. At this time, the correction value becomes larger as the number of activated skills is increased. In this way, in each race, an addition condition for the number of fans is set, and the number of fans to be obtained is increased depending on various race results other than the order of arrival and the progress during the race. However, the number of fans to be obtained by the main character is at least the base acquisition count corresponding to the order of arrival.

Note that, in some races, the number of fans is prescribed as a participation condition. In the case where the number of fans that have been obtained by the main character is less than the number of fans prescribed as the participation condition, the player cannot make the main character participate in that race. As the difficulty level of a race becomes higher, the number of fans to be required to participate in the race is increased.

In this way, a plurality of clear goals are set for each character. By achieving the clear goals, the player can continue the nurture main game until the final turn. On the other hand, in the case where the clear goals cannot be achieved, the nurture main game is ended in the corresponding turn.

As described above, in the main-character selection screen 150, which is shown in FIG. 5A, the player can select a main character while confirming various kinds of information on the individual characters. Then, when the next operation section 154 is tapped in the main-character selection screen 150, the selected character is set as the main character, and an inheritance character selection screen 170 is displayed on the display 26.

### <Registration of Inheritance Characters>

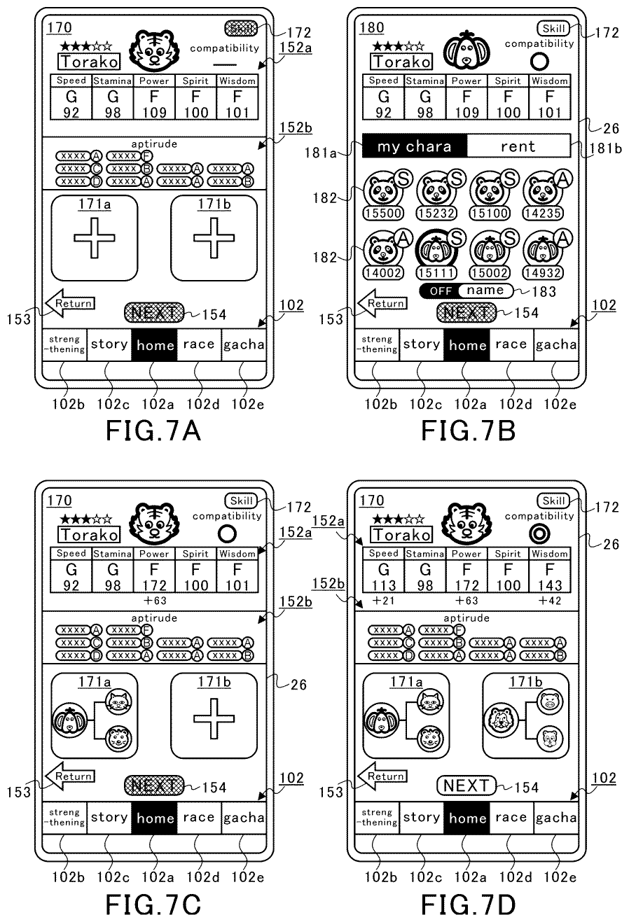

FIG. 7A is a first view for explaining the inheritance character selection screen 170. FIG. 7B is a first view for explaining a nurtured-character list screen 180. FIG. 7C is a second view for explaining the inheritance character selection screen 170. FIG. 7D is a third view for explaining the inheritance character selection screen 170. The inheritance character selection screen 170 is a screen in which the player registers inheritance characters.

The inheritance characters are characters from which the main character inherits the ability values, the skills, etc., of the inheritance characters. The player can select two inheritance characters, from among the nurtured characters possessed by the player himself/herself and a representative character of another player, e.g., a representative character of a friend, such as a follower, extracted according to a predetermined extraction condition, organize the two inheritance characters in a deck, and register the inheritance characters. Note that only one representative character of another player can be organized in a deck as an inheritance character in one nurture game.

In the inheritance character selection screen 170, the ability-parameter display section 152a, the aptitude-parameter display section 152b, a first inheritance-character selection area 171a, and a second inheritance-character selection area 171b are provided. When the screen is transitioned from the main-character selection screen 150 to the inheritance character selection screen 170, the first inheritance-character selection area 171a and the second inheritance-character selection area 171b are displayed in blank, as shown in FIG. 7A.

When the first inheritance-character selection area 171a or the second inheritance-character selection area 171b is tapped, the nurtured-character list screen 180, which is shown in FIG. 7B, is displayed. In the nurtured-character list screen 180, a my-character tab 181a and a rental tab 181b are provided. Furthermore, a nurtured-character-list display area is provided below the my-character tab 181a and the rental tab 181b. In the nurtured-character-list display area, nurtured-character icons 182 are displayed.

In a state in which the my-character tab 181a is selected, the nurtured-character icons 182 corresponding to the nurtured characters possessed by the player himself/herself are displayed, as shown in FIG. 7B. Furthermore, although not shown in the figures, in a state in which the rental tab 181b is selected, the nurtured-character icons 182 corresponding to representative characters of friends, i.e., nurtured characters that have been nurtured by the friends, are displayed.

Furthermore, when any of the nurtured-character icons 182 is tapped, the nurtured character corresponding to the tapped nurtured-character icon 182 is temporarily selected. Furthermore, when this nurtured-character icon 182 is tapped, the inheritance character selection screen 170 is displayed as shown in FIG. 7C. At this time, for example, in the case where the first inheritance-character selection area 171a is tapped, the nurtured-character list screen 180 is thus displayed, and any of the nurtured-character icons 182 is tapped in the nurtured-character list screen 180, an image indicating the nurtured character that is temporarily selected is displayed in the first inheritance-character selection area 171a.

In this state, for example, when the second inheritance-character selection area 171b is tapped, the nurtured-character list screen 180 is thus displayed, and any of the nurtured-character icons 182 is tapped in the nurtured-character list screen 180, an image indicating the nurtured character that is temporarily selected is displayed in the second inheritance-character selection area 171b, as shown in FIG. 7D.

Furthermore, information related to inheritance characters that were used when each nurtured character was nurtured is stored while being linked to the nurtured character. In the first inheritance-character selection area 171a, the information related to the inheritance characters that were used when the nurtured character was nurtured is displayed.

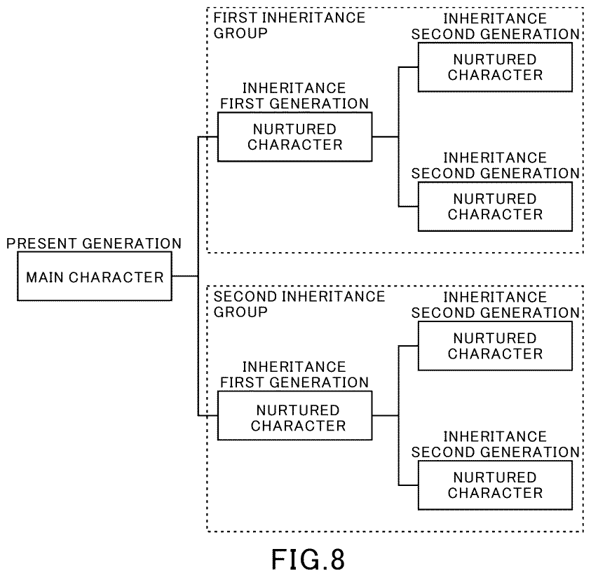

FIG. 8 is a view for explaining lineage of inheritance. In the nurture game, various benefits, such as an increase in the values of the ability parameters and the aptitude parameters of the main character, are provided on the basis of factor information of inheritance characters. Here, two inheritance characters are set for one main character, and these inheritance characters are nurtured characters that were generated earlier. Therefore, when the nurtured characters to be set as inheritance characters were generated, two inheritance characters were also set for each of these nurtured characters.

As shown in FIG. 8, a nurture-target main character in a nurture main game to be started from now is referred to as a character in the present generation. Furthermore, two nurtured characters set as inheritance characters for this main character are referred to as characters in an inheritance first generation. Furthermore, when nurture of each of the nurtured characters in the inheritance first generation was started, two nurtured characters were set as inheritance characters. The two nurtured characters set as the inheritance characters when each of the nurtured characters in the inheritance first generation was generated are referred to as characters in an inheritance second generation.

In this case, the nurtured characters in the inheritance first generation and in the inheritance second generation bring benefits to the main character in the present generation, as shown in FIG. 8. As described above, since two inheritance characters (in the inheritance first generation) are set for one main character, six nurtured characters in total bring benefits to one main character.

For example, one of the two nurtured characters in the inheritance first generation and the two nurtured characters in the inheritance second generation that are inheritance characters for this nurtured character are formed in a first inheritance group. Similarly, the other one of the two nurtured characters in the inheritance first generation and the two nurtured characters in the inheritance second generation that are inheritance characters for this nurtured character are formed in a second inheritance group.

As shown in FIG. 7D, icons individually corresponding to one nurtured character in the inheritance first generation and two nurtured characters in the inheritance second generation, these nurtured characters constituting the first inheritance group, are displayed in the first inheritance-character selection area 171a. Similarly, icons individually corresponding to one nurtured character in the inheritance first generation and two nurtured characters in the inheritance second generation, these nurtured characters constituting the second inheritance group, are displayed in the second inheritance-character selection area 171b.

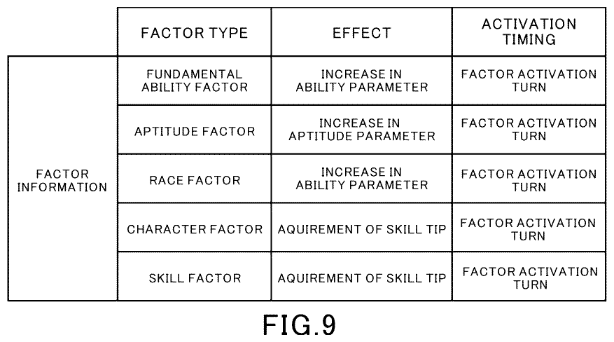

FIG. 9 is a view for explaining factor information. Although a detailed description will be given later, the nurture-target main character is registered as a nurtured character when the nurture game is completed, and, at this time, factor information is stored while being linked to the nurtured character. Specifically, when nurture of the nurtured character is completed, factors to be obtained by the nurtured character are determined by a lottery. Then, factor information indicating factors won by a lottery is linked to the nurtured character. In other words, when the nurture game is completed, the nurtured character can obtain factors won by a lottery.

However, the factors obtained by the nurtured character do not affect the abilities of this nurtured character. For example, the nurtured character can be made to participate in a race game such as a team competition game. At this time, in such a race, simulation, that is, arithmetic processing, for determining the order of arrival and the race development is performed on the basis of the ability parameters, the aptitude parameters, the obtained skills, etc., of all nurtured characters that participate in the race. Since the factors held by the nurtured characters are not used in the arithmetic processing, even if many factors are held, the race is not advantageously proceeded with.

The factors held by a nurtured character affect only the nurture-target main character in the case where this nurtured character is set as an inheritance character. Factors that can be obtained by a nurtured character are classified into a plurality of types. FIG. 9 shows, as factor types, a fundamental ability factor, an aptitude factor, a race factor, a character factor, and a skill factor. Either of a plurality of stages is set for each of the factors. Here, three stages of factor levels, i.e., level 1, level 2, and level 3, are provided as stages of a factor.

Note that the factor level is determined by a lottery. At this time, it is also possible that, after factors to be obtained by a nurtured character are determined, the factor levels for the individual obtained factors are determined by a lottery. Alternately, it is also possible that a winning ratio is set for each combination pattern of a factor and a factor level, and any combination pattern is determined on the basis of the set winning ratio. In this case, a factor to be obtained and a factor level thereof are determined at the same time.

Among the factor levels, level 3 is the most effective, and level 1 is the least effective. In the lottery for determining a factor level, the lowest winning rate is set for level 3, and the highest winning rate is set for level 1. However, the winning rate for a factor to be obtained and the winning rate for a factor level may change depending on the result of the nurture game. In this case, for example, a higher factor level may be determined as a nurtured character has higher ability parameters and higher evaluation points.

The fundamental ability factor increases the corresponding ability parameter of the main character. The fundamental ability factor includes five factors, i.e., a speed factor, a stamina factor, a power factor, a spirit factor, and a wisdom factor. A nurtured character always obtains one fundamental ability factor among the five fundamental ability factors. The five fundamental ability factors respectively correspond to the five ability parameters of speed, stamina, power, spirit, and wisdom. For example, in the case where a nurtured character in the inheritance first generation or in the inheritance second generation has the speed factor, the ability parameter of speed of the main character will be increased.

At this time, an increase value for the ability parameter of speed differs depending on the factor level of the speed factor. For example, in the case where the factor level of the speed factor is level 1, the ability parameter of speed of the main character is increased by “7”, in the case where the factor level thereof is level 2, the ability parameter thereof is increased by “13”, and, in the case where the factor level thereof is level 3, the ability parameter thereof is increased by “21”. Therefore, in the case where the total of six nurtured characters, including two nurtured characters in the inheritance first generation and four nurtured characters in the inheritance second generation, all have the speed factor of level 3, the ability parameter of speed of the main character is increased by 126 at most (increase value 21× six nurtured characters).

However, an activation timing and an activation condition are set for each factor. Therefore, even when an inheritance character has a factor, if the activation condition is not established at the activation timing, the benefit is not brought to the main character.

As described above, the nurture main game is composed of a plurality of turns, and predetermined turns of the turns are set as factor activation turns. For example, it is assumed that three turns, e.g., the 1st turn, the 30th turn, and the 54th turn, in the nurture main game are set as the factor activation turns. In these factor activation turns, it is determined, for each factor, whether the factor is to be activated or not. In the case where it is determined that the factor is to be activated, the activation condition for this factor is established, and the benefit corresponding to the factor is brought.

Note that whether the fundamental ability factor is activated or not is determined by a lottery. At this time, the winning rate of the lottery as to whether the fundamental ability factor is activated or not, that is, the rate of activating the fundamental ability factor (hereinafter, referred to as activation rate), may be different in the three factor activation turns. Here, in the 1st turn, the activation rate of the fundamental ability factor is set to 100% regardless of the factor level. Furthermore, in the 30th turn and the 54th turn, the activation rate of the fundamental ability factor is different depending on the factor level. In one example, in the 30th turn and the 54th turn, the activation rate of the fundamental ability factor of level 3 is set to 100%, the activation rate of the fundamental ability factor of level 2 is set to 90%, and the activation rate of the fundamental ability factor of level 1 is set to 80%.

In the inheritance character selection screen 170, an increase value(s) by which the ability parameter(s) is to be increased in the 1st turn is displayed for the ability parameter(s). For example, in FIG. 7C, one inheritance character that constitutes the first inheritance group is temporarily selected. In this case, the kind of the ability parameter to be increased in the 1st turn due to the temporarily selected one inheritance character and an increase value therefor are displayed. Here, “+63” is displayed below the ability parameter of power, which indicates that the ability parameter of power will be increased in the 1st turn by 63 points. Furthermore, the value obtained by adding the increase value, by which the ability parameter is to be increased in the 1st turn, is displayed in the ability-parameter display section 152a.

Furthermore, in FIG. 7D, two inheritance characters that constitute the first inheritance group and the second inheritance group are temporarily selected. In this case, the kinds of the ability parameters to be increased in the 1st turn due to the temporarily selected two inheritance characters and increase values thereof are displayed. Here, “+21”, “+63”, and “+42” are respectively displayed below the ability parameters of speed, power, and wisdom, which indicates that the ability parameters of speed, power, and wisdom will be increased in the 1st turn by 21 points, 63 points, and 42 points, respectively.

Note that, in the inheritance character selection screen 170, the increase value for the ability parameter to be increased due to the inheritance character that constitutes the first inheritance group and the increase values for the ability parameters to be increased due to the inheritance character that constitutes the second inheritance group are displayed in an identifiable manner. For example, in FIG. 7D, the color of “+63” displayed below the ability parameter of power is different from that of “+21” and “+42” displayed below the ability parameters of speed and wisdom.

The aptitude factor shown in FIG. 9 increases the corresponding aptitude parameter of the main character. The aptitude factor includes six factors, i.e., a turf factor, a dirt factor, a short-distance factor, a mile factor, a middle-distance factor, and a long-distance factor. A nurtured character always obtains one aptitude factor among the six aptitude factors. The six aptitude factors respectively correspond to a turf aptitude, a dirt aptitude, a short-distance aptitude, a mile aptitude, a middle-distance aptitude, and a long-distance aptitude. For example, in the case where a nurtured character that has the turf factor is included in the nurtured characters in the inheritance first generation or in the inheritance second generation, the aptitude parameter of the turf aptitude of the main character will be increased.

Note that an activation timing and an activation condition are also set for each aptitude factor, and, in the same factor activation turns as for the fundamental ability factor, it is determined, for each aptitude factor, whether the aptitude factor is to be activated or not. In the case where it is determined that the aptitude factor is to be activated, the corresponding aptitude parameter is increased by one stage. In one example, in the 1st turn, the activation rate of the aptitude factor is set to 100% regardless of the factor level.

For example, it is assumed that the aptitude factors of the three nurtured characters that belong to the first inheritance group are respectively the turf factor, the short-distance factor, and the mile factor, and the aptitude factors of the three nurtured characters that belong to the second inheritance group are respectively the turf factor, the short-distance factor, and the middle-distance factor. In this case, the turf aptitude and the short-distance aptitude of the main character are individually increased by two stages, and the mile aptitude and the middle-distance aptitude thereof are individually increased by one stage.

Furthermore, for example, it is assumed that the aptitude factors of the three nurtured characters that belong to the first inheritance group are all the turf factor, and the aptitude factors of the three nurtured characters that belong to the second inheritance group are all the short-distance factor. In this case, the turf aptitude and the short-distance aptitude of the main character are individually increased by three stages. Furthermore, in still another example, it is assumed that the aptitude factors of the three nurtured characters that belong to the first inheritance group are all the turf factor, and the aptitude factors of the three nurtured characters that belong to the second inheritance group are the turf factor, the short-distance factor, and the mile factor. In this case, the turf aptitude of the main character is increased by four stages, and the short-distance aptitude and the mile aptitude thereof are individually increased by one stage.

However, in the 1st turn, a limitation is set on the increase values for the aptitude parameters. Specifically, in the 1st turn, the upper limit for all the aptitude parameters is set to A. Therefore, in the case where the initial value of the turf aptitude of the main character is A, the turf aptitude will not be increased in the 1st turn even if any of the inheritance characters has the turf factor.

In contrast to this, in the 30th turn and the 54th turn, a lottery is performed, for each aptitude factor, to determine whether the aptitude factor is to be activated or not on the basis of the factor level. In one example, in the 30th turn and the 54th turn, the activation rate of the aptitude factor of level 3 is set to 5%, the activation rate of the aptitude factor of level 2 is set to 3%, and the activation rate of the aptitude factor of level 1 is set to 1%. In the 30th turn or the 54th turn, when it is determined by the lottery that the aptitude factor is to be activated, the aptitude parameter corresponding to the aptitude factor is increased. Note that, in the 30th turn and the 54th turn, the upper limit for each aptitude is raised from A to S. Therefore, in the 30th turn and the 54th turn, the value of the corresponding aptitude parameter can be increased up to S through activation of the aptitude factor.

Note that the value(s) of the aptitude parameter(s) that has been increased in the 1st turn is displayed in the aptitude-parameter display section 152b of the inheritance character selection screen 170.

The race factor increases the corresponding ability parameter of the main character. The race factor is provided for each race of a high difficulty level, for example, GI, (hereinafter, referred to as factor target race) among races in each of which participation is allowed in the nurture main game. When the nurture game is completed, a lottery is performed for each factor target race in which the main character came in 1st place, to determine whether the race factor is to be obtained or not. By winning the lottery, the nurtured character can obtain the race factor.

Note that a factor level is provided in the race factor, and, for each race factor that has been determined to be obtained, the factor level thereof is determined by a lottery. Furthermore, here, there is no upper limit on the number of race factors that can be obtained by one nurtured character, and a nurtured character can obtain a plurality of race factors.

For each race factor, an ability parameter to be increased through activation of the race factor and an increase value therefor are set in advance. For example, race factors include a factor for increasing the ability parameter of speed and a factor for increasing the ability parameter of power. At this time, an increase value for the ability parameter is increased as the factor level becomes higher.

Furthermore, an activation timing and an activation condition are also set for each race factor, and, in the factor activation turns, it is determined, for each race factor, whether the race factor is to be activated or not. In the case where it is determined that the race factor is to be activated, the ability parameter corresponding to the race factor is increased. Note that the factor activation turns for the race factors are limited to the 30th turn and the 54th turn. Furthermore, the activation rate of each of the race factors in the factor activation turns is different depending on the factor level, and the activation rate is increased as the factor level becomes higher.

The character factor is a factor unique to a character, and, for example, only in the case where a character strengthened to a predetermined level is nurtured as the main character, the character factor set for this character is always given to the nurtured character when the nurture game is completed. Note that, since only one character factor is set for one character, one nurtured character can obtain at most one character factor.

Furthermore, in the case where a nurtured character is generated on the basis of a character that has not been strengthened to the predetermined level, the character factor cannot be obtained.

Furthermore, the character factor can be activated in a factor activation turn set in advance and is activated by winning a lottery executed in the factor activation turn. When the character factor is activated, a tip event set for the character factor occurs, and a tip for a skill can be obtained, as described above.

The skill factor is given on the basis of an obtained skill that has been obtained by a nurtured character. Specifically, when the nurture game is completed, a lottery is performed, for each of the obtained skills that have been obtained by the nurtured character, to determine whether the corresponding skill factor is to be obtained or not. By winning the lottery, the skill factor is given to the nurtured character. That is, the nurtured character can obtain part or all of the skill factors corresponding to the obtained skills. Note that, when it is determined that a skill factor is obtained, the factor level of the skill factor is determined by a lottery.

Furthermore, the skill factor can be activated in a factor activation turn set in advance and is activated by winning a lottery executed in the factor activation turn. At this time, the winning rate is increased as the factor level is higher. When the skill factor is activated, a tip event set for the skill factor occurs, and a tip for a skill can be obtained. Accordingly, the main character can obtain the same skills as the obtained skills that have been obtained by the inheritance characters.

In this way, whether a skill factor is obtained or not is determined within the range of the obtained skills that have been obtained by the nurtured character. Therefore, the possibility of obtaining skill factors is increased as the nurtured character has more obtained skills. However, since whether a skill factor is obtained or not is determined by a lottery, even if the nurtured character has many obtained skills, skill factors may not be obtained, in some cases.

Note that, although, here, a nurtured character obtains a skill factor separately from an obtained skill, it is also possible that skill factors are not provided, and skills that can be obtained by the main character are determined on the basis of the obtained skills held by the nurtured characters serving as the inheritance characters.

As described above, the ability parameters of the main character significantly change depending on the inheritance characters organized in the deck. Furthermore, even if the abilities of a nurtured character itself are high, whether each factor is to be obtained or not is determined by a lottery; thus, it is not always the case that a nurtured character having high abilities is suitable as an inheritance character. On the other hand, even in the case where the abilities of a nurtured character itself are not high, the nurtured character effectively functions as an inheritance character by obtaining many factors of high factor levels, in some cases. In this way, inheritance characters can be organized in a deck, thereby bringing an interest not only in nurturing a simply powerful nurtured character but also in nurturing the nurtured character effective as an inheritance character.

Furthermore, in this embodiment, the compatibility is judged among the main character, a nurtured character in the inheritance first generation, and a nurtured character in the inheritance second generation. Then, in the case of a combination of characters having a good compatibility, the activation conditions for factors become advantageous.

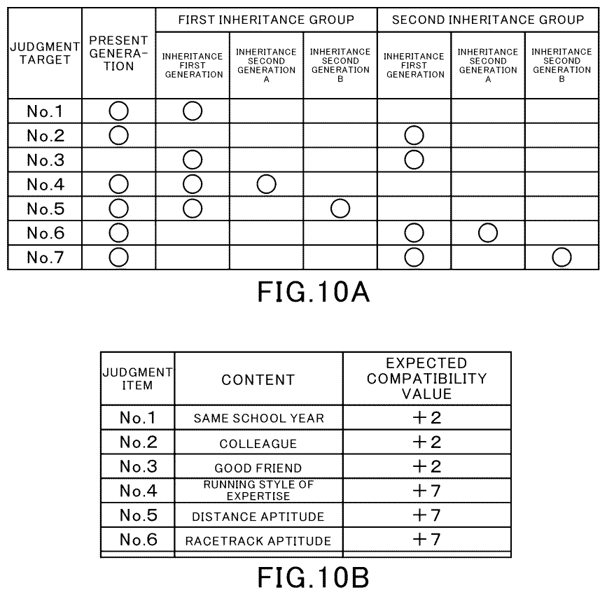

FIG. 10A is a view for explaining compatibility judgment targets, and FIG. 10B is a view for explaining compatibility judgment items. As shown in FIG. 10A, in this embodiment, seven judgment targets from No. 1 to No. 7 are provided. A first judgment target (No. 1) includes the main character in the present generation and a nurtured character in the inheritance first generation in the first inheritance group. A second judgment target (No. 2) includes the main character in the present generation and a nurtured character in the inheritance first generation in the second inheritance group.

A third judgment target (No. 3) includes the nurtured character in the inheritance first generation in the first inheritance group and the nurtured character in the inheritance first generation in the second inheritance group. A fourth judgment target (No. 4) includes the main character in the present generation, the nurtured character in the inheritance first generation in the first inheritance group, and one (nurtured character A) of the nurtured characters in the inheritance second generation in the first inheritance group. A fifth judgment target (No. 5) includes the main character in the present generation, the nurtured character in the inheritance first generation in the first inheritance group, and the other one (nurtured character B) of the nurtured characters in the inheritance second generation in the first inheritance group.

A sixth judgment target (No. 6) includes the main character in the present generation, the nurtured character in the inheritance first generation in the second inheritance group, and one (nurtured character A) of the nurtured characters in the inheritance second generation in the second inheritance group. A seventh judgment target (No. 7) includes the main character in the present generation, the nurtured character in the inheritance first generation in the second inheritance group, and the other one (nurtured character B) of the nurtured characters in the inheritance second generation in the second inheritance group.

For each of the judgment targets, whether a condition is established or not is judged with respect to each of a plurality of judgment items. FIG. 10B shows examples of the judgment items. In this embodiment, a worldview of the game is set in which characters that can each be selected as the main character are students, and the individual characters do trainings at school.

Then, as shown in FIG. 10B, school year, colleague, and good friend are set in advance for the characters. The judgment items include items of content indicating, for example, whether two or three judgment-target characters are in the same school year, are colleagues, or are good friends. Furthermore, the judgment items include items of content indicating whether the judgment-target characters have the same best running style, distance aptitude, or racetrack aptitude.

Then, expected compatibility values are linked to the judgment items, and the expected compatibility values of the judgment items that are established between the judgment-target characters are accumulated. Here, although the expected compatibility values are different depending on the judgment items, the expected compatibility values may be common to all the judgment items.

For example, in the case where the compatibility is to be judged, first it is judged whether the judgment items are each established or not between the main character in the present generation and the nurtured character in the inheritance first generation in the first inheritance group, which are included in the first judgment target. At this time, the expected compatibility value linked to an established judgment item is accumulated and counted. In this way, the expected compatibility value is counted sequentially from the first judgment target to the seventh judgment target, and the activation rates of factors are corrected on the basis of the finally calculated expected compatibility value. That is, the activation rates of all factors are increased as the expected compatibility value becomes higher, and the activation rates of all factors are decreased as the expected compatibility value becomes lower.

Note that the activation rates may be calculated by using the calculated expected compatibility value as a correction value. Furthermore, for example, a correction value for correcting the activation rates of factors may be set for each compatibility level, and the compatibility level may be determined by the calculated expected compatibility value.

In this way, since the activation rates of factors are different depending on the compatibility between the main character and an inheritance character or the compatibility between inheritance characters, a combination of two inheritance characters have a great influence on the nurture of the main character. That is, the compatibility between characters is an important judgment material in selecting inheritance characters.

As shown in FIGS. 7B, 7C, and 7D, with inheritance characters being selected, a compatibility mark indicating the compatibility is displayed at an upper right section of the inheritance character selection screen 170 and the nurtured-character list screen 180. Here, the compatibility level of the selected characters is indicated by any of three compatibility marks including double circle (i.e., excellent), single circle (i.e., good), and triangle (i.e., acceptable), as shown in FIGS. 7B, 7C, and 7D. Note that, as shown in FIG. 7A, with no inheritance characters being selected, none of the compatibility marks is displayed.

Furthermore, as shown in FIG. 7B, a display switch button 183 is provided in the nurtured-character list screen 180. When the display switch button 183 is operated, a display condition setting screen (not shown) is displayed. In the display condition setting screen, the player can sort or filter the nurtured-character icons 182 to be displayed in the nurtured-character list screen 180, that is, the nurtured characters that can be selected as inheritance characters.

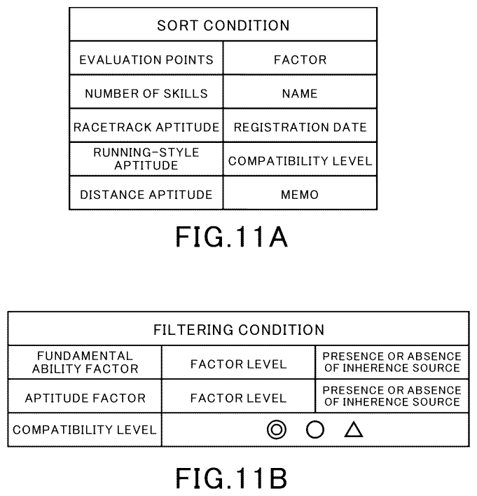

FIG. 11A is a view for explaining a sort condition. FIG. 11B is a view for explaining a filtering condition. In the display condition setting screen, the player can select and set a sort condition shown in FIG. 11A. Here, it is possible to select and set, as a sort condition, any of the evaluation points, a factor, the number of skills, the name, the racetrack aptitude, the registration date, the running-style aptitude, the compatibility level, the distance aptitude, and a memo. When a sort condition is set, the nurtured-character list screen 180 is displayed. At this time, the display order of the nurtured-character icons 182 has been changed according to the sort condition, in the nurtured-character list screen 180.

Furthermore, in the display condition setting screen, the player can select and set a filtering condition shown in FIG. 11B. Here, the fundamental ability factor, the aptitude factor, and the compatibility level are provided as filtering conditions. Note that, when the fundamental ability factor or the aptitude factor is set as a filtering condition, only the nurtured characters that have the factor selected by the player are displayed in the nurtured-character list screen 180.

At this time, the player can set the factor level. For example, when filtering is performed by setting the factor level to level 3, only the nurtured characters that have the factor of level 3, among the factor selected by the player, are displayed in the nurtured-character list screen 180. Note that the player can select whether a factor is held by the nurtured characters themselves or is held by inheritance characters of the nurtured characters, to perform filtering of the nurtured characters.

Furthermore, the player can perform filtering based on the compatibility level. Here, it is possible to filter nurtured characters having a compatibility of double circle (i.e., excellent), nurtured characters having a compatibility of single circle (i.e., good), or nurtured characters having a compatibility of triangle (i.e., acceptable). In this way, it is possible to perform sorting and filtering by various conditions, whereby the convenience of the player is improved.

Furthermore, when any of the nurtured-character icons 182 is pressed and held in the nurtured-character list screen 180, which is shown in FIG. 7B, detailed information on the nurtured character corresponding to the nurtured-character icon 182 is displayed.

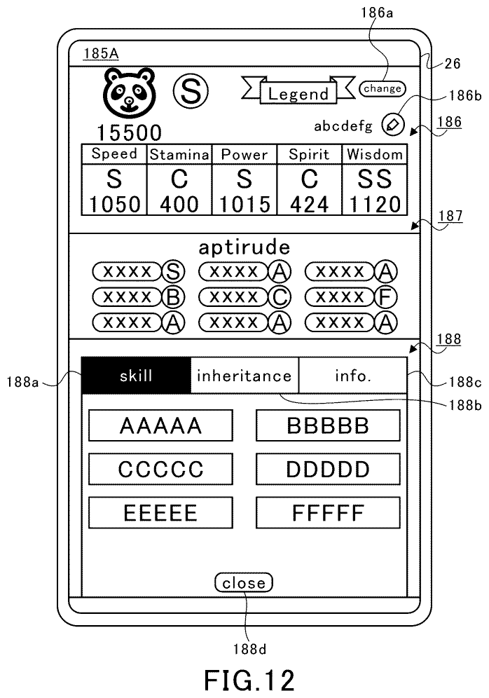

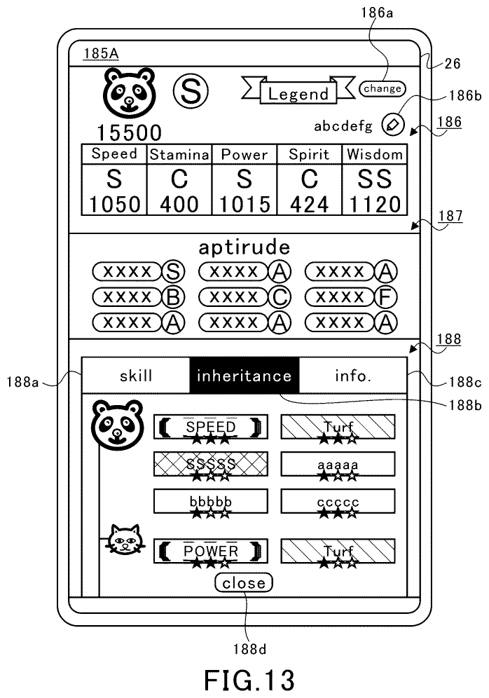

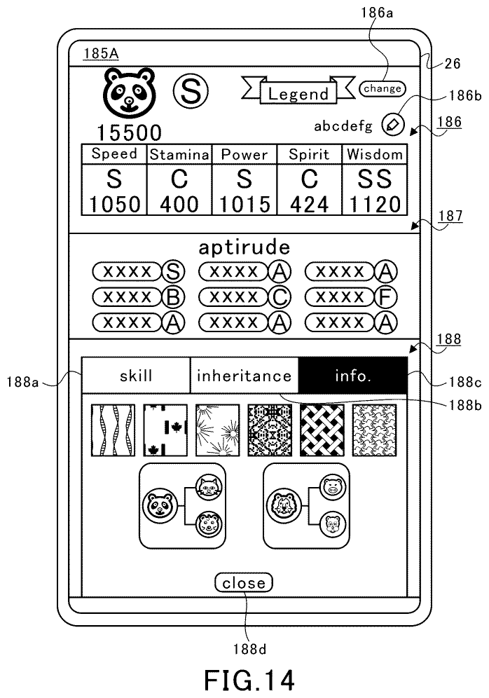

FIG. 12 is a first view for explaining a character detail dialog 185A. FIG. 13 is a second view for explaining the character detail dialog 185A. FIG. 14 is a third view for explaining the character detail dialog 185A. In the character detail dialog 185A, detailed information on the nurtured character is displayed. An ability-parameter display field 186 indicating the ability parameters of the nurtured character is displayed at an upper section of the character detail dialog 185A.

At the upper left of the ability-parameter display field 186, an icon indicating the character that is the basis of the nurtured character and the evaluation points and the nurture rank of the nurtured character are displayed. Furthermore, a nickname change button 186a and a memo input button 186b are provided at the upper right of the ability-parameter display field 186. When the nickname change button 186a is tapped, a nickname list screen (not shown) is displayed. In the nickname list screen, nicknames obtained by the nurtured character are displayed in a list. Note that, in the nurture main game, a number of nicknames are provided, and an acquisition condition is set for each of all the nicknames.

In the nurture main game, a nickname for which the acquisition condition is satisfied is given to the nurtured character. The player can select one from among the nicknames obtained by the nurtured character and set the nickname to the nurtured character. The player can change the nickname to be set to the nurtured character, in the nickname list screen. The currently set nickname (here, Legend) is displayed at the left side of the nickname change button 186a.

Note that examples of the nickname acquisition condition are that the main character obtains a predetermined number of fans, that the ability parameters or the aptitude parameters are equal to or higher than a predetermined value, that a predetermined skill is obtained, that the number of race wins is equal to or higher than a predetermined number, and that a predetermined order of arrival (for example, the 1st place) is obtained in a specific race.

Furthermore, when the memo input button 186b is tapped, a letter input screen (not shown) is displayed. In the letter input screen, 9 letters or less can be input in, for example, Hiragana, Katakana, numbers, Roman alphabets, etc. Letters that are input in the letter input screen are stored, as a memo, while being linked to the nurtured character. In the case where a memo is stored for the nurtured character, the memo (here, abcdefg) is displayed at the left side of the memo input button 186b.

Note that the above-mentioned memo is included in the sort conditions for the nurtured-character icons 182 in the nurtured-character list screen 180. Therefore, when the player registers a memo while making it linked to each nurtured character, it becomes easier to search for a nurtured character to be used as an inheritance character.

Furthermore, an aptitude information display field 187 is displayed below the ability-parameter display field 186. In the aptitude information display field 187, displayed are: aptitude parameters related to the racetrack aptitudes for turf and dirt; aptitude parameters related to the distance aptitudes for short distance, mile, middle distance, and long distance; and aptitude parameters related to the running-style aptitudes for runaway winner, front runner, come-from-behind runner, and stretch runner.

A various-kinds-of-information display field 188 is displayed below the aptitude information display field 187. In the various-kinds-of-information display field 188, a skill display tab 188a, an inheritance information display tab 188b, a nurture information display tab 188c, and a close operation section 188d are provided. When the skill display tab 188a is tapped, obtained skills of the nurtured character are displayed in the various-kinds-of-information display field 188, as shown in FIG. 12. Furthermore, when the inheritance information display tab 188b is tapped, inheritance information of the nurtured character is displayed, as shown in FIG. 13.

Note that, in the various-kinds-of-information display field 188, the inheritance information is displayed on the basis of the nurtured character that can be set as an inheritance character and the inheritance characters that have been used for the nurture of the nurtured character. The inheritance information includes: information on the inheritance characters that have been used for the nurture of this nurtured character; factor information of the nurtured character; and factor information of the inheritance characters. Here, the inheritance information is displayed in a list for each nurtured character.

Specifically, factor information linked to the nurtured character and factor information linked to the inheritance characters for the nurtured character are displayed for each character. Therefore, the player can confirm the factor information of the three characters by scrolling the various-kinds-of-information display field 188 in the vertical direction.

In the various-kinds-of-information display field 188, the fundamental ability factor, the aptitude factor, and the character factor are displayed in different colors. For example, the fundamental ability factor is displayed in blue, the aptitude factor is displayed in red, and the character factor is displayed in green. Note that, in the various-kinds-of-information display field 188, the race factor(s) and the skill factor(s) are displayed in white. Furthermore, stars indicating the factor level are displayed for each piece of factor information so as to be overlaid thereon.

Furthermore, when the nurture information display tab 188c is tapped, nurture information on the nurtured character is displayed, as shown in FIG. 14. Note that the nurture information includes: the types of support cards that have been used to nurture the nurtured character; the characters in the inheritance first generation and the inheritance second generation; the results of individual races in the nurture game; and the evaluation points.

In this way, the player can confirm various kinds of information related to the nurtured character, in the character detail dialog 185A. Therefore, it is easy for the player to grasp information linked to inheritance characters to be organized into a deck, whereby it is possible to improve the convenience of the player.

Note that, when the close operation section 188d is tapped in the character detail dialog 185A, the character detail dialog 185A is closed, and the nurtured-character list screen 180 is displayed on the display 26. Furthermore, as shown in FIGS. 7A, 7B, 7C, and 7D, a skill display button 172 is provided at an upper right section of the inheritance character selection screen 170 and the nurtured-character list screen 180. When the skill display button 172 is tapped, skills that can be obtained due to the nurtured character(s) temporarily selected as an inheritance character(s) are displayed in a list.

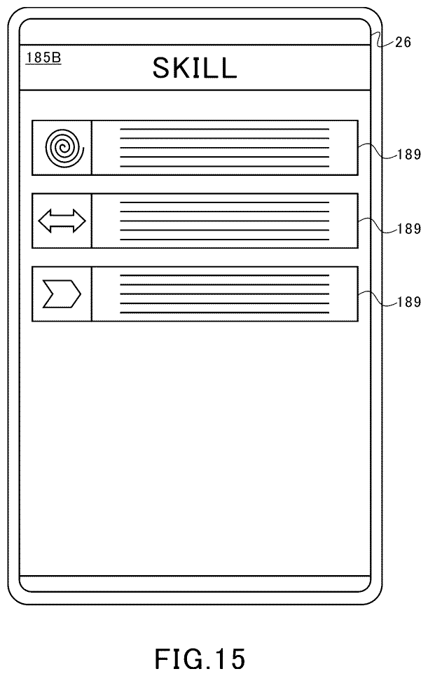

FIG. 15 is a view for explaining a skill display dialog 185B. In the skill display dialog 185B, skill explanation display fields 189 are displayed, each of which shows an icon corresponding to a skill and the content of the skill. In the skill explanation display fields 189, all skills that can be obtained by the main character in the case where the currently selected nurtured character(s) is used as an inheritance character(s) are displayed in a list.

That is, pieces of information related to the skills linked to the character factor(s) or the skill factor(s) of the nurtured character(s) are displayed in a list in the skill display dialog 185B. As shown in FIG. 7C, in the case where the skill display button 172 is tapped with one nurtured character being selected as an inheritance character, skills linked to the character factor and the race factor(s) of this one nurtured character (inheritance character) are displayed in the skill display dialog 185B.

On the other hand, as shown in FIG. 7D, in the case where the skill display button 172 is tapped with two nurtured characters being selected as inheritance characters, skills linked to the character factors and the race factors of the two nurtured characters (inheritance characters) are displayed in the skill display dialog 185B.

As described above, in this embodiment, in the character detail dialog 185A, inheritance information (factor information) is displayed in a list for each nurtured character that can be set as an inheritance character. Furthermore, in the skill display dialog 185B, information (skills) linked to the inheritance information (factor information) is displayed in a list. At this time, the character detail dialog 185A and the skill display dialog 185B are displayed on the basis of the nurtured character that can be set as an inheritance character and the inheritance characters that have been used for nurture of the nurtured character. The convenience of the player is improved by displaying the character detail dialog 185A and the skill display dialog 185B.

Note that, here, skills that can be obtained through activation of factors are displayed in the skill display dialog 185B. However, instead of information related to skills, factor information from which a tip for a skill can be obtained may be displayed in the skill display dialog 185B. In any case, it is preferred that the inheritance information (factor information) is classified into a plurality of types (factor types), and the inheritance information (the character factor and the race factor(s)) classified into a predetermined type or information (information related to skills) linked to the inheritance information is displayed in the skill display dialog 185B. In this way, it can be said that part of the inheritance information is extracted, and the extracted inheritance information is displayed in the skill display dialog 185B.

Then, when two nurtured characters are temporarily selected, a next operation section 154 provided in the inheritance character selection screen 170 is enabled. When the enabled next operation section 154 is tapped, the nurtured characters that are temporarily selected are temporarily registered in a deck as inheritance characters, and a support-card organization screen 190, to be described later, is displayed.

Note that the player always has to select two nurtured characters as inheritance characters in the inheritance character selection screen 170. In the case where two inheritance characters have not been temporarily selected, the next operation section 154 is grayed out, as shown in FIGS. 7A and 7C, thus being disabled to accept a player's operation. Furthermore, a return operation section 153 is provided in the inheritance character selection screen 170, and, when the return operation section 153 is tapped, the main-character selection screen 150 is displayed.

### <Registration of Support Cards>

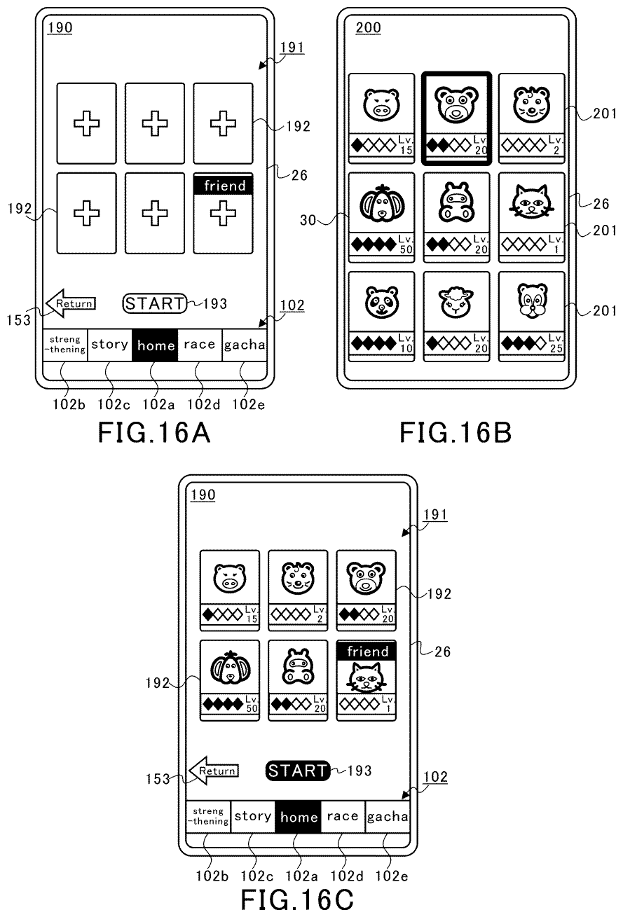

FIG. 16A is a first view for explaining the support-card organization screen 190. When two inheritance characters are registered in the inheritance character selection screen 170, the support-card organization screen 190, which is shown in FIG. 16A, is displayed. A support-card display area 191 is provided at a central section of the support-card organization screen 190. A plurality of support-card display frames 192 are included in the support-card display area 191.

Furthermore, a return operation section 153, in which “Return” is written, and a start operation section 193, in which “START” is written, are displayed at a lower section of the support-card organization screen 190.

The plurality of (here, six) support-card display frames 192 are displayed in the support-card display area 191. The same number of support-card display frames 192 as the number of support cards that can be set by the player is displayed. Note that, when the support-card organization screen 190 is displayed at first, the support-card display frames 192 are displayed in blank.

In this embodiment, the player can set six kinds of support cards in the deck. Note that part (for example, five kinds) of the six kinds of support cards, which can be set by the player, can be selected from among support cards that are possessed by the player. Furthermore, the other part (for example, one kind) of the six kinds of support cards, which can be set by the player, can be selected from among support cards that are set as rental cards by another player such as a friend.

FIG. 16B is a view for explaining a support-card selection screen 200. When any of the support-card display frames 192 (except the support-card display frame 192 that is displayed at the lower right) is tapped in the support-card organization screen 190 shown in FIG. 16A, the support-card selection screen 200, which is shown in FIG. 16B, is displayed on the display 26. In the support-card selection screen 200, card icons 201 corresponding to support cards possessed by the player are displayed in a list. The player can select support cards by tapping the corresponding card icons 201 displayed in the support-card selection screen 200.

Note that, although not shown in the figures, when the support-card display frame 192 that is displayed at the lower right is tapped in the support-card organization screen 190, a support card(s) that is set as a rental card(s) by a friend or a player extracted on the basis of a predetermined condition such as a lottery, for example, is displayed in the support-card selection screen 200. The player can select one support card of the friend by tapping the support card displayed at this time in the support-card selection screen 200. In this way, the player can use a support card possessed by another player, in the nurture game.

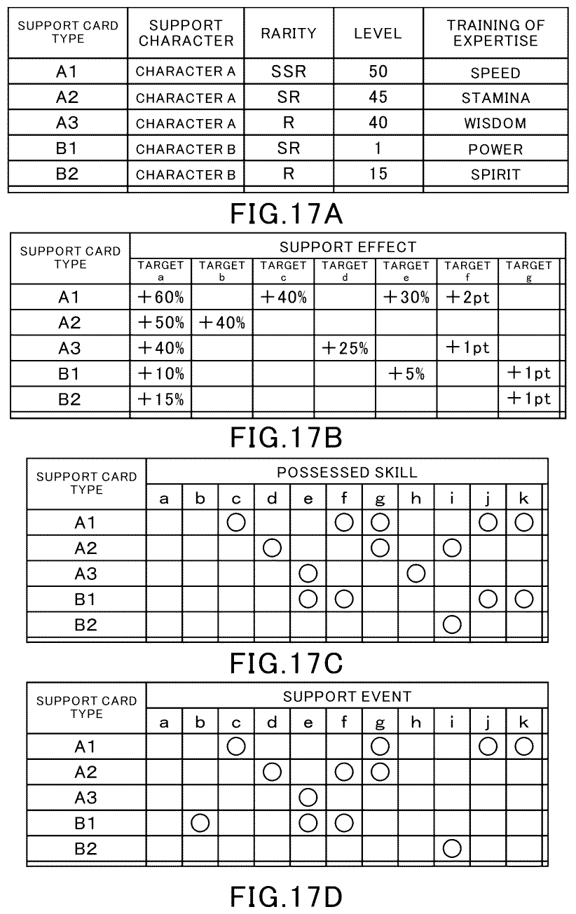

FIG. 17A is a view for explaining a support card table. As shown in FIG. 17A, the support card table records, for each type (that is, support card ID) of a support card possessed by the player, the kind (that is, character ID) of a support character, the rarity, the level, and training of expertise. The support character corresponds one-to-one to the type of the support card. That is, one character ID is always linked to one support card ID. In other words, one support character is always made to correspond to one support card.

In this embodiment, the rarity is set for each support card. Three stages, i.e., R (rare), SR (super rare), and SSR (super special rare), are provided for the rarity. Note that R is set as the lowest rarity, and SSR is set as the highest rarity. In this embodiment, a support card having a higher rarity tends to have a higher support effect, to be described later. Furthermore, in this embodiment, a support card having a higher rarity tends to have a larger number of possessed skills and a larger number of support events, to be described later.

As the levels of a support card, 50 stages from level 1 to level 50 are provided. The level of a support card can be raised by the player, and the level raised by the player is stored for each support card. Note that the level of a support card can be raised by using the in-game currency, an item, or the like. Note that an upper limit is provided for the level of a support card depending on the rarity thereof.

For example, level 20 is set as the upper limit for a support card that has the rarity R, level 25 is set as the upper limit for a support card that has the rarity SR, and level 30 is set as the upper limit for a support card that has the rarity SSR.

Note that the upper limit of the level can be raised in stages in the case where a predetermined condition is established. For example, it is also possible that the upper limit can be raised up to level 40 for a support card that has the rarity R, the upper limit can be raised up to level 45 for a support card that has the rarity SR, and the upper limit can be raised up to level 50 for a support card that has the rarity SSR.

FIG. 17B is a view for explaining a support effect table. As shown in FIG. 17B, the support effect table records support effects for each type of a support card possessed by the player.

The support effects raise various statuses in the nurture main game. A plurality of support-effect targets are provided for each support card. Examples of the support-effect targets are physical strength, speed, stamina, power, spirit, wisdom, etc.

FIG. 17C is a view for explaining a possessed-skill table. As shown in FIG. 17C, a possessed skill(s) is set for each of the support cards possessed by the player, in the possessed-skill table. In this embodiment, a possessed skill(s) is set for each support card such that a character that is set as the main character by the player possesses the possessed skill(s). A possessed skill set for each support card can be obtained by the main character, which is selected by the player, when a tip event occurs during the nurture main game.

FIG. 17D is a view for explaining a support event table. As shown in FIG. 17D, in the support event table, a support event(s) that could occur is recorded for each of the support cards possessed by the player. The support event is an event that could occur during the execution of the nurture main game. In the case where a support event occurs, the values of various statuses in the nurture main game are increased or decreased, in some cases.

For example, a support event that is to occur may be determined according to the number of turns or may be determined by a predetermined lottery. Furthermore, a plurality of support events that are to occur may be selected in one turn. In any case, a support event that is to occur just needs to be determined according to a predetermined determination method set in advance.

Note that support events may include: a first tip event that could occur at the start of a turn in the nurture game; a second tip event that could occur after execution of training, to be described later, in the nurture game; a first ability event that could occur at the start of a turn in the nurture game; a second ability event that could occur after execution of training in the nurture game; etc. The first tip event and the second tip event are events for allowing skills to be possessed or obtained. Furthermore, the first ability event and the second ability event are events for increasing or decreasing the values of the ability parameters of the character. Hereinafter, the first tip event and the first ability event are collectively referred to as a first event(s) and the second tip event and the second ability event are collectively referred to as a second event(s).

FIG. 16C is a second view for explaining the support-card organization screen 190. In this embodiment, when six support cards are all selected, the start operation section 193 can be operated, as shown in FIG. 16C. On the other hand, in the case where six support cards have not all been selected, the start operation section 193 cannot be operated, as shown in FIG. 16A.

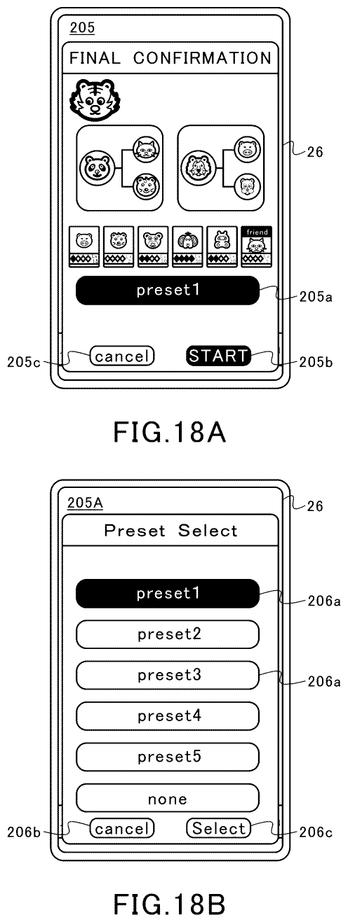

Note that, when the return operation section 153 is operated in the support-card organization screen 190, the inheritance character selection screen 170 shown in FIG. 7D is displayed on the display 26. Furthermore, as shown in FIG. 16C, when the start operation section 193 is tapped in the support-card organization screen 190, the selected support cards are temporarily registered, and a final confirmation screen 205 (FIG. 18A) is displayed.

FIG. 18A is a view for explaining the final confirmation screen 205. FIG. 18B is a view for explaining a preset selection screen 205A. In the final confirmation screen 205, the main character selected by the player, the nurtured characters that constitute the first inheritance group, the nurtured characters that constitute the second inheritance group, and the support cards are displayed. Furthermore, a preset display section 205a is displayed in the final confirmation screen 205. The number of a preset that is currently selected is shown in the preset display section 205a.

Here, a preset is reservation information on a race in which the main character is made to participate, in the nurture main game. The player can select an arbitrary race from among all races, to generate a preset. A plurality of presets can be stored, and, in the final confirmation screen 205, it is possible to select one from among the stored presets. Specifically, when the preset display section 205a is tapped, the preset selection screen 205A, which is shown in FIG. 18B, is displayed.

In the preset selection screen 205A, preset read buttons 206a corresponding to the stored presets are displayed. The player can set a preset by tapping any of the preset read buttons 206a and then tapping a selection operation section 206c. Note that, when the selection operation section 206c is tapped, the preset selection screen 205A is closed, and the final confirmation screen 205 is displayed. Furthermore, when a cancel operation section 206b in the preset selection screen 205A is tapped, the preset selection screen 205A is displayed without changing the preset.

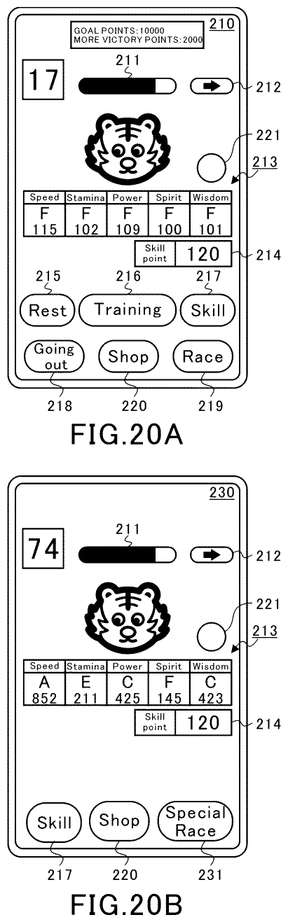

Note that, when a cancel operation section 205c is tapped in the final confirmation screen 205, the support-card organization screen 190 is displayed. On the other hand, when a start operation section 205b is tapped, a game screen 210 (FIG. 20A) is displayed on the display 26.

Note that, in this embodiment, when support cards are registered, limitation is provided such that the character type that is set as the main character and the character type that is set as a support character do not overlap.

As described above, when the main character, the inheritance characters, and the support cards have been registered, the preparatory-stage processing ends.

### <Nurture-Stage Processing>

When the preparatory-stage processing ends, the nurture-stage processing is started. In the nurture-stage processing, the main character can be nurtured. Note that, for ease of understanding, the basic flow of the nurture main game will be first described below.

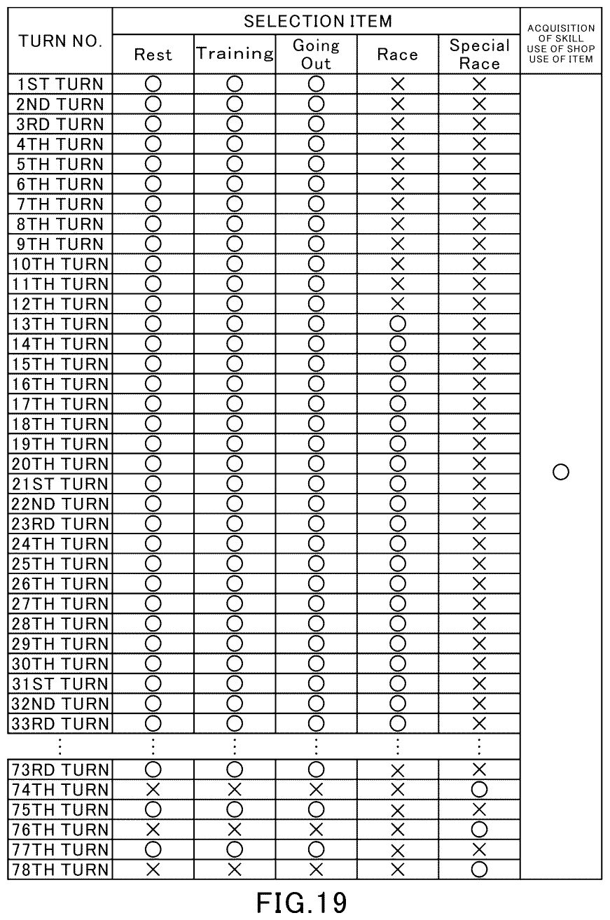

FIG. 19 is a view for explaining a selection item table. Note that, here, the selection item table is provided for each type of a main character. However, it is also possible to provide a common selection item table regardless of the type of the main character. The nurture game is composed of a plurality of turns from the 1st turn to the 78th turn, as shown in FIG. 19, and has a game property in which the various parameters are updated in accordance with a player's selection result in each of the turns. Furthermore, according to the selection item table, an item(s) that can be selected by the player is set in advance for each turn.

FIG. 20A is a view for explaining the game screen 210. FIG. 20B is a view for explaining a special race screen 230. When a transition is made to the nurture-stage processing, the game screen 210, which is shown in FIG. 20A, is displayed on the display 26. A physical-strength display section 211 and a physical-condition display section 212 are displayed at an upper section of the game screen 210. A parameter of “physical strength” is provided for the main character. The parameter of “physical strength” is mainly used to calculate a failure rate that is the possibility of failing in training, to be described later. The physical-strength display section 211 is displayed such that the current remaining amount of “physical strength” of the main character with respect to the upper limit of “physical strength” can be visually grasped.

Furthermore, a parameter of “physical condition” is provided for the main character. The physical-condition display section 212 is displayed such that the current “physical condition” of the main character can be visually grasped by a plurality of stages (five stages of very bad condition, bad condition, normal condition, good condition, and very good condition). As the parameter of “physical condition” becomes higher, the race development becomes advantageous to the main character, and the increase values for the ability parameters due to training become higher.

Furthermore, the image of the main character, a status display section 213, and a skill-point display section 214 are displayed at a central section of the game screen 210, as shown in FIG. 20A. In the status display section 213, the current statuses of the main character are shown by numerical values and ranks in a plurality of stages (16 stages of G⁺, F, F⁺, E, E⁺, D, D⁺, C, C⁺, B, B⁺, A, A⁺, S, SS, and SS⁺). Specifically, in this embodiment, the values and the ranks of the ability parameters of “Speed” (speed), “Stamina” (stamina), “Power” (power), “Spirit” (spirit), and “Wisdom” (wisdom) are displayed. Furthermore, in the skill-point display section 214, the remaining amount of the skill points possessed by the main character in the nurture game is numerically shown.

Furthermore, as shown in FIG. 20A, a rest operation section 215, in which “Rest” is written, a training operation section 216, in which “Training” is written, a skill operation section 217, in which “Skill” is written, a going-out operation section 218, in which “Going Out” is written, an individual-race operation section 219, in which “Race” is written, and a shop operation section 220, in which “Shop” is written, are displayed at a lower section of the game screen 210. Furthermore, the number of the current turn is displayed at an upper section of the game screen 210. Furthermore, an item operation section 221 is displayed at a central section of the game screen 210.

As shown in FIG. 19, the player can select, in each turn, any of items of “Rest” (the rest operation section 215), “Training” (the training operation section 216), “Going Out” (the going-out operation section 218), “Race” (the individual-race operation section 219), and “Special Race” (a special-race operation section 231), to be described later. At this time, an item(s) that can be selected in the individual turns is set in advance, as shown in FIG. 19.

When the item of “Rest” is selected, the physical strength is restored. When the item of “Going Out” is selected, the physical condition is increased. Furthermore, when the item of “Training” is selected, training, to be described later, can be executed. When the item of “Race” is selected, the main character can be made to participate in an individual race. When the item of “Special Race” is selected, the main character can be made to participate in a special race, to be described later. When any of the items of “Rest”, “Training”, “Going Out”, “Race”, and “Special Race” is selected, and a game result is derived, the current turn ends, and a transition is made to the next turn.

In this embodiment, as in the 74th turn, the 76th turn, and the 78th turn shown in FIG. 19, turns are set in which the items of the rest operation section 215, the training operation section 216, the going-out operation section 218, and the individual-race operation section 219 cannot be selected. In those turns, the special race screen 230 is displayed on the display 26, as shown in FIG. 20B.

In the special race screen 230, the special-race operation section 231, in which “Special Race” is written, the skill operation section 217, the shop operation section 220, and the item operation section 221 are displayed, and any of the operation sections can be selected by the player. When the special-race operation section 231 is selected, a special race is executed, which is different from an individual race executed when the individual-race operation section 219 is selected. A special race is executed in each of the 74th turn, the 76th turn, and the 78th turn, i.e., in three races in total, and is a race to determine the winner on the basis of a cumulative value of victory points, to be described later.

On the other hand, the skill operation section 217, the shop operation section 220, and the item operation section 221 are set so as to be always selectable in all the turns. Note that, although a detailed description will be given later, even when the skill operation section 217, the shop operation section 220, or the item operation section 221 is operated to obtain a skill, to use a shop, or to use an item, the corresponding turn does not end.

In this embodiment, when an individual race or a special race is executed, the main character can obtain the victory points and the special currency in accordance with the order of arrival in the race. In each race, the amount of victory points to be obtained and the amount of special currency to be obtained are defined for each order of arrival. The values of the victory points and the special currency to be obtained are increased as the order of arrival is higher.

Furthermore, more victory points and more special currency can be obtained as the difficulty level of a race is higher. For example, more victory points and more special currency can be obtained in a race of a higher grade among the grades of GI, GII, and GIII.

In the nurture game of this embodiment, predetermined goal points are set for each prescribed turn segment. As described above, in this embodiment, the nurture game is composed of a plurality of turns from the 1st turn to the 78th turn. Here, a segment from the 1st turn to the 24th turn is referred to as an early turn segment, a segment from the 25th turn to the 48th turn is referred to as a middle turn segment, a segment from the 49th turn to the 72nd turn is referred to as a late turn segment, and a segment from the 73rd turn to the 78th turn is referred to as a final turn segment.

Goal points are set in each of the early turn segment, the middle turn segment, and the late turn segment. The goal points set in the individual turn segments may be the same or may be different from one another. The player makes the cumulative value of the victory points obtained in each of the turn segments sequentially reach the goal points set therein, thereby making it possible to proceed with the nurture game to the final turn segment.

Furthermore, the goal points are set on the basis of the aptitude parameters related to the racetrack aptitudes and the aptitude parameters related to the distance aptitudes of the nurture-target main character. For example, goal points for a main character of which the aptitude parameter of turf is higher than the aptitude parameter of dirt are set higher than goal points for a main character of which the aptitude parameter of dirt is higher than the aptitude parameter of turf. Furthermore, for example, different goal points may be set according to the type of the highest parameter among the aptitude parameters of short distance, mile, middle distance, and long distance. Furthermore, different goal points may be set according to the combination of the aptitude parameters related to the racetrack aptitudes and the distance aptitudes. In this way, there are cases in which the goal points set for each main character are different according to the aptitude parameters related to the racetrack aptitudes and the distance aptitudes. Note that the goal points may also be set on the basis of the aptitude parameters related to the running-style aptitudes in addition to the racetrack aptitudes and the distance aptitudes of the main character.

At an upper section of the game screen 210, which is shown in FIG. 20A, goal points that are set in the current turn segment and more victory points that are required to reach the goal points are displayed. With the goal points and the more victory points being displayed, the player can grasp victory points that should be obtained in the current turn segment.

Note that the victory points obtained by the player are reset in each of the early turn segment, the middle turn segment, and the late turn segment. However, the victory points obtained by the player may be sequentially accumulated, without being reset in each turn segment.

When the goal points are achieved in all of the early turn segment, the middle turn segment, and the late turn segment, it is possible to advance to the nurture game in the final turn segment. In the final turn segment, a total of three special races (a first race, a second race, and a third race) are executed, and the winner is determined on the basis of the cumulative value of victory points corresponding to the race results.

The value of obtainable victory points is increased with the progress of the specific races. Specifically, among all the three races, the value of victory points that can be obtained when the first place is taken in the second race is larger than the value of victory points that can be obtained when the first place is taken in the first race, and the value of victory points that can be obtained when the first place is taken in the third race is larger than the value of victory points that can be obtained when the first place is taken in the second race.

Furthermore, so-called non-player characters (hereinafter, referred to as NPCs) that participate in all the three races to compete with the main character are NPCs having the same character ID. However, the parameters of the NPCs are set higher with the progress of the special races. For example, correction values to be added to the ability parameters of the NPCs are increased in the order of the first race, the second race, and the third race, thus making the ability parameters of the NPCs higher. Note that, in the final turn segment, even if the order of arrival of the main character in any of the special races is a predetermined order (for example, the second place) or lower, the special races can be continued without ending the nurture game.

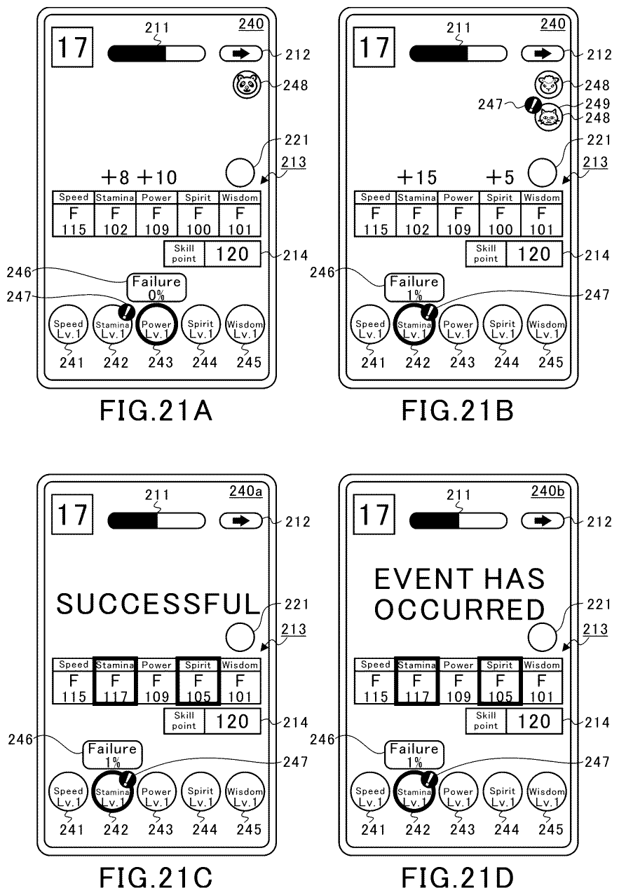

FIG. 21A is a first view for explaining a training screen 240. FIG. 21B is a second view for explaining the training screen 240. When the training operation section 216 in the game screen 210 is operated, the training screen 240 is displayed on the display 26.

As shown in FIG. 21A, training items are displayed at a lower section of the training screen 240. Here, a speed operation section 241, in which “Speed” is written, a stamina operation section 242, in which “Stamina” is written, a power operation section 243, in which “Power” is written, a spirit operation section 244, in which “Spirit” is written, and a wisdom operation section 245, in which “Wisdom” is written, are displayed.

When the player taps any of the operation sections 241 to 245 once, the training item corresponding to the tapped one of the operation sections 241 to 245 is temporarily selected, and the one of the operation sections 241 to 245 corresponding to the temporarily selected training item is highlighted. FIG. 21A shows a state in which the power operation section 243 is temporarily selected. Furthermore, FIG. 21B shows a state in which the stamina operation section 242 is temporarily selected.

Furthermore, in each of the operation sections 241 to 245, the training level of the corresponding training item is also displayed. The training level is a parameter that is increased in accordance with the number of times to select the corresponding training item, and increase values for the ability parameters when training is executed are increased as the training level is higher. The training level is initially set to level 1 and is increased up to level 5.

Furthermore, for the temporarily selected one of the operation sections 241 to 245, a failure-rate display section 246, in which “Failure” is written, is displayed. The failure rate numerically displayed in the failure-rate display section 246 is set so as to increase in reverse proportion to the remaining amount of the physical strength, which is displayed in the physical-strength display section 211.

Furthermore, the values by which the ability parameters are increased in the case where the training corresponding to the temporarily selected one of the operation sections 241 to 245 is executed successfully are displayed in the status display section 213. For example, in the example case shown in FIG. 21A, the power operation section 243 is temporarily selected, and “+8” is displayed for “Stamina” and “+10” is displayed for “Power” in the status display section 213. Furthermore, in the example case shown in FIG. 21B, the stamina operation section 242 is temporarily selected, and “+15” is displayed for “Stamina” and “+5” is displayed for “Spirit” in the status display section 213.

Furthermore, in the case where training is executed successfully, an event notification display 247 is displayed for the one of the operation sections 241 to 245 that corresponds to the training item for which a predetermined event occurs. Note that the display mode of the event notification display 247 can be different depending on the type of an event.

Furthermore, as shown in FIG. 21B, at an upper right section of the training screen 240, arranged-character icons 248 of characters arranged for the training are displayed for the item of the temporarily selected one of the operation sections 241 to 245. Then, in the case where the training is successful, and in the case where a predetermined event occurs for any of the characters displayed in the arranged-character icons 248, the event notification display 247 is displayed on the corresponding arranged-character icon 248. Hereinafter, the arranged-character icon 248 on which the event notification display 247 is displayed is referred to as an event arranged-character icon 249. Note that, hereinafter, training for which a character is arranged is referred to as joint training.

In this embodiment, a character arranged for training is a support character. When training for which a support character has been arranged is executed, a second event linked to the arranged support character occurs in some cases. In the case where this second event occurs, the event notification display 247 is displayed on the arranged-character icon 248. In the case where training for which a support character has been arranged is successful, the parameter increase value for the main character becomes higher than that in the case where training for which a support character is not arranged is successful.

Note that the present invention is not limited thereto, and a character to be arranged for training may be a character other than the support characters corresponding to the support cards registered by the player in the preparatory-stage processing. For example, a character to be arranged for training may be a character selected by a random lottery from among all support characters implemented in the game. In that case, a character icon 248 indicating a character other than the support characters registered by the player is displayed in the training screen 240. Furthermore, when training for which the character icon 248 has been displayed is executed, an event linked to the character other than the support characters registered by the player may occur. Here, the occurrence rate of an event linked to a character that is not registered by the player is lower than the occurrence rate of an event linked to any of the support characters that have been registered by the player. In this case, the event notification display 247 may also be displayed on the character icon 248 displayed in the training screen 240.

FIG. 21C is a view for explaining a training-result notification screen 240a. When the one of the operation sections 241 to 245 that is temporarily selected is tapped again, the training corresponding to the tapped one of the operation sections 241 to 245 is executed. When the training is executed, the training-result notification screen 240a, in which success or failure of the training is notified, is displayed on the display 26. Here, a word “success” is displayed, whereby success of the training is notified to the player.

Furthermore, at this time, the ability parameters in the status display section 213 are updated and displayed on the basis of the success of the training. That is, the ability parameters (ability information) of the main character that correspond to the training item (nurture item) selected by the player are updated.

Here, the values by which the ability parameters are increased in the case where the training is successful are added, the values being displayed in the status display section 213 in FIG. 21A or FIG. 21B. Furthermore, the display of the physical-strength display section 211 is updated according to the executed training item. In the case where any training of speed, stamina, power, or spirit is executed successfully, the physical strength is reduced. On the other hand, in the case where training of wisdom is executed successfully, the physical strength is restored.

Furthermore, in the case where training is failed, a predetermined penalty is given. Specifically, examples of the content of a penalty include a reduction in the physical strength, reductions in the values of the ability parameters, a decrease in the physical condition, etc. Note that it is possible that, for example, a penalty given when the failure rate is high is more disadvantageous (for example, the value by which the physical strength is reduced is larger, the values by which the ability parameters are reduced are larger, or the number of stages by which the physical condition is decreased is larger) than a penalty given when the failure rate is low.

Furthermore, the content of a penalty may be determined depending on the training item. For example, the value of the ability parameter of speed may be reduced in the case where training of speed is failed, and the value of the ability parameter of power may be reduced in the case where training of power is failed. Furthermore, it is possible that a penalty is not given even when training of part (for example, wisdom) of the training items is failed.

FIG. 21D is a view for explaining an event screen 240b. When display of the training-result notification screen 240a ends, the event screen 240b is displayed on the display 26 in some cases. In the event screen 240b, various events are executed. Note that there is a case in which a plurality of events occur during one turn.

For example, in the case where the first tip event or the second tip event occurs, a tip for a skill can be obtained. When a tip for a skill is obtained, the player can obtain the skill by consuming the skill points. A plurality of kinds of skills are provided, and a predetermined ability is activated for each skill in some cases. An activation condition and an effect are defined for each of the skills, and, in the case where an individual activation condition is established, a predetermined effect is activated. A skill is activated during an individual race, to be described later, in some cases.

Examples of the events include, in addition to the first tip event and the second tip event for possessing skills, an event for restoring the physical strength, an event for reducing the physical strength, a first ability event and a second ability event for increasing or decreasing the ability parameter, an event for increasing the physical condition, an event for reducing the physical condition, etc. Although a detailed description will be given later, there are an event that occurs in a predetermined turn and an event that occurs when a predetermined lottery is won. Furthermore, there are an event that occurs at the start of a turn and an event that occurs before the end of a turn. When an event(s) that has occurred is all finished, the game screen 210 related to the next turn is displayed.

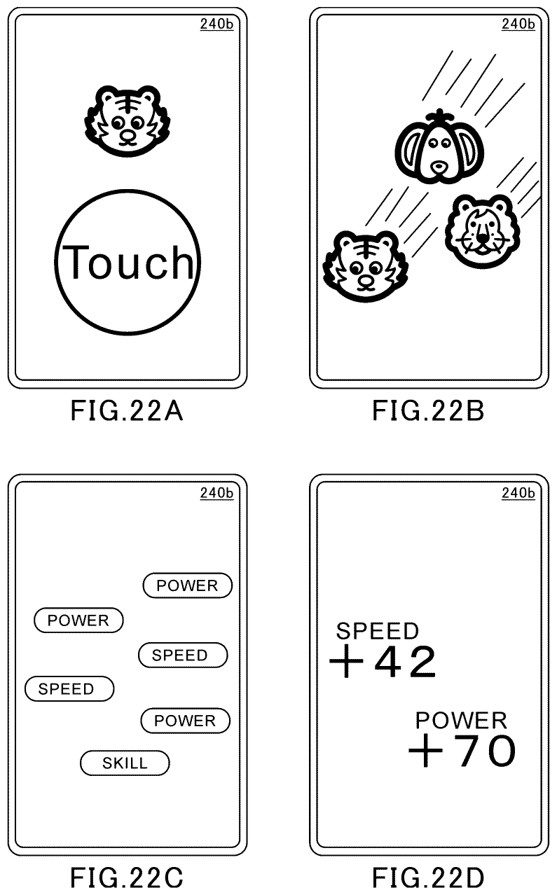

FIG. 22A is a first view for explaining an inheritance event. FIG. 22B is a second view for explaining the inheritance event. FIG. 22C is a third view for explaining the inheritance event. FIG. 22D is a fourth view for explaining the inheritance event. In the above-described factor activation turns, an inheritance event occurs along with the start of the corresponding turn. Note that this inheritance event is a scenario common event, to be described later, and always occurs in the same turns irrespective of the scenario selected by the player. In this embodiment, although the 1st turn, the 30th turn, and the 54th turn are set as the factor activation turns, here, a description will be given of a case in which the inheritance event occurs in the 30th turn.

When the 30th turn is started, the main character and an operation section in which “Touch” is written are first displayed in the event screen 240b, as shown in FIG. 22A. When the operation section displayed in the event screen 240b is tapped, an animation image including the main character and the two inheritance characters is displayed, as shown in FIG. 22B. Furthermore, when the operation section is tapped, an activation determination lottery is performed for determining whether to activate all factors possessed by the total of six nurtured characters in the inheritance first generation and the inheritance second generation.

Then, factors that are won by the activation determination lottery and are determined to be activated are displayed, as shown in FIG. 22C. Then, as shown in FIG. 22D, the kinds of the ability parameters or the aptitude parameters that are to be increased through the activation of the factors and the increase values thereof are displayed, and the parameters are updated. After the inheritance event is finished, the game screen 210, which is shown in FIG. 20A, is displayed, and the player can select any of the items. At this time, the status display section 213 is in a state in which the increase values for the ability parameters or the aptitude parameters that were displayed in the inheritance event have already been added.

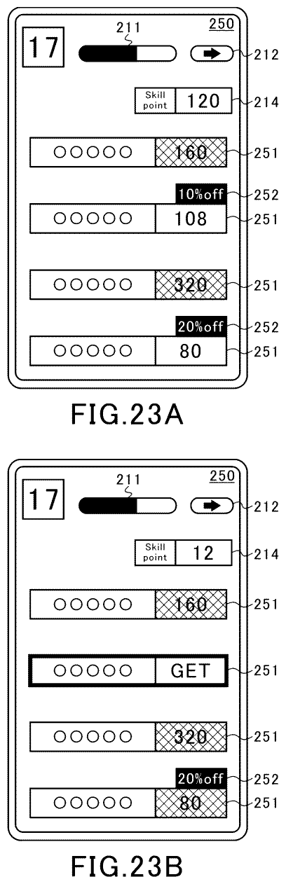

FIG. 23A is a first view for explaining a skill screen 250. FIG. 23B is a second view for explaining the skill screen 250. When the skill operation section 217 in the game screen 210 is operated, the skill screen 250 shown in FIG. 23A is displayed on the display 26.

In the skill screen 250, skill display fields 251 are displayed. In the skill display fields 251, obtained skills, possessed skills that have been set in advance for the main character, possessed skills that have been possessed due to the occurrence of various events, etc., are displayed. Furthermore, in the case where a first tip event or a second tip event occurs for any of the possessed skills, skill points to be consumed to obtain this possessed skill are discounted. Here, for the possessed skill for which a tip is obtained, skill points required to obtain this possessed skill are discounted, and the resultant is displayed. At this time, a discount-rate display icon 252 indicating a discount rate is displayed together with the corresponding skill display field 251.

Furthermore, for each of the skills displayed in the skill screen 250, an activation condition for the skill and an effect to be exerted when the skill is activated are displayed.

Furthermore, the physical-strength display section 211, the physical-condition display section 212, and the skill-point display section 214 are displayed at an upper section of the skill screen 250. Furthermore, the number of the current turn is displayed at an upper section of the skill screen 250.

When the possessed skill is obtained by consuming the skill points on the basis of an operation of the player, “GET” is displayed for the obtained skill, as shown in FIG. 23B, to notify that the possessed skill has been obtained, and the consumed skill points are subtracted from the skill points displayed in the skill-point display section 214, whereby the display of the skill points is updated.

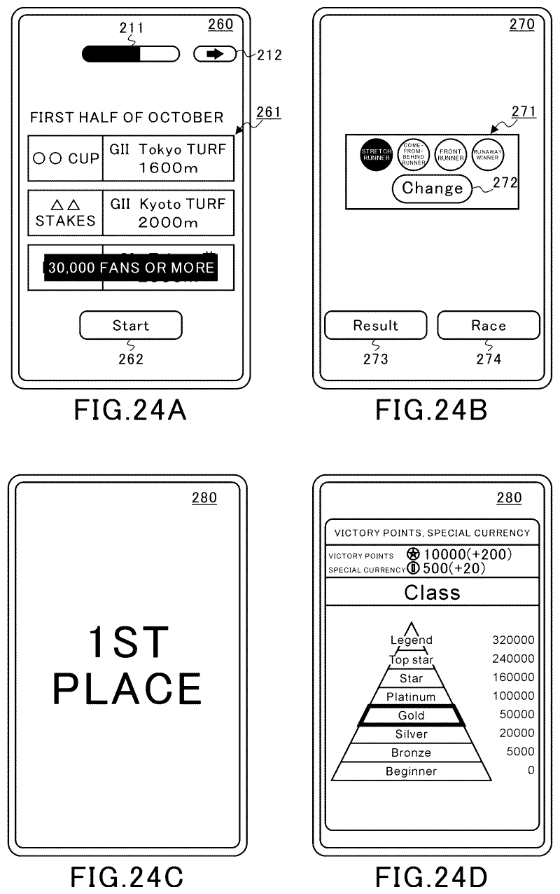

FIG. 24A is a first view for explaining an individual-race selection screen 260. When the individual-race operation section 219 in the game screen 210 is operated, the individual-race selection screen 260, which is shown in FIG. 24A, is displayed. The individual race has a game property in which the main character and NPCs participate in the race.

At an upper section of the individual-race selection screen 260, the physical-strength display section 211 and the physical-condition display section 212 are displayed. Furthermore, an individual-race selection operation section 261 for selecting a race event in which the main character is made to participate is displayed at a central section of the individual-race selection screen 260. In the case where a plurality of individual-race selection operation sections (subcommands) 261 are displayed in the individual-race selection screen 260, individual races different from each other are set in the plurality of individual-race selection operation sections 261. Furthermore, a start operation section 262, in which “Start” is written, is displayed at a lower section of the individual-race selection screen 260. Note that a race(s) that can be selected by means of the individual-race selection operation section(s) 261 in the individual-race selection screen 260 is set in advance for each turn.

Furthermore, a participation condition is set in advance for each race, and the player can make the main character participate only in a race for which the participation condition is satisfied. As described above, for some races, the number of fans is prescribed as the participation condition. For a race for which a prescribed number of fans has not been satisfied, the participation condition is displayed on the corresponding individual-race selection operation section 261, as shown in FIG. 24A, to notify that this race cannot be selected. Furthermore, in a turn in which a target race for a clear goal is set, only the target race is displayed so as to be selectable in the individual-race selection screen 260.

FIG. 24B is a view for explaining an individual-race start screen 270. When the start operation section 262 is operated with a race event of an individual race for participation being selected by means of the corresponding individual-race selection operation section 261, the individual-race start screen 270, which is shown in FIG. 24B, is displayed. A strategy display section 271 is displayed at a central section of the individual-race start screen 270. Furthermore, in the strategy display section 271, a currently selected strategy (stretch runner, come-from-behind runner, front runner, or runaway winner) is highlighted, and a change operation section 272, in which “Change” is written, is displayed. When the change operation section 272 is operated, a strategy change screen (not shown) is displayed on the display 26. The player can change the strategy for the individual race to an arbitrary strategy, through an operation performed in the strategy change screen.

Furthermore, a result operation section 273, in which “Result” is written, and a race operation section 274, in which “Race” is written, are displayed at a lower section of the individual-race start screen 270.

In the case where the race operation section 274 is operated, a race screen (not shown) is displayed on the display 26. A video of the race development (hereinafter, also referred to as a race video) is displayed on the display 26.

FIG. 24C is a first view for explaining an individual-race result screen 280. FIG. 24D is a second view for explaining the individual-race result screen 280. In the case where playback of the above-described race video is finished, and, in the case where the result operation section 273 is operated, the individual-race result screen 280 is displayed on the display 26. In the individual-race result screen 280, the order of arrival of the main character in this individual race is displayed, as shown in FIG. 24C. Furthermore, the current class of the main character is displayed in the individual-race result screen 280, as shown in FIG. 24D.

In this embodiment, the main character is set in a class according to the number of obtained fans. The range of the number of fans is set in each class, and, here, the main character is classified into one of eight stages according to the number of fans. In the individual-race result screen 280, the number of fans, the victory points, and the special currency that are obtained in the current individual race are displayed. Furthermore, in the individual-race result screen 280, the total number of fans, which is obtained by adding the number of newly obtained fans to the number of already obtained fans, is displayed. Furthermore, the current class corresponding to the total number of fans is displayed in an identifiable manner. Furthermore, in the individual-race result screen 280, the value of the total victory points, which is obtained by adding the newly obtained victory points to the already obtained victory points, and the value of the total special currency, which is obtained by adding the newly obtained special currency to the already obtained special currency, are displayed.

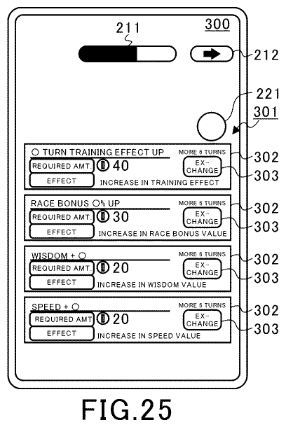

FIG. 25 is a view for explaining an example of an item exchange screen 300. For example, when the shop operation section 220 in the game screen 210, which is shown in FIG. 20A, is tapped, the item exchange screen 300, which is shown in FIG. 25, is displayed. In the item exchange screen 300, the player can exchange a predetermined item displayed in the item exchange screen 300, by consuming the special currency obtained by the player. Note that the total amount of the special currency possessed by the player may be superimposed below the shop operation section 220 in the game screen 210, which is shown in FIG. 20A.

As shown in FIG. 25, the item operation section 221 and an item exchange list 301 are displayed in the item exchange screen 300. In the item exchange list 301, one or a plurality of item exchange tabs 302 are displayed.

In each of the item exchange tabs 302, the name of an item (item name) that can be exchanged by the player, the effect of the item, the required amount of the special currency required for the exchange, a notification of an exchange deadline, and an item exchange operation section 303 are displayed. The exchange deadline is notified in each of the item exchange tabs 302, and, for example, the number of remaining turns from the current turn, during which the player can exchange the corresponding item, is notified. In the item exchange screen 300, replacement of items is performed for every certain period of time (predetermined turns). The exchange deadline shows the number of remaining turns before the replacement of items is performed. Furthermore, in the item exchange, it is possible that a lottery is performed in every turn during the nurture game, and a sale occurs at a certain rate. The period during which a sale occurs is, for example, the period from a turn in which the sale occurs to a turn in which the next replacement of items is performed. During the sale period, the required amount of the special currency required for item exchange becomes less than that outside the sale period.

Items that can be exchanged by the player include, for example, a parameter changing item, a status giving item, a training-level changing item, a skill tip obtaining item, a character re-arranging item, a training effect changing item, a physical-strength consuming item, a failure-rate changing item, and an event parameter changing item.

The parameter changing item is an item for changing the parameter of the main character. For example, the parameter changing item increases, by a predetermined value, the value of a target parameter among the parameters, of the main character, related to speed, stamina, power, spirit, wisdom, the physical strength, the physical-strength upper limit, the physical condition, the skill points, and the number of fans.

The status giving item is an item for giving a status to the main character. For example, the status giving item gives a status advantageous to the main character or a status disadvantageous to the main character. Examples of an advantageous status include, for example, a status for increasing the amount of increase in the various parameters of the main character and a status for reducing the amount of consumption of the skill points required to obtain a skill. Furthermore, examples of a disadvantageous status include, for example, a status for making an event for reducing the various parameters of the main character occur and a status for preventing an increase in the various parameters.

The training-level changing item is an item for changing the training level of each training item. For example, the training-level changing item increases, by a predetermined value, the training level of a target training item among the training items of speed, stamina, power, spirit, and wisdom.

The skill tip obtaining item is an item for making a skill event occur, thus enabling the main character to possess or obtain a skill. For example, the skill tip obtaining item enables the main character to possess or obtain various skills shown in FIG. 6C.

The character re-arranging item is an item for re-arranging the character(s) that has been arranged for a predetermined training as shown in FIG. 21A or FIG. 21B, for another training. Re-arrangement of a character will be described later.

The training effect changing item is an item for changing the training effect to be exerted due to a training, during a certain period of time. Specifically, the training effect changing item increases increase fixed values, to be described later, for the ability parameters of the main character due to a training, by a predetermined value during a certain period of time. For example, the training effect changing item increases the increase fixed values for the ability parameters due to a target training among the training items (speed, power, spirit, stamina, and wisdom) by a X % during Y turns.

The physical-strength consuming item is an item for increasing the training effect by increasing the amount of consumption of the physical strength, which is consumed in a training. Specifically, the physical-strength consuming item increases increase fixed values, to be described later, for the ability parameters of the main character due to a training, by a predetermined value. The physical-strength consuming item can increase a training improvement effect by also using the training effect changing item.

The failure-rate changing item is an item for changing the failure rate of a target training item. For example, the failure-rate changing item decreases the failure rate of a target training among the training items (speed, power, spirit, stamina, and wisdom) by a predetermined value.

The event parameter changing item is an item for changing a main-character parameter change value to be given when an event occurs after a race. For example, the event parameter changing item increases, by a predetermined value, a target parameter change value among parameters, of the main character, related to speed, stamina, power, spirit, wisdom, the physical strength, the physical-strength upper limit, the physical condition, the skill points, and the number of fans.

In the item exchange list 301, which is shown in FIG. 25, examples of the training effect changing item, the event parameter changing item, and the parameter changing item are displayed. When the item exchange operation section 303 in each of the item exchange tabs 302 is tapped, subtraction processing for subtracting the required amount of the special currency written in the item exchange tab 302 from the cumulative value of the special currency obtained by the player and giving processing for giving the item written in the item exchange tab 302 to the player are executed. Note that at least some of the items that can be exchanged in the item exchange tabs 302 are limited items of which the number of times of exchange (that is, the number of purchases) is limited to a predetermined number of times or less. In the case where the number of times to give a limited item reaches the upper limit, the player becomes unable to exchange the limited item even when the player has the special currency.

Furthermore, when the item operation section 221 is tapped, an item use screen (not shown) is displayed on the display 26. In the item use screen, a list of items possessed by the player is displayed. The list of items includes an item(s) that has been exchanged in the item exchange screen 300. That is, an item(s) that has been given to the player in exchange for the special currency is displayed in the item use screen. Note that items that have been obtained in various events may be displayed in the item use screen. The player can use various items by tapping the corresponding items displayed in the item use screen.

In this embodiment, with operations on the item operation section 221, the player can use, in the individual screens, various items (a parameter changing item, a status giving item, a training-level changing item, a skill tip obtaining item, a character re-arranging item, a training effect changing item, a physical-strength consuming item, a failure-rate changing item, and an event parameter changing item) that have been exchanged for the special currency. When each of the items is used, for example, an icon expressing the effect that is currently exerted due to the use of the item may be displayed in the training screen 240 shown in FIG. 21A. At this time, an effect activation turn number in which the effect is exerted due to the use of an item may also be displayed below the icon. Note that, for each item, a period during which the item can be exchanged is set, as shown in FIG. 25. The player can exchange each item for the special currency during the exchangeable period set for the item. Note that it is also possible that the exchangeable period is not set for each item.

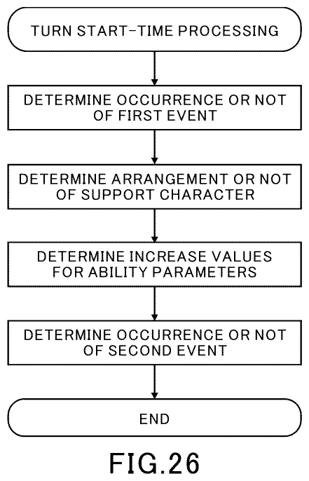

FIG. 26 is a view for explaining a rough flow of turn start-time processing. The nurture-stage processing includes the turn start-time processing, which is executed at the start of each turn of the nurture game. Although details of the turn start-time processing will be described later, a description will be given here of the rough flow of the turn start-time processing.

During the nurture main game, processing for determining whether to make any of various events appear is executed in each turn. The events are roughly divided into three events, i.e., a scenario event, the above-described dedicated events, which are set for each main character, and the support events. Note that a scenario event, dedicated events, and support events that could appear during the nurture main game are defined in advance in each scenario.

The scenario event is an event set in each scenario of the nurture main game. In this embodiment, a plurality of scenarios are provided, and the player can select any of the scenarios. The scenario event appears in each scenario selected by the player. In other words, a scenario event that is to appear in the nurture main game is determined on the basis of the scenario selected by the player.

Note that a scenario inherent event and a scenario common event may be provided as scenario events. The scenario inherent event is an event linked to only one scenario. For example, a scenario inherent event that is linked to a first scenario appears only when the first scenario is selected and does not appear when another scenario is selected.

Furthermore, the scenario common event is an event that appears in the plurality of scenarios. Therefore, the scenario common event appears in both cases in which the first scenario is selected and in which a second scenario is selected.

Here, it is assumed that the scenario inherent event and the scenario common event are provided as scenario events. However, it is also possible that only one of the scenario inherent event and the scenario common event is provided.

The dedicated events are events set in advance for each character, as described above. In the nurture main game, dedicated events for the character registered as the main character by the player in the setting game, i.e., in the preparatory-stage processing, appear.

The support events are events set in advance for the individual support cards, as described above. In the nurture main game, support events linked to the support cards registered by the player in the setting game appear. The support events include first events that could occur at the start of a turn and second events that could occur after execution of training. The occurrence or not of a first event is determined at the start of a turn on the basis of a random number that is randomly acquired and a first-event table.

After processing for determining each support character to be arranged for training is performed, the occurrence or not of a second event is determined on the basis of a random number that is randomly acquired and a second-event table. Note that, only in the case where a support character is arranged for training, the occurrence or not of a second event is determined for the arranged support character.

Note that, in this embodiment, it is assumed that a first event is selected by a lottery from among the support events linked to the support cards registered in the deck by the player in the preparatory-stage processing. However, the present invention is not limited thereto, and it is also possible to select a support event linked to a support card selected by a lottery from among all support cards implemented in the game. In this case, it is preferred that the selection rate of a support event linked to a support card that is registered in the deck is higher than the selection rate of a support-card event linked to a support card that is not registered in the deck.

In this way, the appearance or not of the scenario event is determined on the basis of the scenario.

Furthermore, the appearance or not of the dedicated event(s) and that of the support event(s) are determined on the basis of the main character and the support card(s), respectively. These event types are divided according to information to be referred to when the appearance or not of the event(s) is determined.

In contrast to this, in this embodiment, individual events are each classified into any of six event classifications according to the content brought about by the appearance of the event. Here, individual events are each classified into any of the event classifications, i.e., a first tip event, a second tip event, a first ability event, a second ability event, an aptitude event, and a story event.

As described above, the first tip event and the second tip event are events for allowing skills to be possessed or obtained. Furthermore, the first ability event and the second ability event are events for increasing or decreasing the ability parameters of the main character. The aptitude event is an event for increasing or decreasing the aptitude parameters of the main character. The story event is an event for displaying a story related to a character appearing in the nurture game. Note that there is a story event for changing the ability parameters or the aptitude parameters in addition to displaying a story.

Here, the scenario event includes a first tip event, a second tip event, a first ability event, a second ability event, an aptitude event, and a story event. Furthermore, the dedicated events and the support events include a first tip event, a second tip event, a first ability event, and a second ability event. Note that the dedicated events may include a story event.

In this embodiment, in addition to processing for determining a scenario event and processing for determining a dedicated event(s), the turn start-time processing includes “processing for determining the occurrence or not of a first event”, “processing for determining the arrangement or not of a support character”, “processing for determining increase values for ability parameters”, and “processing for determining a second event” that are shown in FIG. 26. The processing for determining a scenario event, the processing for determining a dedicated event(s), the “processing for determining the occurrence or not of a first event”, the “processing for determining the arrangement or not of a support character”, the “processing for determining increase values for ability parameters”, and the “processing for determining a second event” are executed in this order. Note that, although various processing procedures are executed in the turn start-time processing in addition to these processing procedures, the processing procedures shown in FIG. 26 will be sequentially described here.

### <Processing for Determining Occurrence or not of First Event>

A first event is selected by a lottery from among the support events (first events) linked to the support cards registered by the player in the preparatory-stage processing. Specifically, at the start of a turn, a random number is randomly acquired, and the occurrence or not of a first event and the content of the first event are determined on the basis of the acquired random number and the first-event table. In the first-event table, a selection ratio of “making a first event occur” and “not making a first event occur” is set. In this embodiment, the first event includes four types of events, i.e., an event a, an event b, an event c, and an event d. For example, in the first-event table, the rate of “making each of the events (events a to d) occur” is set to 20%, and the rate of “not making a first event occur” is set to 20%. Note that the selection ratio for a first event may be individually set for each support card, that is, each support character.

### <Processing for Determining Arrangement or not of Support Character>

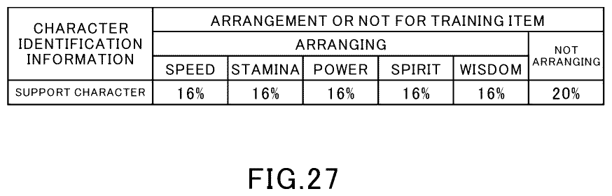

FIG. 27 is a view for explaining an arrangement-or-not table. As shown in FIG. 27, a selection ratio of arranging or not of a support character for a training item (“arranging for any of the training items” and “not arranging”) is set in the arrangement-or-not table. In this embodiment, the arrangement or not of each of the support characters corresponding to all the support cards registered by the player in the preparatory-stage processing is determined on the basis of the arrangement-or-not table shown in FIG. 27. Specifically, at the start of a turn, a random number is randomly acquired, and the arrangement or not of each of the support characters for a training item is determined on the basis of the acquired random number and the arrangement-or-not table. However, the present invention is not limited thereto, and the arrangement or not of each of the support characters for a training item may also be selected by a lottery from among all support characters corresponding to all support cards implemented in the game.

Specifically, as shown in FIG. 27, in this embodiment, “arranging” of each support character for any of the training items of speed, stamina, power, spirit, and wisdom is selected at a rate of 16%, and “not arranging” of the support character for any of the training items is selected at a rate of 20%. Note that, as shown in FIG. 17A, a plurality of kinds of training of expertise are set for the support characters. Thus, for example, the selection ratio of arranging a support character for each training item may be set such that the selection ratio for the training item corresponding to the training of expertise is higher than that for training items not corresponding to the training of expertise. In the case where a lottery is performed, a lottery table in which a selection ratio used in the lottery is set may be stored in advance or the lottery table may be generated every time a lottery is performed.

Note that, after a training item for which a support character is to be arranged is determined, the support character determined to be arranged and the determined training item may be linked to each other and may be stored in the server 1000. More specifically, it is possible to store, in the server 1000, link information that links the training ID indicating the type of the training item to the character ID of the support character or the support card ID of the support card linked to the support character.

### <Processing for Determining Increase Values for Ability Parameters>

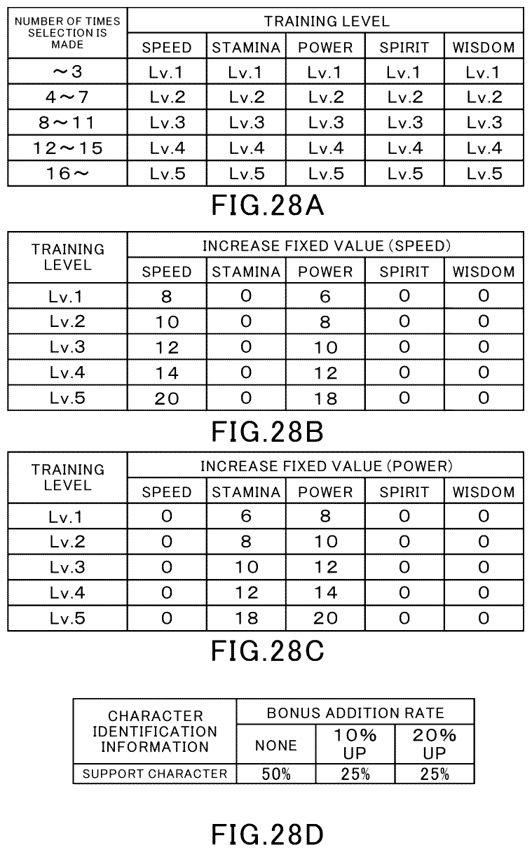

FIG. 28A is a view for explaining a training-level table. As shown in FIG. 28A, the training level is set so as to be raised according to the number of times to select each training. Specifically, in the case where the number of times to select each training is three times or less, the training level of the corresponding one of “Speed” (speed), “Stamina” (stamina), “Power” (power), “Spirit” (spirit), and “Wisdom” (wisdom) is set to “level 1”. In the case where the number of times to select each training is equal to or greater than 4 times and is equal to or less than 7 times, the training level thereof is set to “level 2”. In the case where the number of times to select each training is equal to or greater than 8 times and is equal to or less than 11 times, the training level thereof is set to “level 3”. In the case where the number of times to select each training is equal to or greater than 12 times and is equal to or less than 15 times, the training level thereof is set to “level 4”. In the case where the number of times to select each training is equal to or greater than 16 times, the training level thereof is set to “level 5”.

In this embodiment, in the case where training selected by the player is executed successfully, the values of predetermined ability parameters are increased due to the executed training item.

Specifically, in this embodiment, in the case where training of “Speed” (speed) is executed successfully, the values of the ability parameters of “Speed” (speed) and “Power” (power) are increased.

Furthermore, in the case where training of “Stamina” (stamina) is executed successfully, the values of the ability parameters of “Stamina” (stamina) and “Spirit” (spirit) are increased.

Furthermore, in the case where training of “Power” (power) is executed successfully, the values of the ability parameters of “Stamina” (stamina) and “Power” (power) are increased.

Furthermore, in the case where training of “Spirit” (spirit) is executed successfully, the values of the ability parameters of “Speed” (speed), “Power” (power), and “Spirit” (spirit) are increased.

Furthermore, in the case where training of “Wisdom” (wisdom) is executed successfully, the values of the ability parameters of “Speed” (speed) and “Wisdom” (wisdom) are increased.

In this embodiment, the value of an ability parameter to be increased in the case where training is successful is calculated by adding, to a bonus addition rate, to be described later, which is determined in accordance with the executed training item and the training level, a value that is obtained by multiplying the increase fixed value by a bonus addition rate.

FIG. 28B is a view for explaining an increase fixed value (speed) table. Furthermore, FIG. 28C is a view for explaining an increase fixed value table (power). That is, FIG. 28B shows increase fixed values in the case where the training item is “Speed” (speed). Furthermore, FIG. 28C shows increase fixed values in the case where the training item is “Power” (power).

As shown in FIGS. 28B and 28C, the increase fixed values each determined in accordance with the executed training item and the training level are recorded in the increase fixed value table. Furthermore, in this embodiment, as shown in FIGS. 28B and 28C, it is set that the ability parameters are more increased as the training level is higher.

Note that, although not shown here, increase fixed value tables to be used in the case where “Stamina” (stamina), “Spirit” (spirit), and “Wisdom” (wisdom) are selected as training items are also provided.

Furthermore, in addition to the above-described increase fixed values, the bonus addition rate is determined on the basis of a support character that is arranged for each training item.

FIG. 28D is a view for explaining a bonus addition rate table. In this embodiment, the bonus addition rate is determined on the basis of a support character determined to be arranged for each training.

Specifically, as shown in FIG. 28D, in the bonus addition rate table, a selection ratio of the presence/absence of a bonus addition rate and the addition rates (10% up and 20% up) is set for a support character.

For the bonus addition rate, “none” is selected at a rate of 50%, “10% up” is selected at a rate of 25%, and “20% up” is selected at a rate of 25%.

Then, the values obtained by multiplying the increase fixed values determined by the increase fixed value table by the bonus addition rate are derived as bonus additional values. The values obtained by adding the bonus additional values to the increase fixed values are determined as the amounts of increase in the values of the ability parameters when training is successful. Note that, for training for which a plurality of support characters are arranged, the bonus additional values for each of the arranged support characters are added to the increase fixed values. In this way, the amounts of increase in the ability parameters of the main character when training is successful are determined for all the training types.

### <Processing for Determining Occurrence or not of Second Event>

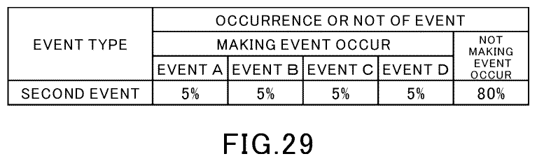

FIG. 29 is a view for explaining a second-event table. A second event is selected by a lottery from among the support events (second events) linked to the support card(s) corresponding to a support character(s) arranged for each training item. Specifically, after the “processing for determining the arrangement or not of a support character”, a random number is randomly acquired, and the occurrence or not of a second event is determined on the basis of the acquired random number and the second-event table. In the second-event table, a selection ratio of “making a second event occur” and “not making a second event occur” is set.

For example, as shown in FIG. 29, the second event includes four types of events, i.e., an event A, an event B, an event C, and an event D. For example, in the second-event table, the rate of “making each of the events (events A to D) occur” is set to 5%, and the rate of “not making a second event occur” is set to 80%. Note that the selection ratio for a second event may be individually set for each support card, that is, each support character.

In this embodiment, after the “processing for determining the arrangement or not of a support character”, the processing for determining the occurrence or not of a second event is performed for all support characters arranged for the individual training items. Then, the event notification display 247 is displayed in the training screen 240 on the basis of the determination on the occurrence of a second event. In the case where the player selects training for which a character with which the occurrence of a second event has been determined is arranged, the second event occurs after execution of the training. For example, in the case where appearance of a second tip event of a support character that is arranged for training of speed has been determined, when the training of speed is executed, the second tip event surely appears after the execution of the training. However, when training other than speed is executed, this second tip event does not appear after the execution of the training. At this time, in the case where the occurrence of second events of two or more characters has been determined, which of the second events is made to occur is determined by a lottery or by the priorities set in advance for the support events. For example, which of the plurality of second events is made to occur is determined with an equal probability. However, the present invention is not limited thereto, and it is also possible that weights are set according to the types of second events, and which of the plurality of second events is made to occur is determined according to the set weights. Note that, in the case where the occurrence of second events of two or more characters is determined, it is also possible that the determined second events are all made to occur.

Here, for example, after the appearance of a second event is determined, appearance information indicating the appearance or not of a support event may be linked to the support card or the support character linked to the second event and may be stored in the server 1000. More specifically, it is possible to store, in the server 1000, link information in which the appearance information is linked to the character ID of the support character or the support card ID of the support card linked to the support character.

When the above-described “processing for determining the occurrence or not of a first event”, “processing for determining the arrangement or not of a support character”, “processing for determining increase values for ability parameters”, and “processing for determining the occurrence or not of a second event” are executed, and an operation on the training operation section 216 is performed, the training screen 240 shown in FIG. 21B, for example, is displayed on the display 26.

As described above, in the training screen 240 shown in FIG. 21B, two kinds of arranged-character icons 248 arranged for the training item of stamina are displayed through the “processing for determining the arrangement or not of a support character”.

Furthermore, in the training screen 240, increase values for ability value parameters determined through the “processing for determining increase values for ability parameters” are displayed in the status display section 213. Furthermore, in the training screen 240, the event notification displays 247 are displayed, which notify the second event determined through the “processing for determining the occurrence or not of a second event”.

At this time, when the item operation section 221 is tapped, and a character re-arranging item is used, “processing for determining a training item for which re-arrangement is performed” is executed.

<Processing for Determining Training Item for which Re-Arrangement is Performed>

In the “processing for determining a training item for which re-arrangement is performed”, it is determined, by a lottery, whether a support character that has been determined to be arranged through the “processing for determining the arrangement or not of a support character” is re-arranged for any of the training items of “Speed” (speed), “Stamina” (stamina), “Power” (power), “Spirit” (spirit), and “Wisdom” (wisdom).

Here, one random number is determined by a re-lottery at the use of a character re-arranging item, and arrangement of each support character for each training item is redetermined on the basis of the random number determined by the re-lottery and the arrangement-or-not table shown in FIG. 27. That is, a re-lottery is performed for arranging each support character for each training item. At this time, in the case where the arrangement location of a support character for a training item after the re-lottery is identical to the arrangement location of the support character for a training item before the re-lottery (that is, the arrangement location determined through the “processing for determining the arrangement or not of a support character”), a re-lottery for a random number is performed again. Then, arrangement of each support character for each training item is redetermined on the basis of the random number determined by the re-lottery and the arrangement-or-not table shown in FIG. 27. This processing is repeatedly executed until the arrangement location of a support character for a training item after the re-lottery becomes different from the arrangement location of the support character for a training item before the re-lottery (that is, the arrangement location determined through the “processing for determining the arrangement or not of a support character”). Alternately, it is also possible that a special re-arrangement table is used so as to obtain a different result of a training item for which re-arrangement is performed, thereby preventing a support character from being re-arranged for the same training item. Accordingly, arrangement of each support character for each training item after the “processing for determining a training item for which re-arrangement is performed” becomes different from arrangement of the support character for a training item after the “processing for determining the arrangement or not of a support character”.

Furthermore, at the use of a character re-arranging item, the occurrence or not of a second event is determined by a re-lottery on the basis of the random number selected by the lottery in the “processing for determining the occurrence or not of a second event” and the second-event table. Here, since the re-lottery is performed by using the same random number as the random number used in the “processing for determining the occurrence or not of a second event” and the same second-event table, a second event to be determined by a re-lottery after the character re-arranging item is used is the same as the second event of which the occurrence has been determined through the “processing for determining the occurrence or not of a second event”.

That is, even when the arrangement of each support character for each training item is changed, the appearance or not of a second event and the type of the second event of which the appearance has been determined are maintained without being changed. Note that, in this embodiment, although a second event is determined by a re-lottery by using the same random number, the second event that has been determined through the “processing for determining the occurrence or not of a second event” may be used as it is without performing a re-lottery. Note that a re-lottery for determining the arrangement of each support character for each training item and a re-lottery for determining the occurrence or not of a second event are executed every time a character re-arranging item is used.

Note that, in re-lottery processing performed when a character re-arranging item is used, it is also possible to perform a re-lottery for linking the training ID, which indicates the type of a training item, to the character ID of a support character or the support card ID of the support card linked to the support character. At this time, it is also possible to maintain link information that links the appearance information indicating the appearance or not of a support event to the character ID of a support character or the support card ID of the support card linked to the support character.

At the time of a re-lottery, a lottery may be performed such that each training item is won at an equal rate, for example. Alternately, a lottery may be performed such that each training item is won at a different rate set for the training item. Furthermore, a lottery may be performed such that a support character is likely to be arranged for training of expertise thereof (see FIG. 17A), for example. When a lottery is performed, a lottery table in which a selection ratio used in the lottery is set may be stored in advance, or the lottery table may be generated every time a lottery is performed.

After the execution of the “processing for determining a training item for which re-arrangement is performed”, a post-re-arrangement training screen 310 is displayed on the display 26.

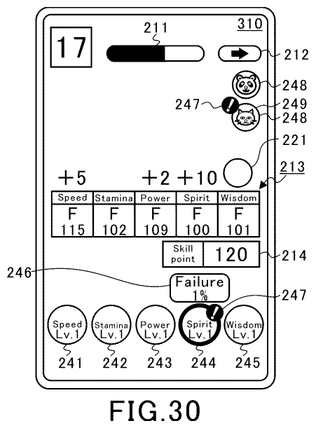

FIG. 30 is a view for explaining the post-re-arrangement training screen 310. As shown in FIG. 30, in the post-re-arrangement training screen 310, two kinds of arranged-character icons 248 arranged for the training item of spirit through the “processing for determining a training item for which re-arrangement is performed” are displayed.

One of the two kinds of arranged-character icons 248 is an event arranged-character icon 249 on which the event notification display 247 is displayed. The event arranged-character icon 249 shown in FIG. 30 is the same as the event arranged-character icon 249 shown in FIG. 21B.

That is, the event arranged-character icon 249 shown in FIG. 21B is re-arranged from the training item of stamina to the training item of spirit, as shown in FIG. 30, through the “processing for determining a training item for which re-arrangement is performed”.

Here, as described above, a second event to be determined by a re-lottery after a character re-arranging item is used becomes the same as the second event of which the occurrence has been determined through the “processing for determining the occurrence or not of a second event”. As a result, as shown in FIG. 30, in the post-re-arrangement training screen 310, the event arranged-character icon 249 is displayed, on which the event notification display 247 is displayed for notifying the second event that has been determined through the “processing for determining the occurrence or not of a second event” before the execution of the “processing for determining a training item for which re-arrangement is performed”.

Accordingly, while the appearance of a second event of the support card is maintained, only a training item for which the support character is to be arranged is changed, thereby making it possible to make a second event likely occur in a training item desired by the player and to improve the convenience of the nurture game.

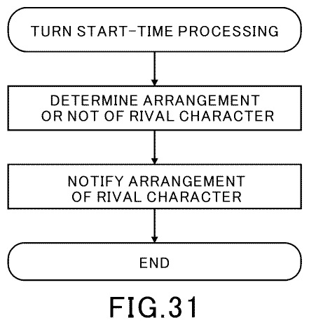

Furthermore, the turn start-time processing of this embodiment includes “processing for determining the arrangement or not of a rival character” and “processing for notifying the arrangement of the rival character” shown in FIG. 31. FIG. 31 is a view for explaining a rough flow of the turn start-time processing. A rival character is an NPC that appears in an individual race to compete with the main character for a win in the individual race.

The rival character is formed of a character having the same character ID as a regular NPC (hereinafter, referred to as a regular NPC) that appears in a regular individual race in which a rival character does not appear. However, the rival character is a character having higher parameters than the regular NPC. For example, the rival character has ability parameters that are obtained by multiplying the values of the ability parameters of a regular NPC having the same character ID, by predetermined times (for example, 1.1 times). Thus, an individual race in which a rival character appears basically has a game property in which the rival character and the main character complete for rank (the 1st place).

### <Processing for Determining Arrangement or not of Rival Character>

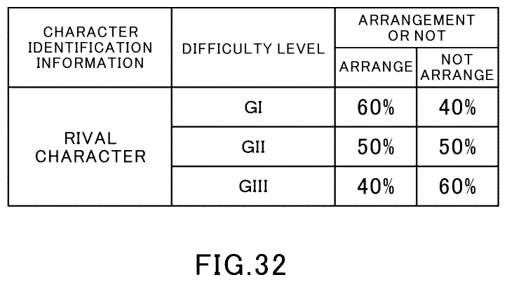

FIG. 32 is a view for explaining an arrangement-or-not table. As shown in FIG. 32, the selection ratio of the arrangement or not (“arranging” or “not arranging”) of a rival character is set in the arrangement-or-not table. In this embodiment, the arrangement or not of a rival character is determined on the basis of the arrangement-or-not table shown in FIG. 32.

In this embodiment, the arrangement of a rival character is executed in the case where, among individual races that appear in the current turn, there is a race for which the current aptitude parameters related to the racetrack aptitudes and the distance aptitudes of the main character are equal to or greater than a predetermined value (for example, equal to or greater than C). Thus, in the “processing for determining the arrangement or not of a rival character”, first, it is judged whether there is a race (hereinafter, referred to as a suitable race) for which the current aptitude parameters related to the racetrack aptitudes and the distance aptitudes of the main character are equal to or greater than a predetermined value, among individual races (race events) that appear in the current turn.

As shown in FIG. 32, in this embodiment, the selection ratio for a rival character is changed according to the difficulty level of a suitable race. Specifically, as shown in FIG. 32, in the case where the difficulty level (grade) of a suitable race is GI, “arranging” of a rival character is selected at a rate of 60%, and “not arranging” thereof is selected at a rate of 40%.

Furthermore, in the case where the difficulty level of a suitable race is GII, “arranging” of a rival character is selected at a rate of 50%, and “not arranging” thereof is selected at a rate of 50%. Furthermore, in the case where the difficulty level of a suitable race is GIII, “arranging” of a rival character is selected at a rate of 40%, and “not arranging” thereof is selected at a rate of 60%. However, the selection ratio for a rival character need not be changed according to the difficulty level of a suitable race. For example, the selection ratio for a rival character may be fixed regardless of the difficulty level of a suitable race. After the arrangement of a rival character is determined, the type (character ID) of a rival character to be arranged is selected by a random lottery. At this time, either one character is selected as a rival character by a random lottery, from among characters whose aptitude parameters related to the racetrack aptitudes and the distance aptitudes are equal to or greater than a predetermined value (for example, equal to or greater than C), with respect to any of the racetracks, such as turf and dirt, and any of the distances, such as short distance, mile, middle distance, and long distance, which are set in a suitable race. However, in the case where a plurality of suitable races are included in one turn, a random lottery is performed such that the same rival character (character ID) is not selected for the plurality of suitable races. Furthermore, a random lottery for a rival character is performed while excluding the nurture-target main character.

Here, the parameters of a rival character may be changed according to the difficulty level of a suitable race. For example, the rival character may have higher parameters as the difficulty level of a suitable race becomes higher. Furthermore, the parameters of a rival character may be fixed values regardless of the difficulty level of a suitable race.

The parameters of a rival character are set higher as the number of turns in the nurture game is increased. Specifically, the parameters of a rival character may be set higher in the order of the early turn segment, the middle turn segment, and the late turn segment. More specifically, in the case of the early turn segment, the ability parameters of a rival character are 1.1 times of the ability parameters of a regular NPC having the same character ID; in the case of the middle turn segment, the ability parameters thereof are 1.3 times of the ability parameters of a regular NPC having the same character ID; and, in the case of the late turn segment, the ability parameters thereof are 1.5 times of the ability parameters of a regular NPC having the same character ID.

When the main character participates in a suitable race, the player is given a basic reward. Furthermore, when the main character defeats a rival character in a suitable race, the player is given an additional reward in addition to the basic reward. However, the additional reward may be given when the main character participates in a suitable race, regardless of victory or defeat with a rival character. The basic reward is a reward that the player can get regardless of victory or defeat with a rival character. The additional reward is given to the nurture-target main character separately from the basic reward, and examples thereof are a skill tip related to the racetrack of a suitable race, a skill tip related to the distance of a suitable race, and a skill tip related to the running method of the main character. Furthermore, the additional reward may be a display of a predetermined event on the display 26. In that predetermined event, for example, a rival character is displayed. Furthermore, examples of the additional reward include a skill tip linked to the nurture-target main character, and parameters. This skill tip may be determined on the basis of the parameters of the racetrack aptitudes, the distance aptitudes, and the running-method aptitudes of the nurture-target main character.

Note that, in this embodiment, the additional reward has been described by using examples of a display of an event and giving of a skill tip or parameters. However, the present invention is not limited thereto, and the additional reward may include a special item that enables to increase the initial values of the ability parameters of a specific character and that enables to strengthen a unique skill provided for the specific character. Here, the specific character is a character having the same character ID as a rival character, for example. Note that the specific character may be the main character or any character that participates in a suitable race. However, the present invention is not limited thereto, and the specific character may be any character as long as the character can be obtained by the player, and may be a character that does not participate in a suitable race. Furthermore, for one suitable race, one kind of special item will be given to the player as an additional reward.

In this embodiment, although no limit is provided for the number of times to give an additional reward that is obtainable in a suitable race, the number of times to obtain a special item in one suitable race during a predetermined period of time may be limited to a predetermined number of times, for example. For example, the number of times to obtain a special item in one suitable race in one day may be limited to three times. However, the number of times to obtain a special item may be changed according to the type of a suitable race (race event). In this case, an additional reward obtained in a suitable race is linked to the player ID and is stored in the server 1000.

Furthermore, the number of special items obtained at one time is the total of the basic acquisition count (for example, three) and the bonus acquisition count. The bonus acquisition count can be given when the main character wins against the rival character.

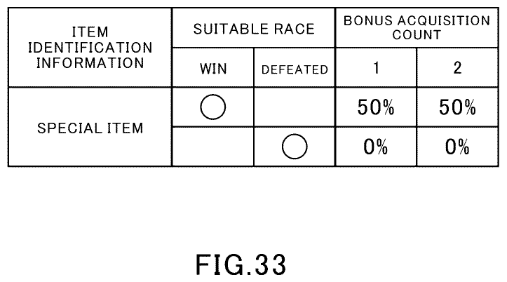

FIG. 33 is a view for explaining a bonus-acquisition-count table. In this embodiment, the bonus acquisition count is determined on the basis of the bonus-acquisition-count table. Specifically, as shown in FIG. 33, in the bonus-acquisition-count table, the presence or absence of bonus acquisition and a selection ratio for bonus acquisition counts are set for a special item.

As shown in FIG. 33, a special item is set such that the bonus acquisition count changes on the basis of victory or defeat in a suitable race (that is, victory or defeat with a rival character). Specifically, the bonus acquisition count is zero when the main character is defeated by a rival character. On the other hand, when the main character wins against a rival character, “1” is selected at a rate of 50% for the bonus acquisition count, and “2” is selected at a rate of 50% therefor.

### <Processing for Notifying Arrangement of Rival Character>

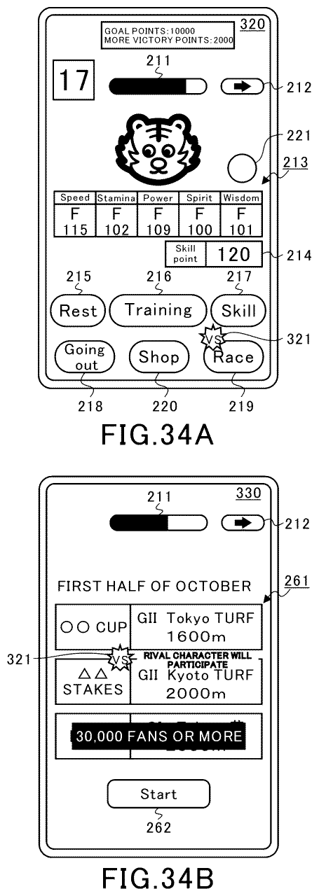

FIG. 34A is a view for explaining notification of arrangement of a rival character in a game screen 320. FIG. 34B is a view for explaining notification of arrangement of a rival character in an individual-race selection screen 330.

After arrangement of a rival character is determined through the “processing for determining the arrangement or not of a rival character”, a rival-character notification display 321 is displayed so as to overlap the individual-race operation section 219 in the game screen 320, as shown in FIG. 34A.

When the individual-race operation section 219 on which the rival-character notification display 321 is displayed is tapped, the individual-race selection screen 330, which is shown in FIG. 34B, is displayed on the display 26. The rival-character notification display 321, in which “Rival character will participate” is written, overlaps a race event (suitable race) for which the arrangement of a rival character has been determined, among race events in the individual-race selection operation section 261 in the individual-race selection screen 330.

The player confirms the rival-character notification display 321, thus making it possible to select whether to play a game for nurturing the nurture-target main character or to obtain an additional reward by competing with the rival character, and making it possible to improve interest in the nurture game. Note that, in this embodiment, although a description has been given of an example case in which the rival-character notification display 321, shown in FIGS. 34A and 34B, is displayed on the display 26 in the case where the arrangement of a rival character has been determined, the present invention is not limited thereto, and the rival-character notification display 321 may include, for example, text or an image that can specify the character kind of the rival character.

In this embodiment, a bonus event occurs in the case where the main character achieves predetermined conditions at the end of the final turn in each of the early turn segment, the middle turn segment, and the late turn segment. The predetermined conditions are, for example, that the victory points reach a value more than the goal points by a fixed value, that the main character gets the 1st place in races with a predetermined difficulty level (for example, GI) a predetermined number of times or more, and that the main character wins against a rival character a predetermined number of times or more.

The bonus event includes a low bonus event and a high bonus event, and the kind of a bonus event that is to occur is changed according to the status of achievement of the predetermined conditions. The low bonus event is, for example, an event for raising the level of a unique skill set for the main character. The high bonus event includes, for example, an event for increasing the parameter(s) of the main character by a predetermined value and an event for increasing the skill points by a predetermined value, in addition to the event for raising the level of a unique skill set for the main character.

In this embodiment, the low bonus event occurs in the case where only a basic condition of the predetermined conditions has been achieved, and the high bonus event occurs in the case where the basic condition and a specific condition of the predetermined conditions have both been achieved. The content of the high bonus event is changed on the basis of the type of the turn segment.

For example, in the case where the type of the turn segment is the early turn segment, a high bonus event that occurs therein raises the level of a unique skill set for the main character, increases randomly one parameter of the parameters of the main character by a predetermined value (for example, +10), and increases the skill points by a predetermined value (for example, +20).

Furthermore, in the case where the type of the turn segment is the middle turn segment, a high bonus event that occurs therein raises the level of a unique skill set for the main character, increases all the parameters of the main character by a predetermined value (for example, +5), and increases the skill points by a predetermined value (for example, +30).

Furthermore, in the case where the type of the turn segment is the late turn segment, a high bonus event that occurs therein raises the level of a unique skill set for the main character, increases all the parameters of the main character by a predetermined value (for example, +10), and increases the skill points by a predetermined value (for example, +30).

Furthermore, in this embodiment, separately from the bonus events that occur at the ends of the above-described turn segments, a bonus event occurs in the case where the main character achieves a special condition. The special condition is that, for example, the main character wins the 1st place in a specific race among the individual races. Specifically, the special condition is that the main character gets the 1st place in an individual race for which a specific racetrack and a specific distance have been set, a predetermined number of times, that the main character gets the 1st place in an individual race in a specific region a predetermined number of times, or that the main character gets the 1st place in a specific race among the GI races with a high difficulty level. The bonus event is an event for increasing the parameter(s) of the main character by a predetermined value, for example.

In the above-described nurture main game, when all the turns end, the nurture game ends. Furthermore, during the nurture main game, in the case where the goal set for each character or the goal points set for each prescribed turn segment are not achieved, the nurture game ends at that point.

Here, when the nurture game ends, the main character nurtured in the nurture game is stored as a nurtured character. More specifically, information related to the nurtured character nurtured in the nurture game (hereinafter, referred to as nurtured-character information) is stored while being linked to the player ID. Note that the nurtured-character information is stored in both of the player terminal 1 and the server 1000. The nurtured-character information to be stored while being linked to the player ID includes the ability parameters, the aptitude parameters, the obtained skills, the inheritance information, etc.

Furthermore, when the nurture game ends, the evaluation points of the nurtured character that has been nurtured are calculated. Here, the evaluation points are calculated on the basis of the ability parameters, the aptitude parameters, the obtained skills, the results of individual races, etc., at the end of the nurture game. Note that a method for calculating the evaluation points, in other words, a formula for calculating the evaluation points, is prepared in advance, and the evaluation points are calculated on the basis of the predetermined formula. Note that the method or the formula for calculating the evaluation points is not particularly limited. For example, the evaluation points may be calculated on the basis of only the parameters, such as the ability parameters, the aptitude parameters, the obtained skills, etc., at the end of the nurture game, that affect the race result when the nurtured character participates in a race of a team competition game or another race game.

Furthermore, a nurture rank is set for the nurtured character on the basis of the evaluation points. The nurture rank is an index indicating the strength of the nurtured character, and the range of evaluation points is made to correspond to each nurture rank. For example, a nurture rank “A+” is given to a nurtured character of which the evaluation points fall within the range from 13000 to 14499, and a nurture rank “S” is given to a nurtured character of which the evaluation points fall within the range from 14500 to 15499. In this way, a nurture rank is given on the basis of the evaluation points, thus making it easy to understand the general strength of the nurtured character. Note that the nurtured-character information also includes the evaluation points and the nurture rank.

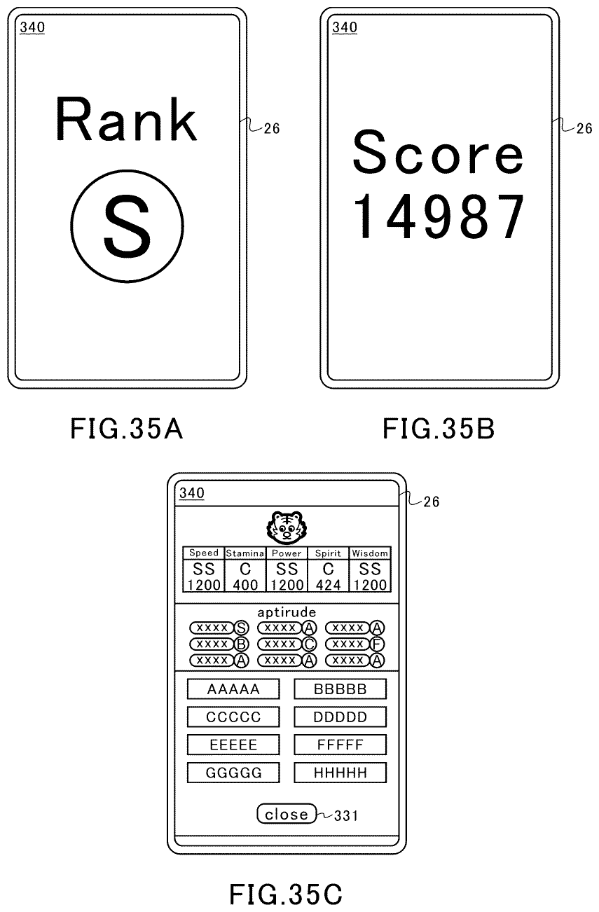

FIG. 35A is a first view for explaining a nurture complete screen 340. FIG. 35B is a second view for explaining the nurture complete screen 340. FIG. 35C is a third view for explaining the nurture complete screen 340. When the nurture game ends, the nurture complete screen 340 is displayed on the display 26, as shown in FIG. 35A. In the nurture complete screen 340, the nurture rank of the nurtured character that has been nurtured is first displayed, and then, the evaluation points are displayed, as shown in FIG. 35B.

Furthermore, when a predetermined period of time has elapsed after the evaluation points are displayed, the ability parameters, the aptitude parameters, and the obtained skills of the nurtured character are displayed in the nurture complete screen 340, as shown in FIG. 35C. At this time, a close operation section 331 is provided in the nurture complete screen 340. When the close operation section 331 is tapped, the nurture complete screen 340 is hidden, and the home screen 100 is displayed on the display 26.

Note that, when the nurture game ends, a lottery for a factor to be obtained by the main character is performed, and factor information is stored while being linked to the nurtured character. Although not shown in the figures, the player can make the factor information that has been obtained by the nurtured character, displayed in the nurture complete screen 340.

Next, functional configurations of the player terminal 1 and the server 1000 for executing the above-described nurture game will be described below.

### (Functional Configuration of Player Terminal 1)

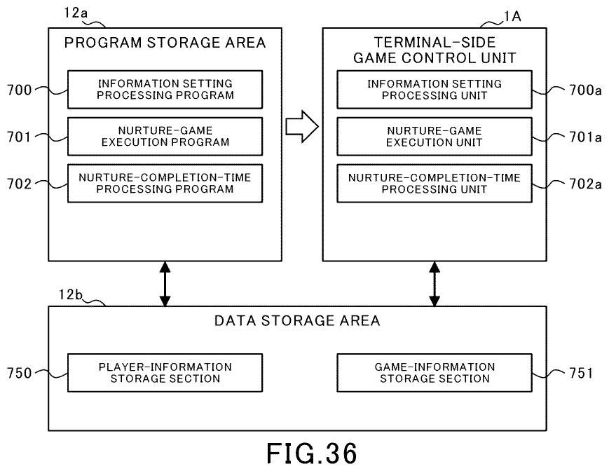

FIG. 36 is a view for explaining the configuration of the memory 12 at the player terminal 1 and the function of the player terminal 1 serving as a computer. In the memory 12, a program storage area 12a and a data storage area 12b are provided. When the game is started, the CPU 10 stores terminal-side game control programs (modules) in the program storage area 12a.

The terminal-side game control programs include an information setting processing program 700, a nurture-game execution program 701, and a nurture-completion-time processing program 702. Note that the programs listed in FIG. 36 are merely examples, and a large number of other programs are also provided as the terminal-side game control programs. In the data storage area 12b, a player-information storage section 750 and a game-information storage section 751 are provided as storage sections for storing data. Note that a large number of other storage sections are also provided in the data storage area 12b. Here, information directly related to games such as a nurture game (hereinafter, referred to as game information) is stored in the game-information storage section 751.

Note that various kinds of information during the progress of games such as the nurture game are temporarily stored in the game-information storage section 751. Therefore, information related to a nurtured character that has been nurtured in the nurture game is all stored in the game-information storage section 751. Furthermore, for example, information other than the game information, such as information related to a player or another player and setting information of the player terminal 1, is all referred to as player information. The player information is stored in the player-information storage section 750.

The CPU 10 runs the individual programs stored in the program storage area 12a and updates data in the individual storage sections of the data storage area 12b. Then, the CPU 10 runs the individual programs stored in the program storage area 12a, thereby causing the player terminal 1 (computer) to function as a terminal-side game control unit 1A. The terminal-side game control unit 1A includes an information setting processing unit 700a, a nurture-game execution unit 701a, and a nurture-completion-time processing unit 702a.

Specifically, the CPU 10 runs the information setting processing program 700, thereby causing the computer to function as the information setting processing unit 700a. Similarly, the CPU 10 runs the nurture-game execution program 701 and the nurture-completion-time processing program 702, thereby causing the computer to function as the nurture-game execution unit 701a and the nurture-completion-time processing unit 702a, respectively.

In the case where setting of various kinds of information is performed at the player terminal 1, the information setting processing unit 700a stores information related to the setting, as player information, in the player-information storage section 750. Furthermore, in the case where information in the player-information storage section 750 is updated, the information setting processing unit 700a sends the updated information to the server 1000.

The nurture-game execution unit 701a executes all processing procedures related to the nurture game. Specifically, the nurture-game execution unit 701a executes the preparatory-stage processing and the nurture-stage processing.

The nurture-completion-time processing unit 702a stores, at the time of completion of the nurture game, nurtured-character information including the ability parameters, the aptitude parameters, the obtained skills, the inheritance information, the factor information, and the types of characters used for nurture of the nurtured character.

(Functional configuration of server 1000)

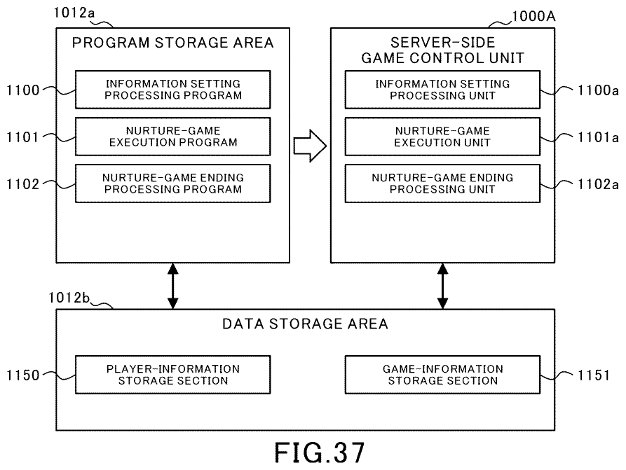

FIG. 37 is a view for explaining the configuration of the memory 1012 at the server 1000 and the function of the server 1000 serving as a computer. In the memory 1012, a program storage area 1012a and a data storage area 1012b are provided. When the game is started, the CPU 1010 stores server-side game control programs (modules) in the program storage area 1012a.

The server-side game control programs include an information setting processing program 1100, a nurture-game execution program 1101, and a nurture-game ending processing program 1102. Note that the programs listed in FIG. 37 are merely examples, and a large number of other programs are also provided as the server-side game control programs.

In the data storage area 1012b, a player-information storage section 1150 and a game-information storage section 1151 are provided as storage sections for storing data. Note that a large number of other storage sections are also provided in the data storage area 1012b. Here, pieces of game information of all players are stored in the game-information storage section 1151 while being linked to the player IDs thereof. Furthermore, pieces of player information of all players are stored in the player-information storage section 1150 while being linked to the player IDs thereof.

The CPU 1010 runs the individual programs stored in the program storage area 1012a and updates data in the individual storage sections of the data storage area 1012b. Then, the CPU 1010 runs the individual programs stored in the program storage area 1012a, thereby causing the server 1000 (computer) to function as a server-side game control unit 1000A. The server-side game control unit 1000A includes an information setting processing unit 1100a, a nurture-game execution unit 1101a, and a nurture-game ending processing unit 1102a.

Specifically, the CPU 1010 runs the information setting processing program 1100, thereby causing the computer to function as the information setting processing unit 1100a. Similarly, the CPU 1010 runs the nurture-game execution program 1101 and the nurture-game ending processing program 1102, thereby causing the computer to function as the nurture-game execution unit 1101a and the nurture-game ending processing unit 1102a, respectively.

In the case where various kinds of information are set at the player terminal 1, the information setting processing unit 1100a updates the player information in the player-information storage section 1150 on the basis of updated information received from the player terminal 1. Furthermore, the information setting processing unit 1100a measures time and updates the game points of each player.

The nurture-game execution unit 1101a executes all processing procedures related to the nurture game.

The nurture-game ending processing unit 1102a derives, when the nurture game ends, the evaluation points, the nurture rank, etc., of the nurtured character that has been nurtured. Furthermore, the nurture-game ending processing unit 1102a determines, by a lottery, a factor to be obtained by the nurtured character. Then, the nurture-game ending processing unit 1102a stores the nurtured-character information including the ability parameters, the aptitude parameters, the obtained skills, the inheritance information, the factor information, and the types of characters used for nurture of the nurtured character, in the game-information storage section 1151 while making it linked to the player ID.

Note that the information setting processing unit 700a in the player terminal 1 and the information setting processing unit 1100a in the server 1000 are common in that they store player information but are different from each other in terms of the content of specific processing and the range of player information to be stored. Furthermore, the nurture-game execution unit 701a in the player terminal 1 and the nurture-game execution unit 1101a in the server 1000 are common in that they execute processing related to the nurture game but are different in terms of their roles, i.e., handling areas.

Processing procedures carried out by the above-described individual functional units in the player terminal 1 and the server 1000 will be described below with reference to flowcharts.

### (Processing at Player Terminal 1 and Server 1000)

### <Processing Related to Nurture Game>

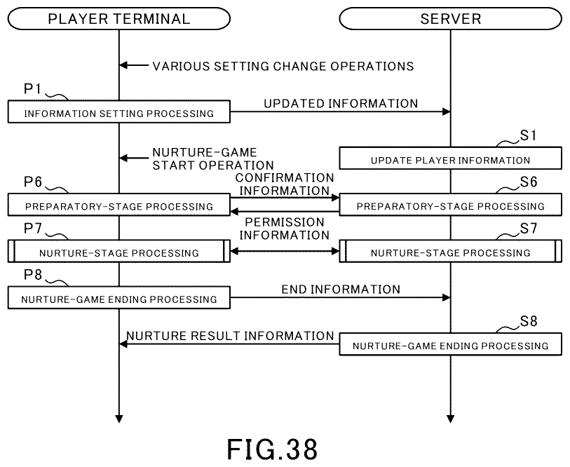

FIG. 38 is a sequence diagram for explaining processing procedures related to the nurture game and performed at the player terminal 1 and the server 1000. Note that, in the following description, processing at the player terminal 1 is indicated by Pn (n is an arbitrary integer). Furthermore, processing at the server 1000 is indicated by Sn (n is an arbitrary integer).

When the player performs various setting change operations at the player terminal 1, the information setting processing unit 700a of the player terminal 1 performs information setting processing (P1) for updating the player-information storage section 750 on the basis of the player's operation inputs. In this information setting processing, updated information is sent to the server 1000. At the server 1000, when the updated information is received, the information setting processing unit 1100a updates the player information in the player-information storage section 1150 (S1).

Note that the player information updated in P1 and S1 includes, for example, the profile information, which can be set by the player. Furthermore, for example, when an operation for adding another player as a friend or an operation for releasing a friend is performed as a setting change operation, friend information that is information related to friends is updated. Note that, in P1 and S1, the information setting processing unit 700a and the information setting processing unit 1100a individually manage the game points to be consumed in order to execute the nurture game. In the case where the game points are less than the upper limit, the information setting processing units 700a and 1100a measure time and give game points to the player by a predetermined value at intervals of a predetermined period of time.

When a nurture-game start operation for starting the nurture game is input at the player terminal 1, the nurture-game execution unit 701a executes the preparatory-stage processing (P6). Furthermore, during the preparatory-stage processing, communication processing is performed between the player terminal 1 and the server 1000. At the server 1000, the nurture-game execution unit 1101a executes the preparatory-stage processing (S6) on the basis of information received from the player terminal 1.

When the preparatory-stage processing (P6) ends, the nurture-game execution unit 701a executes the nurture-stage processing (P7). Furthermore, during the nurture-stage processing, communication processing is performed between the player terminal 1 and the server 1000. At the server 1000, the nurture-game execution unit 1101a executes the nurture-stage processing (S7) on the basis of information received from the player terminal 1. Note that, actually, the player terminal 1 and the server 1000 share roles, to proceed with the nurture main game through the nurture-stage processing (P7) at the player terminal 1 and the nurture-stage processing (S7) at the server 1000. However, a portion or the entirety of processing procedures, to be described below, in the nurture-stage processing (P7) at the player terminal 1 may be carried out in the nurture-stage processing (S7) at the server 1000, or a portion or the entirety of processing procedures in the nurture-stage processing (S7) at the server 1000 may be carried out in the nurture-stage processing (P7) at the player terminal 1.

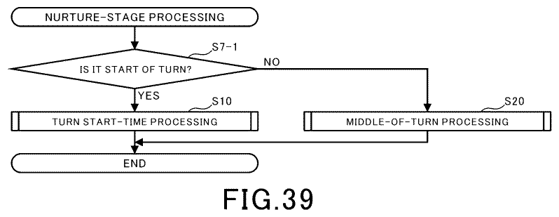

FIG. 39 is a flowchart for explaining the nurture-stage processing at the server 1000. The nurture-game execution unit 1101a of the server 1000 executes turn start-time processing (S10) if it is the start of a turn (YES in S7-1) and executes middle-of-turn processing (S20) if it is not the start of a turn.

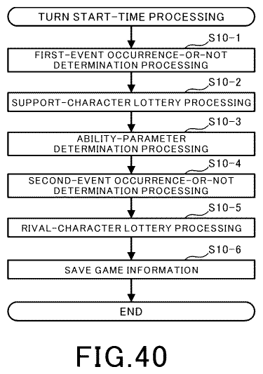

FIG. 40 is a flowchart for explaining the turn start-time processing at the server 1000. As shown in FIG. 40, first, the nurture-game execution unit 1101a of the server 1000 executes first-event occurrence-or-not determination processing (S10-1). Specifically, at the start of a turn, a random number is randomly acquired, and the occurrence or not of a first event and the content of the first event are determined on the basis of the acquired random number and the first-event table. Then, the nurture-game execution unit 1101a executes support-character lottery processing (S10-2). Specifically, the nurture-game execution unit 1101a refers to the arrangement-or-not table shown in FIG. 27, and determines, by a lottery, whether a support character is arranged for each training item. This processing is executed for each support character.

Note that, in the case where arrangement of a support character for a training item has been determined, the nurture-game execution unit 1101a may execute processing for linking the support character ID or the support card (use game medium) ID corresponding to the support character to the training ID corresponding to the training item (parameter change element).

Next, the nurture-game execution unit 1101a executes ability-parameter determination processing (S10-3). In the ability-parameter determination processing, each training is executed, and, increase values for the ability parameters of the main character when the training is successful are determined. Specifically, the nurture-game execution unit 1101a determines, for each of the training items, increase values for the ability parameters of the main character in the case where the corresponding training is successful, by referring to the training-level table, which is shown in FIG. 28A, the increase fixed value tables, which are shown in FIGS. 28B and 28C, and the bonus addition rate table, which is shown in FIG. 28D. Furthermore, the nurture-game execution unit 1101a determines a physical-strength reduction amount or a physical-strength restoration amount in the case where each training item is executed, by referring to a physical strength table (not shown). Furthermore, the nurture-game execution unit 1101a calculates a training failure rate for each training item on the basis of the physical strength of the main character.

Then, the nurture-game execution unit 1101a executes second-event occurrence-or-not determination processing (S10-4). Specifically, the nurture-game execution unit 1101a determines, by a lottery, the occurrence or not of a second event by referring to the second-event table, which is shown in FIG. 29. Specifically, after the support-character lottery processing (S10-2), a random number is randomly acquired, and the occurrence or not of a second event is determined on the basis of the acquired random number and the second-event table. Here, for example, the nurture-game execution unit 1101a performs a giving lottery for determining whether to enable to give a support event (privilege) that is set in advance for the support card linked to each training item.

Furthermore, the nurture-game execution unit 1101a executes rival-character lottery processing (S10-5). Specifically, the nurture-game execution unit 1101a determines, by a lottery, whether a rival character is arranged for each suitable race, by referring to the arrangement-or-not table shown in FIG. 32.

The nurture-game execution unit 1101a saves game information including information related to the lottery results in S10-1 to S10-5, in the game-information storage section 1151 such that the player terminal 1 can receive the game information (S10-6).

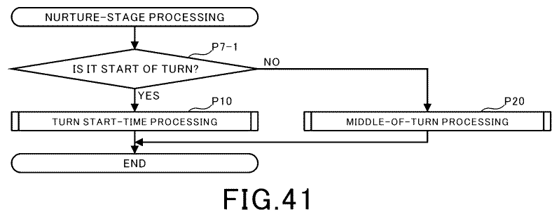

FIG. 41 is a flowchart for explaining the nurture-stage processing at the player terminal 1. The nurture-game execution unit 701a of the player terminal 1 executes turn start-time processing (P10) if it is the start of a turn (YES in P7-1) and executes middle-of-turn processing (P20) if it is not the start of a turn.

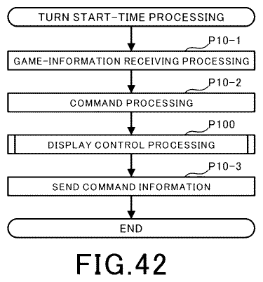

FIG. 42 is a flowchart for explaining the turn start-time processing at the player terminal 1. As shown in FIG. 42, first, the nurture-game execution unit 701a accesses the game-information storage section 1151 of the server 1000 and receives, from the server 1000, the game information including the lottery results in S10-1 to S10-6 (P10-1).

Then, the nurture-game execution unit 701a executes command processing for enabling the player to select various commands related to the nurture-stage processing (P10-2). Specifically, the nurture-game execution unit 701a refers to the selection item table, which is shown in FIG. 19, for example, to perform processing for enabling the player to select various commands, such as the rest operation section 215, the training operation section 216, the skill operation section 217, the going-out operation section 218, the individual-race operation section (specific command) 219, the shop operation section 220, the item operation section 221, etc., on the basis of the current turn number. Furthermore, the nurture-game execution unit 701a performs processing for enabling the player to select a plurality of individual-race selection operation sections (subcommands) 261 linked to the individual-race operation section 219.

Furthermore, in the command processing, the nurture-game execution unit 1101a enables the player to select the commands of the speed operation section 241, the stamina operation section 242, the power operation section 243, the spirit operation section 244, and the wisdom operation section 245, which correspond to the individual training items. The nurture-game execution unit 701a performs the processing for enabling the player to select one command from among the plurality of commands.

When the command processing is completed, the nurture-game execution unit 701a executes display control processing (P100).

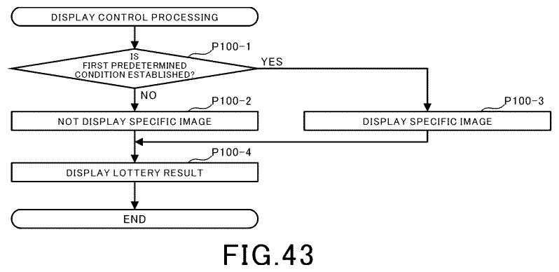

FIG. 43 is a flowchart for explaining the display control processing. As shown in FIG. 43, the nurture-game execution unit 701a executes first-predetermined-condition judgment processing for judging whether a first predetermined condition is established (P100-1). The first-predetermined-condition judgment processing is processing for judging whether the arrangement of a rival character has been determined or not, on the basis of the result of the rival-character lottery processing in S10-5. The nurture-game execution unit 701a judges that the first predetermined condition is established in the case where the arrangement of a rival character has been determined, and judges that the first predetermined condition is not established in the case where the arrangement of a rival character has not been determined. Furthermore, the first-predetermined-condition judgment processing is processing for judging whether a specific race is included in races that are selectable in the current turn. A specific race is, for example, a race from which the above-described special item can be obtained when a limited-time event is held. That is, in the first-predetermined-condition judgment processing, it is judged whether the first predetermined condition is established or not, on the basis of the type of a race (subcommand) that is selectable in the current turn. The nurture-game execution unit 701a judges that the first predetermined condition is established in the case where a specific race is included in the selectable races and judges that the first predetermined condition is not established in the case where a specific race is not included in the selectable races.

In the case where the first predetermined condition is not established (NO in P100-1), the nurture-game execution unit 701a makes the rival-character notification display 321 (specific image) not displayed, and performs control so as not to display the rival-character notification display 321 on the display 26 (P100-2).

On the other hand, in the case where the first predetermined condition is established (YES in P100-1), the nurture-game execution unit 701a performs control so as to display the rival-character notification display 321 (specific image) on the display 26 (P100-3). Specifically, the nurture-game execution unit 701a executes processing for displaying the rival-character notification display 321 linked to the individual-race operation section (specific command) 219, on the basis of establishment of the first predetermined condition. Here, the nurture-game execution unit 701a determines whether the rival-character notification display 321 is displayed so as to be overlapped with the individual-race operation section 219, on the basis of the lottery result of the rival-character lottery processing in S10-5 executed in each turn at the server 1000.

Furthermore, the nurture-game execution unit 701a executes processing for displaying the rival-character notification display 321 while making it linked to the individual-race selection operation section(s) (subcommand(s)) 261 corresponding to one or a plurality of individual races, on the basis of establishment of the first predetermined condition. Specifically, the nurture-game execution unit 701a determines whether or not to display the rival-character notification display 321 for each race event (subcommand) in the individual-race selection operation section(s) 261, on the basis of the parameters (for example, the aptitude parameters related to the racetrack aptitudes and the distance aptitudes) of the main character.

Furthermore, the nurture-game execution unit 701a displays the lottery result on the display 26 on the basis of the lottery result of the support-character lottery processing of S10-2 executed at the server 1000 (P100-4). Here, the nurture-game execution unit 701a displays, on the display 26, a support card (use game medium) linked to each training item (parameter change element) and information related to the result of a giving lottery for a support event (privilege).

Returning to FIG. 42, after the display control processing, in the case where any of various commands is selected by the player, the nurture-game execution unit 701a sends command information indicating the selected command, to the server 1000 (P10-3).

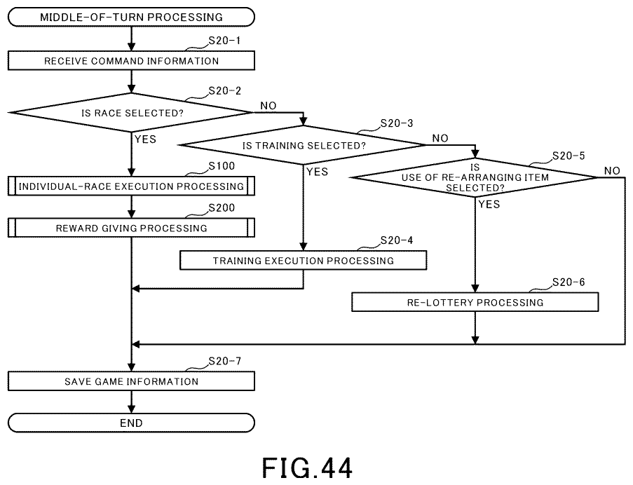

FIG. 44 is a flowchart for explaining the middle-of-turn processing at the server 1000. As shown in FIG. 44, when the command information is sent from the player terminal 1, the nurture-game execution unit 1101a receives the sent command information (S20-1).

When the command information is received, the nurture-game execution unit 1101a judges whether the command of the individual-race operation section 219 is selected by the player (S20-2). In the case where the command of the individual-race operation section 219 is selected (YES in S20-2), the nurture-game execution unit 1101a performs individual-race execution processing for making the main character participate in an individual race (predetermined game) (S100).

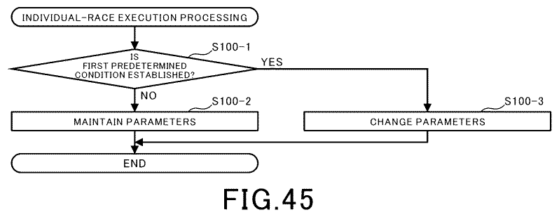

FIG. 45 is a flowchart for explaining the individual-race execution processing. As shown in FIG. 45, the nurture-game execution unit 1101a judges whether the first predetermined condition is established in the individual race in which the main character is made to participate (S100-1). In the case where the first predetermined condition is not established (NO in S100-1), the nurture-game execution unit 1101a executes processing for maintaining, at the set values, the parameters of NPCs that are set in the individual race in which the main character is made to participate (S100-2).

On the other hand, in the case where the first predetermined condition is established (YES in S100-1), the nurture-game execution unit 1101a executes processing for changing the parameters of an NPC that has the same character ID as the rival character, among the NPCs set in the individual race in which the main character is made to participate (S100-3). For example, the nurture-game execution unit 1101a multiplies the ability parameters of the regular NPC that has the same character ID as the rival character by predetermined times (for example, 1.1 times) and makes the NPC that has the changed parameters participate in the individual race as a rival character. In other words, the nurture-game execution unit 1101a executes, in an individual race for which the first predetermined condition is not established, the individual race by using NPCs having default parameters (predetermined parameters) and executes, in an individual race for which the first predetermined condition is established, the individual race by using an NPC whose default parameters have been changed.

Returning to FIG. 44, when the individual-race execution processing ends, the nurture-game execution unit 1101a executes reward giving processing for giving a reward to the player on the basis of the game result of the individual race (S200).

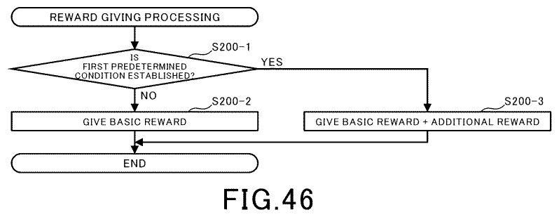

FIG. 46 is a flowchart for explaining the reward giving processing. As shown in FIG. 46, the nurture-game execution unit 1101a judges whether the first predetermined condition is established in the individual race in which the main character is made to participate (S200-1). In the case where the first predetermined condition is not established (NO in S200-1), the nurture-game execution unit 1101a gives a basic reward (first reward) to the player (S200-2). The basic reward is a reward that can be obtained by the player irrespective of victory or defeat with a rival character.

On the other hand, in the case where the first predetermined condition is established (YES in S200-1), the nurture-game execution unit 1101a gives an additional reward (second reward) to the player in addition to the basic reward (S200-3). That is, in the case where the individual race for which the first predetermined condition is established is executed, an additional reward is given to the player on the basis of the game result of the individual race. The additional reward is a reward that can be obtained when the main character participates in an individual race for competing with a rival character for victory or defeat. Note that it is also possible to make an event such as a second event occur as an additional reward, instead of giving of an item.

Returning to FIG. 44, in the case where the individual-race operation section 219 is not selected (NO in S20-2), the nurture-game execution unit 1101a judges whether the command of the training operation section 216 is selected by the player (S20-3). In the case where the command of the training operation section 216 is selected (YES in S20-3), the nurture-game execution unit 1101a performs training execution processing (S20-4).

Specifically, the nurture-game execution unit 1101a judges whether any training item of the speed operation section 241, the stamina operation section 242, the power operation section 243, the spirit operation section 244, and the wisdom operation section 245 is selected. The nurture-game execution unit 1101a judges whether training of the selected training item is successful. In the case where the training is successful, the nurture-game execution unit 1101a performs, for example, processing for increasing the values of the ability parameters of the main character according to the training item. More specifically, in the case where the training is successful, the nurture-game execution unit 1101a executes processing for increasing the values of the ability parameters of the main character on the basis of a support card(s) linked to the training item selected by the player and the presence or absence of giving of a support event. Furthermore, in the case where training is failed, the nurture-game execution unit 1101a performs, for example, processing for reducing the values of the ability parameters of the main character according to the training item. In this way, the nurture-game execution unit 1101a changes the parameters of the main character according to the training item and the judgment on success of the training item.

On the other hand, in the case where the training operation section 216 is not selected (NO in S20-3), the nurture-game execution unit 1101a judges whether the command of use of a character re-arranging item is selected (S20-5). Here, the nurture-game execution unit 1101a performs second-predetermined-condition judgment processing for judging whether a character re-arranging item is used. The nurture-game execution unit 701a judges that a second predetermined condition is established in the case where it is judged that the character re-arranging item is used, and judges that the second predetermined condition is not established in the case where it is judged that the character re-arranging item is not used.

In the case where the command of use of the character re-arranging item is selected (YES in S20-5), the nurture-game execution unit 1101a performs re-lottery processing (S20-6). Specifically, in the case where the character re-arranging item is used, while maintaining the occurrence or not of a second event of a support card, the nurture-game execution unit 1101a executes processing for performing a re-lottery for linking a support card and a training item. Specifically, one random number is determined by a re-lottery at the use of the character re-arranging item, and arrangement of each support character for each training item is redetermined on the basis of the random number determined by the re-lottery and the arrangement-or-not table shown in FIG. 27. At this time, in the case where the arrangement location of each support character to a training item after the re-lottery is the same as the arrangement location of the support character to a training item before the re-lottery (that is, arrangement location determined through the support-character lottery processing (S10-2)), a random number is determined again by a re-lottery. Then, arrangement of each support character for each training item is redetermined on the basis of the random number determined by the re-lottery and the arrangement-or-not table shown in FIG. 27. This processing is executed repeatedly until the arrangement location of each support character to a training item after the re-lottery becomes different from the arrangement location of the support character to a training item before the re-lottery (that is, arrangement location determined through the support-character lottery processing (S10-2)). Furthermore, at the use of the character re-arranging item, the occurrence or not of a second event is determined by the re-lottery on the basis of the random number selected by a lottery in the second-event occurrence-or-not determination processing (S10-4) and the second-event table. Here, since the re-lottery is performed by using the same random number as the random number used in the second-event occurrence-or-not determination processing (S10-4) and the same second-event table as that used therein, a second event determined by the re-lottery after the character re-arranging item is used will have the same result as a second event of which the occurrence has been determined in the second-event occurrence-or-not determination processing (S10-4). On the other hand, in the case where commands other than the individual-race operation section 219, the training operation section 216, and the use of the character re-arranging item are selected (NO in S20-5), various kinds of processing corresponding to the commands are executed. A detailed description thereof is omitted here.

Then, the nurture-game execution unit 1101a saves game information including information related to the race result of the individual-race execution processing executed in S100, information related to the reward result of the reward giving processing executed in S200, information related to the result of the training executed in S20-4, information related to the result of the second-predetermined-condition judgment processing executed in S20-5, and information related to the re-lottery result of the re-lottery processing executed in S20-6, in the game-information storage section 1151 such that the player terminal 1 can receive the game information (S20-7).

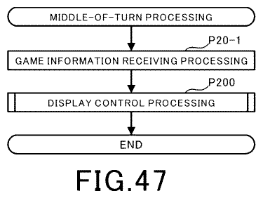

FIG. 47 is a flowchart for explaining the middle-of-turn processing at the player terminal 1. As shown in FIG. 47, first, the nurture-game execution unit 701a accesses the game-information storage section 1151 of the server 1000 and receives, from the server 1000, game information including information related to the race result, the reward result, the training result, the second-predetermined-condition judgment result, and the re-lottery result (P20-1).

After receiving the game information, the nurture-game execution unit 701a executes display control processing (P200).

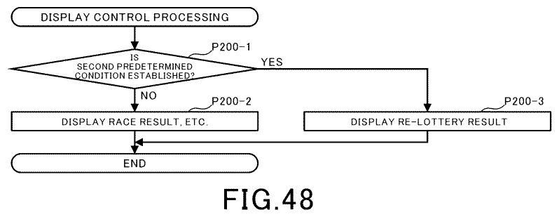

FIG. 48 is a flowchart for explaining the display control processing. As shown in FIG. 48, the nurture-game execution unit 701a judges whether a second predetermined condition is established (P200-1). In the case where the second predetermined condition is not established (NO in P200-1), the nurture-game execution unit 701a displays the race result, the reward result, the training result, etc., on the display 26 on the basis of the results of the individual-race execution processing in S100, the training execution processing in S20-4, and the other various kinds of processing, which are executed at the server 1000 (P200-2).

On the other hand, in the case where the second predetermined condition is established (YES in P200-1), the nurture-game execution unit 701a displays the re-lottery result on the display 26 on the basis of the lottery result of the re-lottery processing in S20-6, which is executed at the server 1000 (P200-3). Specifically, the nurture-game execution unit 701a displays, on the display 26, a support card linked to each training item and information related to the appearance or not of a support event linked to the support card.

Returning to FIG. 38, when the above-described nurture-stage processing ends, the nurture-game execution unit 701a executes nurture-game ending processing at the player terminal 1 (P8). In the nurture-game ending processing, the nurture-game execution unit 701a stores information related to the nurtured character that has been nurtured in the nurture game, in the game-information storage section 751. Furthermore, the nurture-game execution unit 701a sends end information to the server 1000. This end information includes information related to the nurtured character, etc. At the server 1000, when the end information is received, the nurture-game ending processing unit 1102a executes the nurture-game ending processing (S8).

Through the above processing, the above-described nurture game is realized. Note that the above-described processing procedures at the player terminal 1 and the server 1000 are merely examples. Furthermore, the above-described individual processing procedures may be executed only at the player terminal 1 or may be executed only at the server 1000.

Although one aspect of the embodiment has been described above while referring to the accompanying drawings, it is needless to say that the present invention is not limited to the above-described embodiment. It is obvious that a person skilled in the art could think of various alternative embodiments or modifications within the range of the idea of the claims, and the alternative embodiments and modifications can be understood as certainly falling within the technical scope of the present invention.

The game properties described in the above-described embodiment and the processing procedures executed at the player terminal 1 and the server 1000 are merely examples. In any case, the information processing program just needs to make the computer (in the embodiment, one or both of the player terminal 1 and the server 1000) to execute the following processing procedures.

### (Processing Executed by Computer)

Processing (P10-2 in the embodiment) for enabling a player to select one command from among a plurality of commands including a specific command (the individual-race operation section 219 in the embodiment), in a game for changing a parameter of a nurture-target character.

Processing (S100 in the embodiment) for executing a predetermined game (an individual race in the embodiment) on the basis of the fact that the specific command is selected. Processing (S200-2 in the embodiment) for giving a first reward on the basis of the game result of the predetermined game.

Processing (P100-3 in the embodiment) for displaying a specific image (the rival-character notification display 321 in the embodiment) linked to the specific command on the basis of a predetermined condition (determination of arrangement of a rival character in the embodiment).

Processing (S200-3 in the embodiment) for giving a second reward on the basis of the game result of the predetermined game in the case where the predetermined game is executed after the specific command for which the predetermined condition is established is selected.

Furthermore, in the processing for executing the predetermined game (the individual race in the embodiment), the predetermined game executed after the specific command for which the predetermined condition is not established is selected is executed by using a predetermined parameter (S100-2 in the embodiment), and, in the predetermined game executed after the specific command for which the predetermined condition is established is selected, the predetermined parameter is changed (S100-3 in the embodiment).

Furthermore, in the processing for giving the second reward, an event serving as the second reward is displayed.

Furthermore, the game for changing the parameter of the nurture-target character includes a plurality of turns, and, in the processing for displaying the specific image, whether the specific image is displayed or not is determined on the basis of a lottery executed in each of the turns (P100-3 in the embodiment).

Furthermore, a plurality of subcommands (the individual-race selection operation sections 261 in the embodiment) linked to the specific command (the individual-race operation section 219 in the embodiment) are set for the specific command in a selectable manner; predetermined games different from each other are set for the plurality of subcommands; and, in the processing for displaying the specific image (the rival-character notification display 321 in the embodiment), whether the specific image is displayed or not is determined on the basis of the type of each of the subcommands (the type of a race) (P100-3 in the embodiment).

Furthermore, a plurality of subcommands (the individual-race selection operation sections 261 in the embodiment) linked to the specific command (the individual-race operation section 219 in the embodiment) are set for the specific command in a selectable manner; predetermined games different from each other are set for the plurality of subcommands; and, in the processing for displaying the specific image (the rival-character notification display 321 in the embodiment), the specific image is displayed while being linked to the subcommand(s) corresponding to one or a plurality of the predetermined games (P100-3 in the embodiment).

Furthermore, in the processing for displaying the specific image (the rival-character notification display 321 in the embodiment), whether the specific image for each of the subcommand(s) (the individual-race selection operation section(s) 261 in the embodiment) is displayed or not is determined on the basis of the parameter of the nurture-target character (P100-3 in the embodiment).

### (Processing Executed by Computer)

Processing for enabling any of a plurality of parameter change elements (training items in the embodiment) that change the parameter of the nurture-target character, to be selected (P10-2 in the Embodiment).

Processing for linking a use game medium (a support card in the embodiment) used for nurture of the nurture-target character, to any of the parameter change elements by a lottery (S10-2 in the embodiment).

Processing for performing a giving lottery for determining whether a privilege (a support event in the embodiment) set in advance for the use game medium linked to any of the parameter change elements can be given or not (S10-5 in the embodiment).

Processing for changing the parameter of the nurture-target character on the basis of the use game medium linked to any of the parameter change elements that is selected by the player and the presence or absence of a privilege (S20-4 in the embodiment).

Processing for performing a re-lottery for linking a use game medium and any of the parameter change elements when a predetermined condition (use of a character re-arranging item in the embodiment) is established (S20-6 in the embodiment).

Processing for displaying, before the predetermined condition is established, a use game medium (the support card in the embodiment) linked to any of the parameter change elements (the training items in the embodiment) and information related to the result of the giving lottery, on a display section (P100-4 in the embodiment).

The predetermined condition is the use of a limited item (a character re-arranging item in the embodiment) the number of purchases of which is limited.

Note that the information processing program for executing the processing procedures in the above-described embodiment and various modifications may be stored in a non-transitory computer-readable storage medium and may be provided in the form of the storage medium. Alternately, a game terminal device that includes this storage medium may be provided. Furthermore, the above-described embodiment and various modifications may be provided in the form of an information processing method for realizing the individual functions and the steps shown in the flowcharts.

What is claimed is:

1. A non-transitory computer readable medium storing a program causing a computer to execute:
processing for enabling a player to select one command from among a plurality of commands including a specific command, in a game for changing a parameter of a nurture-target character;
processing for executing a predetermined game among at least one game on the basis of the fact that the specific command is selected;
processing for giving a first reward on the basis of a game result of the predetermined game;
processing for displaying a specific image linked to the specific command on the basis of a predetermined condition; and
processing for giving a second reward on the basis of the game result of the predetermined game, in the case where the predetermined game is executed after the specific command for which the predetermined condition is established is selected.

2. The non-transitory computer readable medium according to claim 1,
wherein, in the processing for executing the predetermined game, the predetermined game executed after the specific command for which the predetermined condition is not established is selected is executed by using a predetermined parameter; and
wherein, in the predetermined game executed after the specific command for which the predetermined condition is established is selected, the predetermined parameter is changed.

3. The non-transitory computer readable medium according to claim 1, wherein, in the processing for giving the second reward, an event serving as the second reward is displayed.

4. The non-transitory computer readable medium according to claim 1,
wherein the game for changing the parameter of the nurture-target character includes a plurality of turns; and
wherein, in the processing for displaying the specific image, whether the specific image is displayed or not is determined on the basis of a lottery executed in each of the turns.

5. The non-transitory computer readable medium according to claim 1,
wherein the at least one game includes a plurality of games that are different from each other;
wherein a plurality of subcommands linked to the specific command are set for the specific command in a selectable manner;
wherein one of the plurality of games is set for each of the plurality of subcommands; and
wherein, in the processing for displaying the specific image, whether the specific image is displayed or not is determined on the basis of the type of each of the plurality of subcommands.

6. The non-transitory computer readable medium according to claim 1,
wherein the at least one game includes a plurality of games that are different from each other;
wherein a plurality of subcommands linked to the specific command are set for the specific command in a selectable manner;
wherein one of the plurality of games is set for each of the plurality of subcommands; and
wherein, in the processing for displaying the specific image, the specific image is displayed while being linked to one of the plurality of subcommands, or linked to several of the plurality of subcommands.

7. The non-transitory computer readable medium according to claim 6,
wherein, in the processing for displaying the specific image, whether the specific image is displayed or not is determined on the basis of the parameter of the nurture-target character.

8. An information processing method executed by a computer, the computer executing:
processing for enabling a player to select one command from among a plurality of commands including a specific command, in a game for changing a parameter of a nurture-target character;
processing for executing a predetermined game among at least one game on the basis of the fact that the specific command is selected;
processing for giving a first reward on the basis of a game result of the predetermined game;
processing for displaying a specific image linked to the specific command on the basis of a predetermined condition; and
processing for giving a second reward on the basis of the game result of the predetermined game, in the case where the predetermined game is executed after the specific command for which the predetermined condition is established is selected.

9. An information processing system comprising at least one computer, the at least one computer executing:
processing for enabling a player to select one command from among a plurality of commands including a specific command, in a game for changing a parameter of a nurture-target character;
processing for executing a predetermined game among at least one game on the basis of the fact that the specific command is selected;
processing for giving a first reward on the basis of a game result of the predetermined game;
processing for displaying a specific image linked to the specific command on the basis of a predetermined condition; and
processing for giving a second reward on the basis of the game result of the predetermined game, in the case where the predetermined game is executed after the specific command for which the predetermined condition is established is selected.
